(19) United States
(12) Patent Application Publication
(10) Pub. No.: US 2024/0397946 A1
(43) Pub. Date: Dec. 5, 2024

(54) CONCENTRATED FUNGICIDAL COMPOSITION OF AZOXYSTROBIN, CYPROCONAZOLE AND CHLOROTHALONIL OF HIGH LOAD, FORMULATIONS AND METHOD TO CONTROL ASIAN RUST AND OTHER DISEASES

(71) Applicant: OURO FINO QUÍMICA S.A., Uberaba (BR)

(72) Inventors: Gilberto FERNANDO VELHO, Uberaba (BR); Thais BALBAO CLEMENTE BUENO DE OLIVEIRA, Uberaba (BR); Roberto ESTÊVÃO BRAGION DE TOLEDO, Uberaba (BR); Diego GONÇALVES ALONSO, Uberaba (BR); Richard FELICIANO, Uberaba (BR); Leonardo CAMPOS ARAÚJO, Uberaba (BR); Flavia DE OLIVEIRA BIAZOTTO, Uberaba (BR); Marco ANTONIO DREBES DA CUNHA, Uberaba (BR)

(21) Appl. No.: 18/694,234

(22) PCT Filed: Sep. 14, 2022
(86) PCT No.: PCT/BR2022/050366

§ 371 Date: Mar. 21, 2024

(30) Foreign Application Priority Data
Sep. 22, 2021 (BR) 1020210189410

(51) Int. Cl. A01N 43/54; A01N 37/34; A01N 43/653; A01P 3/00

(52) U.S. Cl. CPC A01N 43/54; A01N 37/34; A01N 43/653; A01P 3/00

(57) ABSTRACT

The present invention describes a concentrated fungicidal composition of azoxystrobin, cyproconazole and chlorothalonil of high load and of other formulations containing chlorothalonil with photoprotective effect of azoxystrobin, cyproconazole and other active ingredients and/or derivatives of this composition, as well as the method of treatment of diseases caused by fungi.

### APPLICATION FIELD

The present invention is applied in the field of agriculture, more specifically, in the field of pesticides where the product of the present invention involves a concentrated fungicidal composition of azoxystrobin, cyproconazole and chlorothalonil of high load and of other formulations containing chlorothalonil with photoprotective effect, of azoxystrobin, cyproconazole and other active ingredients and/or derivatives of this composition, as well as the method of treatment of diseases caused by fungi.

### STATE OF ART

Asian rust (Phakopsora pachyrhizi) is a major concern for soybean cultivation in Brazil. Known for considerably reducing grain yield, its occurrence has been observed in practically all production regions, alternating levels of aggressiveness depending on the climate, or local predisposing factors.

Since the first identification of soybean rust or Asian rust in the 2000/2001 crop and the epidemic in 2003/2004 in Brazil, its presence has already been recorded in more than 65% of the production area in South America. South and in Brazil, in more than 90% of the area cultivated with soy.

Different factors have contributed to the fact that soybean rust continues to cause losses in excess of 23 billion dollars, if the entire production chain is considered.

Some epidemiological parameters have been consistent with the seasons, highlighting the population evolution of soybean rust (Phakopsora pachyrhizi) combined with favorable climatic conditions for infection (leaf wetting and mild night temperatures) and dispersion (frequency of rain).

The symptoms are particularly evident on the leaves, evolving from isolated uredia to areas with pronounced coalescence when it causes yellowing and premature leaf abscission.

According to Bromfield (1984) infections at the beginning of flowering produce high levels of damage, also affecting the protein content in the grain (Ogle et al., 1979).

The improvement of disease control in soybean cultivation occurs through the rational, economic and ecological use of multiple methods, ensuring a stable plant production and minimizing risks to the environment, humans and animals.

It is important to recover the concept of disease, which is the action of biotic (pathogens) or abiotic factors (nutritive, climatic, edaphic factors), establishing stable compatible interactions with susceptible or sensitive host plants, definitively affecting vital physiological functions and whose reflexes are sufficiently permanent or long-lasting to cause economic damage to soy production.

That said, every time a pathogen is successfully established on a host's tissues, without protective measures having been adopted, any control tools will have their effectiveness compromised in proportion to the physiological compromise of the host.

Observations point to an average annual reduction of approximately 20% in soybean productivity due to the incidence of diseases. In the particular case of rust, these values vary between locations and depending on the adaptation of the climate to the evolution of the pathogen.

Considering the area planted with soybean and occupied to a greater extent by susceptible cultivars, both in Brazil and in South America, combined with the easy dissemination of spores abundantly produced by the pathogen, it is evident that the amount of inoculum available for infection has increased continuously, directly reflecting the onset of infections in the field (Miles et al., 2007).

The scenario becomes even more critical if it is considered that the soybean cultivation window in South America is practically 12 months, making it possible to maintain a high level of initial inoculum.

Due to the agronomic control strategies usually used, even if the amount of initial inoculum was minimal, as the crop progresses, the inoculum available for infection and present in the air would reach very high levels between late December and late December. March.

Such inoculum saturation almost completely compromises the effectiveness of any systemic assets, designed to protect rather than eradicate. Thus, preventively applied fungicides have emerged as the most effective strategy to control this disease (Hartman et al., 1991).

Longer residual period and better performance of fungicides were obtained by Vitti et al. (2004) due to the preventive application of fungicides.

Likewise, Oliveira (2004) observed an increase in yield of up to 100% when preventively controlling the disease.

To reduce the risk of damage to the crop, the management strategies recommended in Brazil for this disease are the use of early cycle cultivars, sowing at the beginning of the recommended season, the elimination of voluntary soybean plants, the absence of cultivation of soybeans in the off-season through the sanitary void, monitoring of the crop from the beginning of the development of the culture, the use of fungicides in the appearance of symptoms or preventively and the use of resistant cultivars, when available.

The application of fungicides in spraying the aerial part of the soybean crop, targeting the Asian rust, has been recommended.

The active ingredients of fungicides registered for the control of Asian soybean rust belong, for the most part, to the organic chemical groups strobilurins, triazoles and carboxamides.

The fungicidal activity of strobilurins (QoI) is linked to the ability to inhibit mitochondrial respiration by binding to the Q0 site of cytochrome b (Bartlett et al., 2002). Cytochrome b is part of the bc1 complex, located in the mitochondrial membrane of fungus and other eukaryotes.

When QoI fungicides bind, there is a block in the transfer of electrons between cytochrome b and cytochrome c1, altering the energy production cycle of the fungus (Bartlett et al., 2002).

Such compounds have high activity against spore germination and at the spore germ tube level (Leinhos et al., 1997). This group of compounds acts on the energy synthesis of the fungus, and thus is highly effective in the phases of higher energy demand of the fungus development (Bartlett et al., 2002).

The potent effect of strobilurins on spore germination explains the high preventive activity that these fungicides deliver (Bartlett et al., 2002). However, fungicides also inhibit the mycelial growth of fungi, presenting healing and protective properties.

Strobilurins may have control failures when positioned in a curative or eradicative manner, due to the lower probability of reaching the target site of the fungus when in abundant mycelial growth.

Triazole fungicides (DMIs) act by inhibiting the biosynthesis of ergosterol, an important substance for maintaining the integrity of the cell membrane of fungi. Decreased availability of ergosterol leads to fungal cell disruption and disruption of mycelial growth (Hewitt, 1998).

Triazoles act efficiently at the mycelial level. The great effectiveness of the mechanism of action of DMIs is in the development of the haustorium and in the mycelial growth inside the tissues (Buchenauer, 1987) and it is for this reason that DMIs fungicides are attributed a curative action. DMIs do not efficiently affect spore germination and germ tube stage as the pathogen obtains a supply of ergosterol or its precursors from reserves contained in spores (Hänssler & Kuck, 1987).

The carboxamides, succinate dehydrogenase inhibitors (SDHI), is another chemical group recently introduced in the control of Phakopsora pachyrrizi. Complex Il is the tricarboxylic acid succinate dehydrogenase (TCA) or the fungal Krebs cycle. This cycle catalyzes the oxidation of succinate to fumarate, coupled with the reduction of ubiquinone to ubiquinol.

SDHI fungicides bind to complex Il subunits and act by disrupting the fungus's respiratory cycle (Walter, 2011). In general, these fungicides have the same characteristics mentioned above for the QoI compounds.

It presents high activity at the spore level and germ tube formation, a phase in which the fungus demands a lot of metabolic energy. Thus, they must necessarily be positioned preventively so that they deliver better control performances.

According to a motion presented to MAPA in July 2014, there was a reduction in the efficiency of fungicides in the control of Asian rust. Since then, fungicide efficiency data in recent seasons have shown significant differences in efficiency loss for the main groups.

Influenced by climatic factors, this fungus caused an extremely aggressive epidemic in southern Brazil, appearing very early in relation to the history of other crops.

The hot and humid winter, allied to the presence of inoculum in the air and of volunteer plants, provided rust detections in commercial crops still in the vegetative stage of soybean, focusing on plants not yet protected by fungicides.

The resistance mechanisms developed by soybean rust (P. pachyrhizi), over the last 15 years of chemical control, described in several scientific works, the triazole chemical groups, in the Cyp5 I gene, changing the “strength” of binding of the DMIs with the target enzyme and overexpression, and the strobilurins, phenyl alanine exchanged for leucine at position 129-FI29L in CytB, in both cases the resistance of P. pachyrhizi populations to these fungicides is produced by a directional selection.

The intensive and extensive use of these technologies, associated with the environmental conditions conducive to the high multiplication of the pathogen, facilitates and accelerates the selection of mutants, making these less sensitive individuals able to predominate within the population, apparently without adaptive cost, maintaining them. virulent and taking control of the rust increasingly difficult.

Multisite or protective fungicides, such as chlorothalonil, were evaluated when the rust entered Brazil. However, due to the lower control efficiency compared to triazoles at the beginning of the tests, they were discarded for rust control. With the reduced efficiency of triazoles and mixtures of triazoles and strobilurins, multisite fungicides have been registered for the control of soybean diseases and their use increased in the last crop in association with systemic fungicides.

Multisite fungicides have been seen as an important tool in soybean rust management programs, increasing the efficiency of control of fungicides already with resistance problems and may delay the appearance in those that do not yet have it.

Multisite fungicides have the great advantage, because in addition to being low-priced, they act at multiple sites of action, in the fungal cell, interfering with numerous metabolic processes of the fungus, and consequently, resistance to this group of fungicides is rare or non-existent (ZAMBOLIM, 2008).

Product mixtures as strategies to increase the spectrum of action is a practice that has been carried out in rural properties at the time of application. This fact occurred with mancozeb dithiocarbamate in Brazil.

However, we work with wettable powder formulations used in crops such as potato and tomato. Thus, the launch of a triple formulation, DMI+QoI+Chlorothalonil, shows advantages in terms of effectively overcoming restrictions of farmers and also for being able to add adequate characteristics regarding the formulation.

Binary combinations of azoxystrobin and chlorothalonil are described, for example, in CN106879583 which discloses a microemulsion containing 5-20% azoxystrobin, 5-15% chlorothalonil, 5-25% co-solvent, 5-25% surfactants, 2-8% antifreeze agent, 0.5-4% penetrating agent and water.

Document CN108902156 describes a bactericidal suspension containing 3 to 12 parts of azoxystrobin, 35 to 55 parts of chlorothalonil, 3 to 10 parts of a surfactant, 0.04 to 0.16 parts of a thickener, 2 to 8 parts of an antifreeze agent, 0.1 to 1 part of an auxiliary agent and 35 to 45 parts of water. Said suspension exhibits good stability in a storage process and is used for disease prevention and control of various crops.

Binary compositions of azoxystrobin and cyproconazole are described, for example, in documents CN107980787 and CN107494547.

Document CN107980787 discloses water dispersible granules containing azoxystrobin and cyproconazole. Water-dispersible granules are prepared from azoxystrobin, cyproconazole, a lignosulfonate dispersant, an alkyl sulfate wetting agent and a filler. Water dispersible granules have excellent disintegration, suspending property and low foamability in high concentration of hard water.

Document CN107494547 refers to suspending agent composed of 10 to 30 parts of azoxystrobin, 5 to 15 parts of cyproconazole, 3 to 5 parts of sodium sulfate alkylphenol ethoxylate, 2 to 4 parts of dispersant, 2 to 4 parts of ethylene glycol and 60 to 70 parts of water, wherein the dispersant is a mixture of sodium lignin sulfonate and calcium lignin sulfonate according to a mass ratio of (1.7 to 2.1):1.

Binary combinations of cyproconazole and chlorothalonil are described, for example, in documents CN102017951 which refers to a germicidal composition with a synergistic effect. The effective active components of the germicidal composition comprise cyproconazole and chlorothalonil, wherein the weight ratio of cyproconazole to chlorothalonil is 1:1-1:90. Effective active ingredients are prepared in wettable powders, water-dispersible granules and suspending agents by the addition of adjuvants and excipients.

The launch of a more complete formulation considering three active ingredients, such as a strobilurin, a triazole and chlorothalonil, that is, with three mechanisms of action is an advance and will allow the use on a large scale in the soybean crop. Formulated mixtures of systemic fungicides with chlorothalonil are of great importance for not allowing resistant mutants of the fungus to emerge in the population of P. pachyrhizi, in addition to increasing the shelf life of systemic fungicides, as well as the present invention of the formulation and discovery of Ourofino Agrociência of the photoprotective effect of chlorothalonil, reducing the degradation of azoxystrobin and cyproconazole and other strobilurins and triazoles, increasing the effectiveness in controlling soybean rust and significantly preserving productivity.

The present invention, therefore, is in the introduction of protective fungicides in the formulations of systemic fungicides, the photoprotective effect of chlorothalonil reducing the degradation of different active ingredients of action fungicides, herbicides, insecticides and others.

### SUMMARY OF THE INVENTION

In order to solve the technical problems of the state of the art pointed out above, a new concentrated fungicidal composition of azoxystrobin, cyproconazole and chlorothalonil of high load and of other formulations derived from this composition containing chlorothalonil with photoprotective effect of azoxystrobin and/or other strobilurins and of cyproconazole and/or other triazoles, as well as the method of treating fungal diseases were developed.

### BRIEF DESCRIPTION OF THE FIGURES

FIG. 01 shows the percentage of light absorption of different wavelengths by the three active ingredients with fungicidal action under study, at typical application concentrations.

FIG. 02 illustrates the diagrammatic scale of Asian soybean rust, following the scale of (Godoy et al, 1997).

FIG. 03 illustrates the diagrammatic scale of soybean end-of-cycle diseases (Glycine max) caused by Septoria glycines and Cercospora kikuchii. Top panel, aggregated symptoms. Bottom panel, symptoms randomly distributed, following scale (Martins et al, 2004).

FIG. 04 illustrates the defoliation estimation scale (MARIO HIRANO et al, 2010).

FIG. 05 illustrates the diagrammatic scale for evaluating phytotoxicity as a function of tanning, chlorosis and leaf necrosis caused by the application of fungicides on soybean (Campos et al, 2012).

FIG. 06 illustrates the average productivity in kg per hectare of the products OFA-T 0125/16 (azoxystrobin+cyproconazole+chlorothalonil) and picoxystrobin+cyproconazole (standard product), in the soybean crop.

FIG. 07 illustrates the diagrammatic scale for assessing the severity of target spot in soybean (Soares et al. 2009).

FIG. 08 illustrates a graph of the control efficiency (% reduction of AUDPC) of different fungicides applied to control target spot on soybean plants in the trial conducted in Anaurilândia, MS, 2020.

FIG. 09 illustrates a graph of the control efficiency (% reduction of AUDPC) of different fungicides applied in the for the control of target spot on soybean plants in the trial conducted in Itaquiraí, MS, 2020.

### DETAILED DESCRIPTION OF THE INVENTION

The present invention aims to: 1) increase the concentration of actives in the composition and formulations, reducing the consumption of raw materials and transport costs; 2) use of safer raw materials in toxicological and environmental terms; 3) development of stable formulations during storage and transport; 4) increased deposition with reduced drift losses; 5) development of formulations containing chlorothalonil as a protective fungicide, enhancing the dynamics and persistence of each of the active ingredients of the strobilurins and triazoles groups, since its photoprotective effect reduces the degradation of these actives, promoting greater control of pathogens; and 6) high efficiency in comparative tests under practical conditions of use.

Ourofino Agrociência is a company that operates in the agricultural market developing innovative formulations of pesticides that contribute to the sustainable management of pests, diseases and weeds. The development of an innovative formulation involves the construction of an array of information and technologies that need to be selected, combined, evaluated and continuously improved until obtaining a viable product in economic, social and environmental terms. The process is complex, requires time and large investments, and patent protection is essential so that the company can exclusively commercially exploit the innovation developed, allowing the recovery of invested resources.

The company also has ethics as one of its pillars of support. In this context, it understands that obtaining patents must serve the effective scientific and technological development seeking the sustainable production of food, fiber and bioenergy. It is contrary to the company's ethical principles to apply for patents that aim to create legal uncertainty for competitors and unfair commercial advantages.

It is worth mentioning the complexity of the studies conducted so that the new formulation could be developed and evaluated. In addition to innovative concepts in terms of the selection of components and manufacturing processes, it was a great challenge to develop experimental and analytical methods that would allow the precise quantification of the levels of the three fungicides on the surface or inside the leaves. It was also necessary to develop procedures to measure the concentrations of fungicides in rainwater to compare experimental formulations and commercial products in terms of their ability to remain on leaves after rainfall. In total, 3,258 quantifications of fungicides (active ingredients) were carried out in different types of matrices. Chlorothalonil stands out in terms of analytical difficulty requiring the use of specific ionization and analysis procedures in LC-MSMS systems that were developed exclusively for this project.

### 1—the Combination of Active Ingredients and the Choice of Chlorothalonil as a Protective Fungicide.

The information presented was obtained by consulting the portals of the Action Committee on Fungicide Resistance-FRAC-BR (https://www.frac-br.org/) and “FRAQ-Fungicide Resistance Action Committee” (https://www.frac.info/home). The portals summarize the most current information on the sites and modes of action of fungicides and strategies to reduce problems with fungicide resistance. The mixture of active ingredients with different modes and sites of action is a fundamental strategy with this objective.

Cyproconazole has as its site of action: Group G1 or C14-demethylase in sterol biosynthesis (erg11/cyp51)/DMI-fungicides (demethylation inhibitors) (SBI: Class I). In general, triazole fungicides, a group that includes cyproconazole, have predominantly eradicating and antisporulant action with some curative action. Azoxystrobin has as its site of action: Group C3—Complex III: cytochrome bc1 (ubiquinol oxidase) at the Qo/QoI site—fungicides (Extracellular Quinone Inhibitors). Strobilurins, with extracellular action, act predominantly as preventive and curative fungicides.

Chlorothalonil is a chloronitrile with multiple sites of action and mechanism of action not yet established. It is a protective action fungicide. The work of Kim et al. (2004) indicates that the biotransformation of chlorothalonil is glutathione-dependent and that for each biodegraded chlorothalonil molecule there is the consumption of three glutathiones. Excessive consumption of glutathiones can compromise fungal growth and tolerance to stresses, including those of a chemical nature, as it can limit the chemical biotransformation (degradation) of other fungicides applied in a mixture. The first hypothesis established is that the reduction of the chemical biotransformation rate of the other fungicides can occur both in the fungus, increasing the effectiveness, and in the plants, increasing the persistence of the other fungicides applied in mixture (azoxystrobin and cyproconazole).

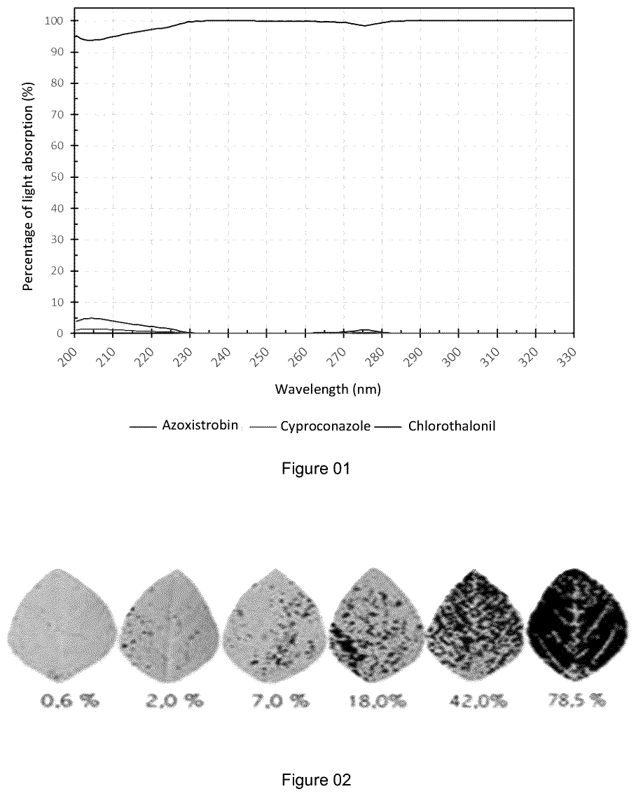

Another factor that contributed to the selection of chlorothalonil as the protective fungicide to compose the mixture of fungicides, objects of this patent application, corresponds to its intense absorption of light at wavelengths critical to the photolysis of the other two actives, thus reducing photodegradation of azoxystrobin and cyproconazole. FIG. 01 shows the information on the percentage of light absorption of the three fungicides in the characteristic concentrations of application at wavelengths between 200 nm and 330 nm. Above 330 nm the light absorption of the three active ingredients was practically null, making it impossible to obtain and present information.

Table 01 shows the averages for the percentages of light absorption in the wavelength ranges that correspond to UVA (partial), UVB and UVC (partial). It was not possible to completely cover the wavelength ranges that correspond to UVC and UVA due to limitations in the available spectrophotometers and the fact that the compounds practically do not absorb light with a wavelength greater than 330 nm.

TABLE 01
Averages of light absorption percentages of azoxystrobin,
cyproconazole and chlorothalonil in the wavelength ranges
that correspond to UVA (partial), UVB and UVC (partial)

| spectrum | Wavelength | Percentage of light absorption | | |
|---|---|---|---|---|
| bands | (nm) | Azoxystrobin | Cyproconazole | Chlorothalonil |
| Partial UVC | 200 a 280 | 1.27173 | 0.38242 | 98.34585 |
| UVB | 280 a 315 | 0.04107 | 0.00943 | 99.94950 |
| Partial UVA | 315 a 330 | 0.00000 | 0.00000 | 100.00000 |

The information contained in FIG. 01 and Table 01 indicate that at typical concentrations of application in the field, chlorothalonil absorbs practically all the ultraviolet light between 200 and 330 nm, showing the potential to be an efficient photoprotector of azoxystrobin and cyproconazole. The second hypothesis considered in the development of the formulation object of this patent application is that, by photoprotecting azoxystrobin and cyproconazole, chlorothalonil contributes to the persistence and effectiveness of these fungicides.

For the purposes of comparison with the other active ingredients of the formulation, chlorothalonil presents average daily rates of degradation of 11.8 and 12.9% only on the surface and on the surface and interior of plant tissues, respectively (http://sitem.herts.ac.uk/aeru/ppdb/en/atoz.htm).

The experiments were designed with the specific purpose of evaluating not only the effectiveness of the triple mixture of fungicides, but also to evaluate the contribution of chlorothalonil in increasing the persistence and effectiveness of the two other fungicides (azoxystrobin and cyproconazole). Therefore, the first objective of this project was to test hypotheses 1 and 2 that indicate that chlorothalonil, in addition to having a fungicidal action, is able to limit the degradation of cyproconazole and azoxystrobin. The second objective was to demonstrate that fungicides complement each other in terms of action, providing high levels of effectiveness under controlled conditions or in field conditions.

We emphasize that improving the dynamics and effectiveness of fungicides allows reducing both doses and number of applications, contributing to the sustainable production of fiber and bioenergy foods.

The analysis of the information presented indicates that the selection of the three active ingredients is consistent and aligned with the most recent knowledge on metabolism, site and mode of action of fungicides. The combination of the three actives corresponds to the first innovation present in the developed product.

Having proven the initial hypotheses that chlorothalonil reduces the degradation of azoxystrobin and cyproconazole, specific technologies were developed to control the biotransformation and photodecomposition of chlorothalonil itself to extend its fungicidal effect and its action by protecting the other active ingredients. The set of technologies to control the availability, biotransformation and photodegradation of chlorothalonil corresponds to the second innovation present in the developed product. 2-Choice of triazole cyproconazole

Triazoles have been used in the control of fungal diseases in humans, animals and agricultural crops in the last four decades, as can be seen in Table 02 which summarizes the main information about these compounds obtained from the PPDB portal: Pesticide Properties DataBase maintained by the University of Hertfordshire (http://sitem.herts.ac.uk/aeru/ppdb/en/atoz.htm) which is one of the most widely used and reliable sources of information on crop protection products worldwide. Only some information was selected that was fundamental for the selection of cyproconazole to compose the innovative formulation of fungicides that this request deals with.

TABLE 02
Compiled of some information about triazole fungicides.

| | | Solubility | | | |
|---|---|---|---|---|---|
| | year of | in water | Log Kow | dissociation | |
| Compound | introduction | mg/L oR PPM | (Log de P) | constant - Pka | Classification |
| fluquinconazole | 1995 | 1.15 | 3.24 | 0.9 | strong acid |
| uniconazole | 1985 | 8.41 | 3.84 | 13.07 | very weak acid |
| difenoconazole | 1988 | 15 | 4.36 | 1.07 | strong acid |
| hexaconazole | 1986 | 18 | 3.9 | 2.3 | strong acid |
| prothioconazole | 2002 | 22.5 | 2 | 6.9 | weak acid |
| metconazole | 1994 | 30.4 | 3.85 | 11.38 | very weak acid |
| tebuconazole | 1986 | 36 | 3.7 | 5 | weak acid |
| bromuconazole | 1990 | 48.3 | 3.24 | 2.75 | strong acid |
| penconazole | 1983 | 73 | 3.72 | 1.51 | very weak base |
| propiconazole | 1980 | 150 | 3.72 | 1.09 | very weak base |
| tetraconazole | 1990 | 156.6 | 3.56 | 0.65 | strong acid |
| azaconazole | 1983 | 300 | 2.36 | 3 | very weak base |
| fenbuconazole | 1992 | 2.47 | 3.79 | Not applicable | no dissociation |
| epoxiconazole | 1993 | 7.1 | 3.3 | Not applicable | no dissociation |
| triticonazole | 1993 | 9.3 | 3.29 | Not applicable | no dissociation |
| cyproconazole | 1986 | 93 | 3.09 | Not applicable | no dissociation |

The first selection criterion was the characteristic of cyproconazole not to undergo ionization. As this compound is neither acidic nor basic, its physical and chemical characteristics remain practically unchanged at different pHs. This is a very desirable feature considering the objective of adding it to two other active ingredients in the new formulation, one of them (chlorothalonil) in a much higher concentration than the others. The second criterion was to search among the non-ionizable triazoles, the one with the highest solubility. The analysis of Table 02 indicates that cyproconazole has a solubility of 93 ppm, much higher than the other non-ionizable triazoles. Even considering all triazoles, cyproconazole has a solubility lower than only three compounds corresponding to two bases and an acid. The search for a non-ionizable triazole with greater solubility is justified considering that the other two fungicides selected to compose the commercial product object of this patent application, azoxystrobin and chlorothalonil, have very low solubilities, of 6.7 and 0.81 ppm., respectively. The concentration of cyproconazole in the formulation is quite low, as well as its doses per hectare, under conditions of commercial use. Even if surfactants were not added to the commercial product or adjuvants to the application, the solubility of 93 ppm of cyproconazole, indicates that this active will be predominantly or completely solubilized in the practical conditions of use common in Brazil. One of the objectives of the project was also to assess whether cyproconazole, being more soluble, would be more easily absorbed than the other compounds included in the formulation (chlorothalonil and azoxystrobin). For the purposes of comparison with the other active ingredients of the formulation, cyproconazole presents average daily rates of degradation of 4.9% only on the surface and 5.8% on the surface and interior of plant tissues, respectively (http://sitem.herts.ac.uk/aeru/ppdb/en/atoz.htm).

In summary, cyproconazole is a compound with a long history of effective and safe use in agriculture, which is not ionizable and with a solubility superior to that presented by most triazole fungicides, azoxystrobin and chlorothalonil. The selection of cyproconazole based on the information presented corresponds to the third innovation included in the developed product.

### 3—Choice of Strobilurin Azoxystrobin.

The choice of azoxystrobin was more complex and had as its starting point the information presented in Table 03, which has as sources the PPDB: Pesticide Properties DataBase portal maintained by the University of Hertfordshire (http://sitem.herts.ac.uk)/aeru/ppdb/en/atoz.htm) and the Pubchem portal maintained by the National Library of Medicine/National Center for Biotechnology Information (https://pubchem.ncbi.nlm.nih.gov/). In the selection process, only strobilurins not protected by patents and most commonly used in Brazil and worldwide were considered. The objective of the formulation developed with the three fungicides is to combine curative and protective action. In addition, it was also relevant to consider information on the persistence of fungicides and characteristics that may interfere with this persistence, such as vapor pressure. The main information is presented in Tables 03 and 04.

For the purposes of comparison with the other active ingredients of the formulation using the same information base (http://sitem.herts.ac.uk/aeru/ppdb/en/atoz.htm), azoxystrobin presents average daily rates degradation of 8.7% only on the surface and 8.3% on the surface and interior of plant tissues, respectively. The values are very close to those found in the detailed literature survey that is presented in Table 04.

The analysis of the information indicates that azoxystrobin is distinguished by being the most soluble, least volatile and most persistent compound in the plant matrix. Another characteristic considered in the selection of azoxystrobin was the log Kow. The work by Bromilow et al. (1990), originally developed taking herbicides as examples, but whose conclusions are applicable to all organic compounds in plants, emphasizes that log Kow values close to 2 indicate maximum ease of compounds to cross biological membranes. Azoxystrobin has a log Kow of 2.5 and, among the strobilurins studied, the one that has the value of this characteristic closest to the value 2, considered ideal by the authors in terms of ease of crossing biological membranes.

In summary, azoxystrobin is a compound with a long history of effective and safe use in agriculture and which stands out from other strobilurins not protected by patents in terms of solubility, Kow Log (indicator of the ease of crossing biological membranes), vapor pressure (volatility indicator) and persistence in the plant matrix. It is worth mentioning the compilation of information on persistence in the plant matrix (Table 04) indicating that azoxystrobin is relatively more persistent than the other strobilurins considered, which is relevant in the construction of a new fungicide whose effects are expected to persist under conditions field. The selection of azoxystrobin based on the information presented corresponds to the fourth innovation included in the developed product.

TABLE 03
Compiled some information about fungicides of the strobilurin group.

| | | | | | | Half life | Plant | Daily |
|---|---|---|---|---|---|---|---|---|
| | | Solubility | log | | Steam | in plants | half-life | percentage of |
| | year of | in water | Kow | | pressure | (number of | (average | degradation |
| Compound | introduction | (mg/L) | Log P | ionization | (mpa) | observations) | in days) | (%) |
| azoxystrobin | 1992 | 6.7 | 2.5 | not ionizable | 1.10E−07 | 24 | 7.15 | 9.24 |
| picoxystrobin | 1999 | 3.1 | 3.6 | not ionizable | 5.50E−03 | 2 | 6.93 | 9.52 |
| pyraclostrobin | 2001 | 1.9 | 3.99 | not ionizable | 2.60E−05 | 9 | 4.33 | 14.78 |
| trifloxystrobin | 2000 | 0.61 | 4.5 | not ionizable | 3.40E−03 | 7 | 6.76 | 9.74 |

TABLE 04
Information on the persistence of strobilurin fungicides in the plant matrix.

| | | | | | | RL50 | RL50 | RL50 | |
|---|---|---|---|---|---|---|---|---|---|
| Compound | Plant | Local | Matrix | Position | Condition | min | max | average | Study citation |
| azoxystrobin | Grape | India | Fruit | In and | Open | 7.00 | 9.10 | 8.05 | Gajbhiye V. T.; |
| | | | | On | field | | | | Mukherjee I.; |
| | | | | | | | | | Singh N.; Dureja |
| | | | | | | | | | P.; Kumar Y. |
| | | | | | | | | | Persistence of |
| | | | | | | | | | Azoxystrobin |
| | | | | | | | | | in/on Grapes and |
| | | | | | | | | | Soil in Different |
| | | | | | | | | | Grapes Growing |
| | | | | | | | | | Areas of India. |
| | | | | | | | | | Bulletin of |
| | | | | | | | | | Environmental |
| | | | | | | | | | Contamination |
| | | | | | | | | | and Toxicology, |
| | | | | | | | | | 2011, 86(1), 90-9. |
| azoxystrobin | Grape | Republic | Fruit | In and | Undercover | 15.58 | 15.58 | 15.58 | Lee C. R.; Horg |
| | | of Korea | | On | | | | | J. H.; Lim J. S.; Lee |
| | | | | | | | | | K. S. Residue |
| | | | | | | | | | Patterns of |
| | | | | | | | | | Azoxystrobin and |
| | | | | | | | | | Cyenopyrafen In |
| | | | | | | | | | Grape between |
| | | | | | | | | | Rainshield and |
| | | | | | | | | | Plastic House |
| | | | | | | | | | Conditions. The |
| | | | | | | | | | Korean Journal |
| | | | | | | | | | of Pesticide |
| | | | | | | | | | Science, 2011, |
| | | | | | | | | | 15(2), 97-103. |
| azoxystrobin | Grape | Republic | Fruit | In and | X (under | 13.28 | 13.28 | 13.28 | Lee C. R.; Horg |
| | | of Korea | | On | rainshield) | | | | J. H.; Lim J. S.; Lee |
| | | | | | | | | | K. S. Residue |
| | | | | | | | | | Patterns of |
| | | | | | | | | | Azoxystrobin and |
| | | | | | | | | | Cyenopyrafen In |
| | | | | | | | | | Grape between |
| | | | | | | | | | Rainshield and |
| | | | | | | | | | Plastic House |
| | | | | | | | | | Conditions. The |
| | | | | | | | | | Korean Journal |
| | | | | | | | | | of Pesticide |
| | | | | | | | | | Science, 2011, |
| | | | | | | | | | 15(2), 97-103. |
| azoxystrobin | Tomato | Poland | Fruit | In and | Undercover | 3.55 | 3.55 | 3.55 | Jankowska M.; |
| | | | | On | | | | | Kaczynski P.; |
| | | | | | | | | | Hrynko I.; |
| | | | | | | | | | Lozowicka B. |
| | | | | | | | | | Dissipation of six |
| | | | | | | | | | fungicides in |
| | | | | | | | | | greenhouse- |
| | | | | | | | | | grown tomatoes |
| | | | | | | | | | with processing |
| | | | | | | | | | and health risk. |
| | | | | | | | | | Environmental |
| | | | | | | | | | Science and |
| | | | | | | | | | Pollution |
| | | | | | | | | | Research], 2016, |
| | | | | | | | | | 23(12), 11885-11900. |
| azoxystrobin | Gojiberry | China | Fruit | In and | Open | 3.40 | 3.40 | 3.40 | Fu Y.; Yang T.; |
| | | | | On | field | | | | Zhao J.; Zhang L.; |
| | | | | | | | | | Chen R.; Wu Y. |
| | | | | | | | | | Determination of |
| | | | | | | | | | eight pesticides |
| | | | | | | | | | in Lycium |
| | | | | | | | | | barbarum by LC- |
| | | | | | | | | | MS/MS and |
| | | | | | | | | | dietary risk |
| | | | | | | | | | assessment. |
| | | | | | | | | | Food Chemistry, |
| | | | | | | | | | 2017, 2018, 192-198. |
| azoxystrobin | Cabbage | China | Leaves | In and | Open | 0.40 | 0.40 | 0.40 | Hou F.; Zhao L; |
| | | | | On | field | | | | Liu F. Residues |
| | | | | | | | | | and dissipation |
| | | | | | | | | | of chlorothalonil |
| | | | | | | | | | and azoxystrobin |
| | | | | | | | | | in cabbage under |
| | | | | | | | | | field conditions. |
| | | | | | | | | | International |
| | | | | | | | | | Journal of |
| | | | | | | | | | Environmental |
| | | | | | | | | | Analytical |
| | | | | | | | | | Chemistry, 2016, |
| | | | | | | | | | 96(12), 1105-1116. |
| azoxystrobin | Banana | China | Whole | In and | Open | 7.60 | 11.60 | 9.60 | Huan Z.; Xu Z.; Lv |
| | | | fruit | On | field | | | | D.; Xie D.; Luo J. |
| | | | | | | | | | Dissipation |
| | | | | | | | | | residues of |
| | | | | | | | | | difenoconazole |
| | | | | | | | | | and azoxystrobin |
| | | | | | | | | | in bananas and |
| | | | | | | | | | soil in two agro- |
| | | | | | | | | | climatic zones of |
| | | | | | | | | | China. Bulletin of |
| | | | | | | | | | Environmental |
| | | | | | | | | | Contamination and |
| | | | | | | | | | Toxicology, 2013, |
| | | | | | | | | | 91(6), 734-738. |
| azoxystrobin | Banana | China | Flesh | In and | Open | 7.50 | 13.50 | 10.50 | Wang S.; Sun H.; |
| | | | | On | field | | | | Liu Y. Dissipation |
| | | | | | | | | | and residues of |
| | | | | | | | | | azoxystrobin in |
| | | | | | | | | | banana under |
| | | | | | | | | | field condition. |
| | | | | | | | | | Environmental |
| | | | | | | | | | Monitoring and |
| | | | | | | | | | Assessment, |
| | | | | | | | | | 2013, 185(9), |
| | | | | | | | | | 7757-7761. |
| azoxystrobin | Ginseng | China | Whole | In and | Open | 1.60 | 1.60 | 1.60 | Hou Z.; Wang X.; |
| | | | plant | On | field | | | | Zhao X., Wang |
| | | | | | | | | | X.; Yuan X.; Lu Z. |
| | | | | | | | | | Dissipation rates |
| | | | | | | | | | and residues of |
| | | | | | | | | | fungicide |
| | | | | | | | | | azoxystrobin in |
| | | | | | | | | | ginseng and soil |
| | | | | | | | | | at two different |
| | | | | | | | | | cultivated |
| | | | | | | | | | regions in China. |
| | | | | | | | | | Environmental |
| | | | | | | | | | Monitoring and |
| | | | | | | | | | Assesment, |
| | | | | | | | | | 2016, 188(7), 1-7. |
| azoxystrobin | Passion | Columbia | Fruit | In and | Open | 13.80 | 13.80 | 13.80 | Juraske R.; |
| | fruit | | | On | field | | | | Fantke P.; |
| | (yellow) | | | | | | | | Romero Ramirez |
| | | | | | | | | | A. C.; Gonzalez A. |
| | | | | | | | | | Pesticide residue |
| | | | | | | | | | dynamics in |
| | | | | | | | | | passion fruits: |
| | | | | | | | | | Comparing field |
| | | | | | | | | | trial and |
| | | | | | | | | | modeling results. |
| | | | | | | | | | Chemosphere, |
| | | | | | | | | | 2012, 89, 850-855. |
| azoxystrobin | Tomato | Poland | Fruit | In and | Undercover | 3.41 | 3.41 | 3.41 | Jankowska M.; |
| | | | | On | | | | | Kaczynski P.; |
| | | | | | | | | | Hrynko I.; |
| | | | | | | | | | Lozowicka B. |
| | | | | | | | | | Dissipation of six |
| | | | | | | | | | fungicides in |
| | | | | | | | | | greenhouse- |
| | | | | | | | | | grown tomatoes |
| | | | | | | | | | with processing |
| | | | | | | | | | and health risk. |
| | | | | | | | | | Environmental |
| | | | | | | | | | Science and |
| | | | | | | | | | Pollution Research], |
| | | | | | | | | | 2016, 23(12), |
| | | | | | | | | | 11885-11900. |
| azoxystrobin | Tomato | Italy | Fruit | In and | Undercover | 9.90 | 14.65 | 12.28 | Cabizza M.; |
| | | | | On | | | | | Dedola F.; Santa |
| | | | | | | | | | M. Residues |
| | | | | | | | | | behavior of some |
| | | | | | | | | | fungicides |
| | | | | | | | | | applied on two |
| | | | | | | | | | greenhouse |
| | | | | | | | | | tomato varieties |
| | | | | | | | | | different in |
| | | | | | | | | | shape and |
| | | | | | | | | | weight. Journal |
| | | | | | | | | | of Environmental |
| | | | | | | | | | Science and |
| | | | | | | | | | Health. 2012, |
| | | | | | | | | | 47(5), 379-384. |
| azoxystrobin | Strawberry | Italy | Fruit | In and | Open | 7.80 | 7.80 | 7.80 | Angioni A.; |
| | | | | On | field | | | | Schirra M.; |
| | | | | | | | | | Garau V. L.; Melis |
| | | | | | | | | | M.; Tuberoso |
| | | | | | | | | | C. I. G.; Cabras P. |
| | | | | | | | | | Residues of |
| | | | | | | | | | azoxystrobin, |
| | | | | | | | | | fenhexzmid and |
| | | | | | | | | | pyrimethanil in |
| | | | | | | | | | strawberry |
| | | | | | | | | | following field |
| | | | | | | | | | treatements and |
| | | | | | | | | | the effect of |
| | | | | | | | | | domestic |
| | | | | | | | | | washing. Food |
| | | | | | | | | | Additives and |
| | | | | | | | | | Contaminants, |
| | | | | | | | | | 2004, 21(11), |
| | | | | | | | | | 1065-1070. |
| azoxystrobin | Soybean | * | Whole | In and | Open | 0.80 | 3.70 | 2.25 | Yin L. D.; Hou |
| | | | plant | On | field | | | | Z. G.; Chen C.; Ji |
| | | | | | | | | | H. M.; Wei X. H.; |
| | | | | | | | | | Lu Z. B.; Wang Y. |
| | | | | | | | | | Residues and |
| | | | | | | | | | decline study of |
| | | | | | | | | | azoxystrobin in |
| | | | | | | | | | soybean. Chinese |
| | | | | | | | | | Journal of |
| | | | | | | | | | Pesticide |
| | | | | | | | | | Science, 2011, |
| | | | | | | | | | 13(3), 304-309. |
| azoxystrobin | Pomegranate | India | Fruit | In and | Open | 2.00 | 4.75 | 3.46 | Utture S. C.; |
| | | | | On | field | | | | Banerjee K.; |
| | | | | | | | | | Dasgupta S.; Patil |
| | | | | | | | | | S. H.; Jadhav M. R.; |
| | | | | | | | | | Wagh S. S.; . . . |
| | | | | | | | | | & Adsule P. G. |
| | | | | | | | | | Dissipation and |
| | | | | | | | | | distribution |
| | | | | | | | | | behavior of |
| | | | | | | | | | azoxystrobin, |
| | | | | | | | | | carbendazim, and |
| | | | | | | | | | difenoconazole |
| | | | | | | | | | in pomegranate |
| | | | | | | | | | fruits. Journal of |
| | | | | | | | | | Agricultural and |
| | | | | | | | | | Food Chemistry, |
| | | | | | | | | | 2011, 59. |
| azoxystrobin | Pepper | India | Fruit | In and | Open | 1.70 | 2.17 | 1.94 | Srinivasan V. M.; |
| | (chilli) | | | On | field | | | | Krishnamoorthy |
| | | | | | | | | | A. S. Dissipation |
| | | | | | | | | | and Harvest |
| | | | | | | | | | Time Residue |
| | | | | | | | | | Analysis of |
| | | | | | | | | | Azoxystrobin in |
| | | | | | | | | | Chilli. Advances |
| | | | | | | | | | in Life Sciences, |
| | | | | | | | | | 2016, 5(14), |
| | | | | | | | | | 5549-5556. |
| azoxystrobin | Pepper | Spain | Fruit | In and | Undercover | 13.54 | 15.21 | 14.40 | Fenoll J.; Ruiz E.; |
| | | | | On | | | | | Hellin P.; Lacasa |
| | | | | | | | | | A.; Flores P. |
| | | | | | | | | | Strobilurin |
| | | | | | | | | | residue levels in |
| | | | | | | | | | greenhouse- |
| | | | | | | | | | grown pepper |
| | | | | | | | | | and under cold- |
| | | | | | | | | | storage conditions. |
| | | | | | | | | | Journal of the |
| | | | | | | | | | Science of Food |
| | | | | | | | | | and Agriculture, |
| | | | | | | | | | 2009, 89(2), 299-303. |
| azoxystrobin | Peach | Uruguay | Fruit | In and | x (under | 0.72 | 0.72 | 0.72 | Galietta G.; |
| | | | | On | rainshield) | | | | Egana E.; Gemelli |
| | | | | | | | | | F.; Maeso D.; |
| | | | | | | | | | Casco N.; Conde |
| | | | | | | | | | P.; Nuenz S. |
| | | | | | | | | | Pesticide |
| | | | | | | | | | dessipation |
| | | | | | | | | | curves in peach, |
| | | | | | | | | | pear and tomato |
| | | | | | | | | | crops in |
| | | | | | | | | | Uruguay. Journal |
| | | | | | | | | | of Environmental |
| | | | | | | | | | Science and |
| | | | | | | | | | Health, 2012, |
| | | | | | | | | | 46(1), 35-40. |
| azoxystrobin | Passion | Columbia | Pulp | In and | Open | 8.00 | 8.00 | 8.00 | Juraske R.; |
| | fruit | | | On | field | | | | Fantke P.; |
| | (yellow) | | | | | | | | Romero Ramirez |
| | | | | | | | | | A. C.; Gonzalez A. |
| | | | | | | | | | Pesticide residue |
| | | | | | | | | | dynamics in |
| | | | | | | | | | passion fruits: |
| | | | | | | | | | Comparing field |
| | | | | | | | | | trial and |
| | | | | | | | | | modeling results. |
| | | | | | | | | | Chemosphere, |
| | | | | | | | | | 2012, 89, 850-855. |
| azoxystrobin | Orange | China | Fruit | In and | Open | 14.00 | 14.10 | 14.05 | Han B.; An-qing |
| | | | | On | field | | | | Y.; Wu H.-M.; |
| | | | | | | | | | Wang M.-C; Qin |
| | | | | | | | | | L. Degradation of |
| | | | | | | | | | Azoxystrobin |
| | | | | | | | | | Residue in |
| | | | | | | | | | Orange and Soil. |
| | | | | | | | | | Agrochemicals, |
| | | | | | | | | | 2009, 48(12), |
| | | | | | | | | | 899-901. |
| azoxystrobin | Mango | * | Fruit | In and | Open | 1.20 | 1.25 | 1.23 | Sundravadana S.; |
| | | | | On | field | | | | Alice D.; |
| | | | | | | | | | Samiyappan R.; |
| | | | | | | | | | Kuttalam S. |
| | | | | | | | | | Determination of |
| | | | | | | | | | azoxystrobin |
| | | | | | | | | | residue by UV |
| | | | | | | | | | detection high |
| | | | | | | | | | performance |
| | | | | | | | | | liquid |
| | | | | | | | | | chromatography |
| | | | | | | | | | in mango. |
| | | | | | | | | | Journal of the |
| | | | | | | | | | Brazilian |
| | | | | | | | | | Chemical |
| | | | | | | | | | Society, 2008, |
| | | | | | | | | | 19(1), 60-63. |
| azoxystrobin | Lettuce | Spain | Leaves | In and | Undercover | 4.87 | 6.23 | 5.55 | Fenoll J.; Hellín |
| | | | | On | | | | | P.; Camacho |
| | | | | | | | | | M. D. M.; López J.; |
| | | | | | | | | | González A.; |
| | | | | | | | | | Lacasa A.; Flores |
| | | | | | | | | | P. Dissipation |
| | | | | | | | | | rates of |
| | | | | | | | | | procymidone |
| | | | | | | | | | and azoxystrobin |
| | | | | | | | | | in greenhouse |
| | | | | | | | | | grown lettuce |
| | | | | | | | | | and under cold |
| | | | | | | | | | storage conditions. |
| | | | | | | | | | Journal of |
| | | | | | | | | | Environmental |
| | | | | | | | | | and Analytical |
| | | | | | | | | | Chemistry, 2008, |
| | | | | | | | | | 88(10), 737-746. |
| azoxystrobin | Grape | Italy | Fruit | On | Open | 15.20 | 15.20 | 15.20 | Cabras P.; |
| | | | | | field | | | | Angioni A.; |
| | | | | | | | | | Garau V. L.; Pirisi |
| | | | | | | | | | F. M.; Espinoza J.; |
| | | | | | | | | | Mendoza A.; |
| | | | | | | | | | Cabitza F.; Pala |
| | | | | | | | | | M.; Brandolini V. |
| | | | | | | | | | Fate of |
| | | | | | | | | | Azoxystrobin, |
| | | | | | | | | | Fluazinam, |
| | | | | | | | | | Kresoxim- |
| | | | | | | | | | methyl, |
| | | | | | | | | | Mepanipyrim, and |
| | | | | | | | | | Tetraconazole |
| | | | | | | | | | from Vine to |
| | | | | | | | | | Wine. Journal of |
| | | | | | | | | | Agricultural and |
| | | | | | | | | | Food Chemistry, |
| | | | | | | | | | 1998, 46, 3249-3251. |
| azoxystrobin | Tomato | India | Fruit | On | Undercover | 0.80 | 2.39 | 1.60 | Anand T.; |
| | | | | | | | | | Chandrasekaran |
| | | | | | | | | | A.; Kuttalam S.; |
| | | | | | | | | | Samiyappan R. |
| | | | | | | | | | Evaluation of |
| | | | | | | | | | azoxystrobin |
| | | | | | | | | | (Amistar 25 SC) |
| | | | | | | | | | against early leaf |
| | | | | | | | | | blight and leaf |
| | | | | | | | | | spot diseases of |
| | | | | | | | | | tomato. Journal |
| | | | | | | | | | of Agricultural |
| | | | | | | | | | Technology, 2010, |
| | | | | | | | | | 6(3), 469-485. |
| picoxystrobin | Peanut | China | Seedlings | In and | Open | 2.10 | 2.80 | 2.45 | Zhu K.; Li P.; |
| | | | | On | field | | | | Feng M.; Hao X.; |
| | | | | | | | | | Han L. |
| | | | | | | | | | Dissipation and |
| | | | | | | | | | residues of |
| | | | | | | | | | picoxystrobin in |
| | | | | | | | | | peanut and field |
| | | | | | | | | | soil by |
| | | | | | | | | | QueEChERS and |
| | | | | | | | | | HPLC-MS/MS. |
| | | | | | | | | | Environmental |
| | | | | | | | | | monitoring and |
| | | | | | | | | | assessment, 2015, |
| | | | | | | | | | 187(8), 1-10. |
| picoxystrobin | Banana | China | Fruit | In and | Open | 10.70 | 12.10 | 11.40 | Wang Y. H.; Yang |
| | | | | On | field | | | | Y. X.; Zhou Q. F.; |
| | | | | | | | | | Lao S. B.; Mo R. F. |
| | | | | | | | | | Dissipation and |
| | | | | | | | | | residue of |
| | | | | | | | | | picoxystrobin in |
| | | | | | | | | | banana and soil |
| | | | | | | | | | under field |
| | | | | | | | | | conditions. |
| | | | | | | | | | Polish Journal of |
| | | | | | | | | | Environmental |
| | | | | | | | | | Studies, 2014, |
| | | | | | | | | | 23(4), 1361-1365. |
| pyraclostrobin | Peanut | India | Leaves | In and | Open | 2.84 | 2.88 | 2.86 | Rao T. N.; Reddy |
| | | | | On | field | | | | E. S.; Reddy G. R.; |
| | | | | | | | | | Sreenlvasulu D.; |
| | | | | | | | | | Ramesh J. |
| | | | | | | | | | Persistence |
| | | | | | | | | | study of |
| | | | | | | | | | pyraclostrobin |
| | | | | | | | | | and epoxiconazole |
| | | | | | | | | | fungicide |
| | | | | | | | | | formulation in |
| | | | | | | | | | groundnut plant |
| | | | | | | | | | followed by |
| | | | | | | | | | HPLC-UV method. |
| | | | | | | | | | International |
| | | | | | | | | | Journal of Current |
| | | | | | | | | | Microbiology |
| | | | | | | | | | and Applied |
| | | | | | | | | | Sciences, 2013, |
| | | | | | | | | | 2(9), 5-13. |
| pyraclostrobin | Rice | China | Whole | In and | Open | 6.30 | 13.90 | 10.10 | Guo X.; Wu W.; |
| | | | plant | On | field | | | | Song N.; Li J.; |
| | | | | | | | | | Kong D.; Kong |
| | | | | | | | | | X.; . . . Shan Z. |
| | | | | | | | | | Residue |
| | | | | | | | | | dynamics and |
| | | | | | | | | | risk assessment |
| | | | | | | | | | of pyraclostrobin |
| | | | | | | | | | in rice, plants, |
| | | | | | | | | | hulls, field soil, |
| | | | | | | | | | and paddy |
| | | | | | | | | | water. Human |
| | | | | | | | | | and Ecological |
| | | | | | | | | | Risk Assessment: |
| | | | | | | | | | An International |
| | | | | | | | | | Journal, 2017, |
| | | | | | | | | | 23(1), 67-81. |
| pyraclostrobin | Grape | Italy | Fruit | In and | Open | 5.40 | 5.40 | 5.40 | Garau V. L.; De |
| | | | | On | field | | | | Melo Abreu S.; |
| | | | | | | | | | Caboni P.; |
| | | | | | | | | | Angioni A.; Alves |
| | | | | | | | | | A.; Cabras P. |
| | | | | | | | | | Residue-free |
| | | | | | | | | | Wines: Fate of |
| | | | | | | | | | Some Quinone |
| | | | | | | | | | outside Inhibitor |
| | | | | | | | | | (QoI) Fungicides |
| | | | | | | | | | in the Winemaking |
| | | | | | | | | | Process. Journal |
| | | | | | | | | | of Agricultural |
| | | | | | | | | | and Food |
| | | | | | | | | | Chemistry, 2009, |
| | | | | | | | | | 57(6), 2329-2333. |
| pyraclostrobin | Strawberry | China | Fruit | In and | Undercover | 4.06 | 4.06 | 4.06 | Zhang Z.-H.; Li |
| | | | | On | | | | | H.-Y.; Wu M.; |
| | | | | | | | | | Yuan Y.-W.; Hu |
| | | | | | | | | | X.-Q.; Zheng W.-R. |
| | | | | | | | | | Residue and |
| | | | | | | | | | Risk Assessment |
| | | | | | | | | | of Chorotalonil, |
| | | | | | | | | | Myclobutanil and |
| | | | | | | | | | Pyraclostrobin in |
| | | | | | | | | | Greenhouse |
| | | | | | | | | | Strawberry. |
| | | | | | | | | | Chinese Journal |
| | | | | | | | | | of Pesticide |
| | | | | | | | | | Science, 2009, |
| | | | | | | | | | 11(4), 449-455. |
| pyraclostrobin | Tomato | | Fruit | In and | Undercover | 2.78 | 2.78 | 2.78 | Jankowska M.; |
| | | | | On | | | | | Kaczynski P.; |
| | | | | | | | | | Hrynko I.; |
| | | | | | | | | | Lozowicka B. |
| | | | | | | | | | Dissipation of six |
| | | | | | | | | | fungicides in |
| | | | | | | | | | greenhouse- |
| | | | | | | | | | grown tomatoes |
| | | | | | | | | | with processing |
| | | | | | | | | | and health risk. |
| | | | | | | | | | Environmental |
| | | | | | | | | | Science and |
| | | | | | | | | | Pollution Research], |
| | | | | | | | | | 2016, 23(12), |
| | | | | | | | | | 11885-11900. |
| pyraclostrobin | Tomato | | Fruit | In and | Undercover | 2.70 | 2.70 | 2.70 | Jankowska M.; |
| | | | | On | | | | | Kaczynski P.; |
| | | | | | | | | | Hrynko I.; |
| | | | | | | | | | Lozowicka B. |
| | | | | | | | | | Dissipation of six |
| | | | | | | | | | fungicides in |
| | | | | | | | | | greenhouse- |
| | | | | | | | | | grown tomatoes |
| | | | | | | | | | with processing |
| | | | | | | | | | and health risk. |
| | | | | | | | | | Environmental |
| | | | | | | | | | Science and |
| | | | | | | | | | Pollution Research], |
| | | | | | | | | | 2016, 23(12), |
| | | | | | | | | | 11885-11900. |
| pyraclostrobin | Green | Egypt | Leaves | On | Open | 4.30 | 4.30 | 4.30 | Hanafi A.; Garau |
| | bean | | | | field | | | | V. L.; Caboni P.; |
| | | | | | | | | | Sarais G.; Cabras |
| | | | | | | | | | P. Minor crops |
| | | | | | | | | | for export: A |
| | | | | | | | | | case study of |
| | | | | | | | | | boscalid, |
| | | | | | | | | | pyraclostrobin, |
| | | | | | | | | | lufenuron and |
| | | | | | | | | | lambda- |
| | | | | | | | | | cyhalothrin |
| | | | | | | | | | residue levels on |
| | | | | | | | | | green beans and |
| | | | | | | | | | spring onions in |
| | | | | | | | | | Egypt. Journal of |
| | | | | | | | | | Environmental |
| | | | | | | | | | Science and Health |
| | | | | | | | | | Part B, 2010, |
| | | | | | | | | | 45(6), 493-500. |
| pyraclostrobin | Strawberry | China | Fruit | On | Undercover | 3.70 | 3.70 | 3.70 | Wang Z.; Cang T.; |
| | | | | | | | | | Qi P.; Zhao X.; Xu |
| | | | | | | | | | H.; Wang X.; . . . |
| | | | | | | | | | Wang X. |
| | | | | | | | | | Dissipation of |
| | | | | | | | | | four fungicides |
| | | | | | | | | | on greenhouse |
| | | | | | | | | | strawberries and |
| | | | | | | | | | na assessment of |
| | | | | | | | | | their risks. Food |
| | | | | | | | | | Control, 2015, |
| | | | | | | | | | 55, 215-220. |
| pyraclostrobin | Spring | Egypt | Leaves | On | Open | 3.10 | 3.10 | 3.10 | Hanafi A.; Garau |
| | onion | | | | field | | | | V. L.; Caboni P.; |
| | | | | | | | | | Sarais G.; Cabras |
| | | | | | | | | | P. Minor crops |
| | | | | | | | | | for export: A |
| | | | | | | | | | case study of |
| | | | | | | | | | boscalid, |
| | | | | | | | | | pyraclostrobin, |
| | | | | | | | | | lufenuron and |
| | | | | | | | | | lambda- |
| | | | | | | | | | cyhalothrin |
| | | | | | | | | | residue levels on |
| | | | | | | | | | green beans and |
| | | | | | | | | | spring onions in |
| | | | | | | | | | Egypt. Journal of |
| | | | | | | | | | Environmental |
| | | | | | | | | | Science and Health |
| trifloxystrobin | Mango | China | Fruit | In and | Open | 9.00 | 9.00 | 9.00 | Mohapatra S. |
| | | | | On | field | | | | Residue levels |
| | | | | | | | | | and dissipation |
| | | | | | | | | | behaviors for |
| | | | | | | | | | trifloxystrobin |
| | | | | | | | | | and |
| | | | | | | | | | tebuconazole in |
| | | | | | | | | | mango fruit and |
| | | | | | | | | | soil. |
| | | | | | | | | | Environmental |
| | | | | | | | | | Monitoring and |
| | | | | | | | | | Assessment, |
| | | | | | | | | | 2005, 187(3), 1-10. |
| trifloxystrobin | Grape | Poland | Fruit | In and | Open | 11.95 | 11.95 | 11.95 | Likas D. T.; |
| | | | | On | field | | | | Tsiropoulos N. G. |
| | | | | | | | | | Residue |
| | | | | | | | | | screening in |
| | | | | | | | | | apple, grape and |
| | | | | | | | | | wine food |
| | | | | | | | | | samples for |
| | | | | | | | | | seven new |
| | | | | | | | | | pesticides using |
| | | | | | | | | | HPLC with UV |
| | | | | | | | | | detection. An |
| | | | | | | | | | application to |
| | | | | | | | | | trifloxystrobin |
| | | | | | | | | | dissipation in |
| | | | | | | | | | grape and wine. |
| | | | | | | | | | Journal of |
| | | | | | | | | | Environmental |
| | | | | | | | | | and Analytical |
| | | | | | | | | | Chemistry, 2009, |
| | | | | | | | | | 89(8-12), 857-869. |
| trifloxystrobin | Grape | Italy | Fruit | In and | Open | 6.40 | 6.40 | 6.40 | Garau V. L.; De |
| | | | | On | field | | | | Melo Abreu S.; |
| | | | | | | | | | Caboni P.; |
| | | | | | | | | | Angioni A.; Alves |
| | | | | | | | | | A.; Cabras P. |
| | | | | | | | | | Residue-free |
| | | | | | | | | | Wines: Fate of |
| | | | | | | | | | Some Quinone |
| | | | | | | | | | outside Inhibitor |
| | | | | | | | | | (QoI) Fungicides |
| | | | | | | | | | in the Winemaking |
| | | | | | | | | | Process. Journal |
| | | | | | | | | | of Agricultural |
| | | | | | | | | | and Food |
| | | | | | | | | | Chemistry, 2009, |
| | | | | | | | | | 57(6), 2329-2333. |
| trifloxystrobin | Pepper | India | Fruit | On | Open | 1.58 | 1.81 | 1.70 | Sahoo S. K.; Jyot |
| | (chilli) | | | | field | | | | G.; Battu R. S.; |
| | | | | | | | | | Singh B. |
| | | | | | | | | | Dissipation |
| | | | | | | | | | Kinetics of |
| | | | | | | | | | Trifloxystrobin |
| | | | | | | | | | and |
| | | | | | | | | | Tebuconazole on |
| | | | | | | | | | Chilli and Soil. |
| | | | | | | | | | Bulletin of |
| | | | | | | | | | Environmental |
| | | | | | | | | | Contamination |
| | | | | | | | | | and Toxicology, |
| | | | | | | | | | 2012, 88(3), 368- |
| | | | | | | | | | 371. |
| trifloxystrobin | Ginseng | China | Stem | On | Open | 6.54 | 7.53 | 7.04 | Wang Y; Wang |
| | | | | | field | | | | C.; Gao J.; Liu C.; |
| | | | | | | | | | Cui L.; Li A. |
| | | | | | | | | | Dissipation, |
| | | | | | | | | | residues, and |
| | | | | | | | | | safety evaluation |
| | | | | | | | | | of trifloxystrobin |
| | | | | | | | | | and tebuconazole on |
| | | | | | | | | | ginseng and soil. |
| | | | | | | | | | Environmental |
| | | | | | | | | | Monitoring and |
| | | | | | | | | | Assessment, |
| | | | | | | | | | 2015, 187(6), 1-11. |
| trifloxystrobin | Ginseng | China | Root | On | Open | 4.59 | 5.46 | 5.03 | Wang Y; Wang |
| | | | | | field | | | | C.; Gao J.; Liu C.; |
| | | | | | | | | | Cui L.; Li A. |
| | | | | | | | | | Dissipation, |
| | | | | | | | | | residues, and |
| | | | | | | | | | safety evaluation |
| | | | | | | | | | of trifloxystrobin |
| | | | | | | | | | and tebuconazole on |
| | | | | | | | | | ginseng and soil. |
| | | | | | | | | | Environmental |
| | | | | | | | | | Monitoring and |
| | | | | | | | | | Assessment, |
| | | | | | | | | | 2015, 187(6), 1-11. |
| trifloxystrobin | Ginseng | China | Leaves | On | Open | 5.14 | 7.27 | 6.21 | Wang Y; Wang |
| | | | | | field | | | | C.; Gao J.; Liu C.; |
| | | | | | | | | | Cui L.; Li A. |
| | | | | | | | | | Dissipation, |
| | | | | | | | | | residues, and |
| | | | | | | | | | safety evaluation |
| | | | | | | | | | of trifloxystrobin |
| | | | | | | | | | and tebuconazole on |
| | | | | | | | | | ginseng and soil. |
| | | | | | | | | | Environmental |
| | | | | | | | | | Monitoring and |
| | | | | | | | | | Assessment, |
| | | | | | | | | | 2015, 187(6), 1-11. |

### Of the Formulation Development Process

The most critical step was the selection of assets, as presented in the previous items. Based on this definition and with sustainability and risk reduction as the main objectives, the main points for improvement that should be incorporated into the new commercial product were identified: 1) increase in the concentration of actives in the formulation, reducing the consumption of raw materials and expenses with transport; 2) use of safer raw materials in toxicological and environmental terms; 3) development of stable formulations during storage and transport; 4) increased deposition with reduced drift losses; 5) development of formulations with dynamics and persistence of each of the active ingredients best suited to the control of pathogens; 6) high efficiency in comparative tests under practical conditions of use.

The six items cited follow both logical and chronological order. In fact, the circuit represented by them was covered several times, obtaining new information and continually improving the prototypes produced. Dozens of experimental formulations were developed and evaluated until it was possible to arrive at the definitive formulation that allows achieving, simultaneously, all the established objectives.

It is worth mentioning that the objective “4) increase deposition with reduction of losses due to drift” is continuously pursued in the process of developing formulations at Ourofino Agrociência. When a plant protection product is applied, it may deposit on the target or suffer drift and other losses. The increase in deposition may increase the effectiveness or persistence of effects with the same applied dose; reduce the applied dose or number of applications without compromising effectiveness. Therefore, increased deposition must always be considered as the basis of formulation strategies, with the aim of increasing the safety of plant protection products for workers, consumers and the environment.

Specifically, it was a great challenge to develop effective and stable formulations containing the three active ingredients with different characteristics in terms of physical state at room temperature and solubility. Azoxystrobin, chlorothalonil and cyproconazole are non-ionizable compounds with physical and chemical characteristics that are slightly altered by pH and with water solubilities of 6.7; 0.81 and 93 mg/L, respectively. The specific masses (densities) of the three compounds are 1.34; 1.74 and 1.26 g/ml, also respectively (http://sitem.herts.ac.uk/aeru/ppdb/en/atoz.htm).

Chlorothalonil, present in the formulation in a much higher concentration than the other active ingredients, has a central role in the development of the innovative formulation that is the object of this patent application. In addition to the ability to control phytopathogens, this compound has demonstrated the ability to protect and reduce the biotransformation and photolysis of azoxystrobin and cyproconazole. It was necessary to develop, evaluate and compare dozens of prototypes until the formulation object of this patent application was validated as the one that maximizes both the effectiveness of chlorothalonil and its protective action for azoxystrobin and cyproconazole.

The objective “5) development of formulations with dynamics and persistence of each of the active ingredients most suitable for the control of pathogens” is quite complex and demands the use of a wide set of technologies. In this case, the photoprotection potential of chlorothalonil to the two other active ingredients present in the formulation and specific solutions was explored to increase or decrease the absorption and reduce the effects of rainwater by removing the compounds from the leaf. Rainwater only removes the compounds that are found outside the leaves and, therefore, a strategy to reduce its effects is to increase the absorption of the compounds. Considering the modes of action of azoxystrobin and cyproconazole, absorption by the leaves is also essential for these fungicides to exert their action. In the case of chlorothalonil, the issue is more complex, considering the protective action of this fungicide, indicating that the ideal would be for this fungicide to remain as long as possible on the surface of the leaves (without being absorbed and without being washed away by rainwater). In terms of photoprotection of the other compounds, permanence on the leaf surface is also desirable. On the other hand, the possible protection of chlorothalonil in terms of biotransformation of cyproconazole and azoxystrobin in plants depends on the absorption of this compound.

To answer all the questions necessary to meet objective 5, discussed in the previous paragraph, the experimental strategy used consisted of carrying out several tests in which the contents of the compounds were always evaluated under the following conditions: 1) contents inside the leaves expressed in ng of compounds/g dry matter of lyophilized leaves; 2) levels of rainwater collected after impact and run-off by plants determined in ng/ml and then expressed in ng of compounds/g of dry matter of lyophilized leaves; 3) external contents removed by washing with a large volume of water, after the occurrence of rain, determined in ng/ml and then expressed in ng of compounds/g of dry matter of lyophilized leaves; 4) the total contents were determined by the sum of the values obtained for conditions 1, 2 and 3 after standardizing the units in which the values were expressed (ng of compounds/g of dry matter of lyophilized leaves). All evaluations were carried out at different periods after the application of the fungicide prototypes so that it was possible to compare the experimental formulations in terms of deposition, absorption and degradation over time. All applications were made with the addition of adjuvant to improve absorption at a concentration compatible with those used in commercial applications of fungicides on soybeans.

For cyproconazole and azoxystrobin, the presentation of information regarding the total and internal levels was prioritized. This information makes it possible to evaluate in a combined way the contribution of the innovations incorporated in each prototype to increase the deposition, absorption and persistence, highlighting the inclusion of adjuvants and chlorothalonil with photoprotection potential and reduction of biotransformations of these two fungicides.

In the case of chlorothalonil, priority was given to the presentation of information regarding the total contents and the contents on the surface of the leaves. This information makes it possible to evaluate, in a combined way, the contribution of the innovations incorporated in each prototype to increase the deposition and presence of chlorothalonil in the regions of the leaf where it exerts its functions as a fungicide and protector of the other fungicides present in the formulation (cyproconazole and azoxystrobin). Comparison of chlorothalonil levels is useful to predict the effects of this fungicide on phytopathogens, but the best way to assess the protective action of this compound on azoxystrobin and cyproconazole is to evaluate the effects on the levels of these fungicides as described in the previous paragraph. It was a great challenge to develop prototypes that to reduce the washing of chlorothalonil by rain and that allowed the compound to remain on the surface of the leaves and absorption in adequate amounts so that chlorothalonil could properly perform all the functions that were expected of it. As already mentioned, 3,258 precise determinations of the levels of fungicides were carried out in soybean leaves, rainwater and washing water after rain application.

After all the determinations of the contents, one last care was necessary. In order to compare the three fungicides evaluated in terms of ease of absorption (reflected in the content inside the leaves) and to compare the experimental prototypes developed to commercial standards, it was necessary to correct the levels as a function of the applied dose. For example, commercial standards are not used in exactly the same doses or proportions of doses of active ingredients that occur in the prototypes developed by Ourofino Agrociencia. To circumvent this limitation, all levels expressed in ng of compounds/g of dry matter of lyophilized leaves were normalized by the dose of each fungicide expressed in g/ha. Thus, the results that will be presented will be expressed in:

$$\frac{ng of compounds / g dry matter of lyophilized leaves}{compound dose in g / ha}$$

Thus, it was possible to establish comparisons between products with different doses of each active ingredient and even between active ingredients applied at different doses.

The following items will present information on the technologies developed to achieve the six objectives that guide the formulation development process at Ourofino Agrociência.

To achieve the above objectives, the present invention, in addition to the active ingredients azoxystrobin, cyproconazole and chlorothalonil in the composition, comprises a surfactant system properly balanced, with surfactants that have dispersing and wetting characteristics.

The surfactant system comprises polyethylene-polypropylene glycol, monobutyl ether, a polyoxyethylene tristyrylphenol phosphate base, potassium salt and a lignosulfonic acid base, sodium salt.

Lignosulfonic acid, sodium salt, are polymerized macromolecules, with characteristics of a polyelectrolyte, are soluble in water, with anionic character. It has binding properties, rheological control and dispersion, emulsion stabilization, humidification, suspensibility and redispersibility.

Propoxylated ethoxylated butyl alcohol is an etho-propoxylated nonionic surfactant, mainly to act as an emulsifier and dispersing agent in agrochemical formulations. Used in combination with other surfactants, it provides an excellent balance between the surfactants, providing stability in the formulation and benefits in the applicability of the product. Thanks to its non-anionic nature it is effective over a wide range of pH, lipophilicity and ionic strength.

Polyoxyethylene Tristyrylphenol Phosphate, Potassium Salt is a TSP ethoxylated anionic surfactant, primarily developed to act as an emulsifier and dispersing agent in agrochemical formulations.

Tristyrylphenol ethoxylated surfactants are excellent dispersing and emulsifying agents, presenting great versatility of use within this range of surfactants, several non-ionic and anionic moieties are available.

The combination of these properly balanced surfactants provides the developed product with excellent physical-chemical stability, such as dispersibility, agglomerating properties, rheological control, emulsion stabilization, humidification, suspensibility, redispersibility, ease in the manufacturing process, inhibition of the growth of crystals, UV protection, antioxidant and complex formation.

In summary, the present invention refers to a composition and formulations based on the fungicides azoxystrobin, cyproconazole and chlorothalonil in high concentrations, comprising a surfactant system plus components in the formulation in association with different concentrations of the active ingredients and high load. In particular, the invention relates to highly loaded compositions of azoxystrobin, cyproconazole and chlorothalonil that show reductions in fungicide losses by washing off rainwater after application and by drifting, deposition and spreading on the surface of the leaves, less photodegradation of the azoxystrobin and/or other strobilurins and cyproconazole and/or other triazoles due to the action of chlorothalonil as a photoprotector of these active ingredients, thus promoting greater ease of absorption and penetration of fungicides in the leaves, and better translocation in plants, resulting in greater effectiveness in the control of Asian rust and leaf spot on soybean and other diseases in different agricultural crops.

The main objective of the present invention is to achieve a composition that promotes an increase in the concentration of the fungicides azoxystrobin and/or other strobilurins, cyproconazole and/or other triazoles and chlorothalonil with photoprotective action to others to be applied to plants, so that in addition to its effective fungicidal effect and greater speed of control action, it also presents itself with the objective of reducing the possible processes of loss of the active ingredients present in the formulation by rainwater, thus reducing the environmental impact, in addition to minimize transport, storage and, mainly, packaging disposal expenses.

More specifically, combinations comprising different concentrations of azoxystrobin, cyproconazole and high-load chlorothalonil and a surfactant system were explored, with the objective of increasing the concentration of fungicides, that is, improving their effectiveness and dynamics in plants regarding control of different diseases in crops, such as Asian soybean rust.

However, the present invention, despite the increase in the concentration of fungicides in plants, does not compromise the effectiveness, the selectivity of soybean, corn and cotton, among other crops, in addition to promoting greater safety for farmers, consumers and for the environment.

More specifically, the components of the composition of the present invention are presented in properly balanced proportions, resulting in greater agronomic efficiency in the management of Asian rust and leaf spot in soybeans, among other diseases in different agricultural crops, as well as selectivity to crops conventional and transgenic soybeans, corn and cotton, thus contributing to the preservation of the productive potential of these crops. Additionally, the composition of the present invention also has low toxicity to man and the environment, in addition to providing low production cost.

The present invention also relates to a formulation derived from said composition in the form of a concentrated suspension, in order to obtain in a single package, a ready formulation that is dissolved in situ, directly in the water tank suitable for spraying. in the field.

More specifically still, therefore, the present invention also includes concentrated fungicidal formulations, containing azoxystrobin, cyproconazole and chlorothalonil of high loading and components properly balanced using a surfactant system. Said formulations aim to facilitate the deposition and spreading of fungicides on the surface of the leaves, absorption and penetration into the plant leaf and translocation in the plant.

The combination of a properly balanced surfactant system, with surfactants that have dispersant and wetting characteristics used in these fungicides consist of a set of surfactants based on polyethylene-polypropylene glycol, monobutyl ether, a base of polyoxyethylene tristyrylphenol phosphate, salt of potassium and a base of lignosulfonic acid, sodium salt.

Lignosulfonic acid and sodium salt are polymerized macromolecules with characteristics of a polyelectrolyte, are soluble in water, and with anionic character. It has binding properties, rheological control and dispersion, emulsion stabilization, humidification, suspensibility and redispersibility.

Propoxylated ethoxylated butyl alcohol is an etho-propoxylated nonionic surfactant, mainly to act as an emulsifier and dispersing agent in agrochemical formulations. Using in combination with other surfactants provides an excellent balance between the surfactants providing stability in the formulation and benefits in the applicability of the product. Thanks to its non-anionic nature it is effective over a wide range of pH, lipophilicity and ionic strength.

Polyoxyethylene Tristyrylphenol Potassium Phosphate is a TSP ethoxylated anionic surfactant, primarily developed to act as an emulsifier and dispersing agent in agrochemical formulations. Tristyrylphenol ethoxylated surfactants are excellent dispersing and emulsifying agents, presenting great versatility of use within this range of surfactants, several non-ionic and anionic moieties are available.

The combination of these properly balanced surfactants provides the developed product with excellent physical-chemical stability, such as dispersibility, agglomerating properties, rheological control, emulsion stabilization, humidification, suspensibility, redispersibility, ease in the manufacturing process, inhibition of the growth of crystals, UV protection, antioxidant and complex formation.

The fungicidal composition of the present invention contains as active ingredients, Chlorothalonil at a concentration of 46.99% to 50.75% w/w of the composition, with a photoprotective effect of the other active ingredients, Azoxystrobin at a concentration of 3.58% to 4.38% w/w of the composition and Cyproconazole at a concentration of 1.02% to 1.38% w/w of the composition.

The fungicidal composition of the present invention also contains Propylene glycol in a concentration of 1.00% to 20.00% w/w of the composition, 1,2-benzisothiazolin-3-one in a concentration of 0.10% to 1, 00% w/w of the composition, Poly(dimethylsiloxane) at a concentration of 0.50% to 2.00% w/w of the composition, Xanthan gum at a concentration of 0.05% to 0.20% w/w of the composition, and water at a concentration of 20.00% to 40.00% w/w of the composition.

The fungicidal composition of the present invention may additionally contain at least one surfactant in a concentration of 0.50% to 20.00% w/w of the composition selected from Polyethylene-polypropylene glycol monobutyl ether, Polyoxyethylene tristyrylphenol phosphate, potassium salt, Lignosulfonic acid sodium salt, Sodium alkylnaphthalenesulfonate condensed formaldehyde, N,N-dimethyldodecylamine oxide, and/or Lignosulfonic acid sodium salt.

The fungicidal composition of the present invention may additionally contain Titanium Dioxide in a concentration of 1.00% to 4.00% w/w of the composition.

The fungicidal composition of the present invention may additionally contain Polyvinylpyrrolidone at a concentration of 0.50% to 3.00% w/w of the composition.

In the table below is an example of the composition of the fungicide of the present invention.

TABLE 05
Exemplified composition of the fungicide of the present invention.

| | | | CAS | Concentration |
|---|---|---|---|---|
| Function | | Components | Number | (% w/w) |
| active | Fungicide | Technical azoxystrobin | 131860-33-8 | 3.58-4.38 |
| ingredient | Azoxystrobin | (100%) | | |
| active | Fungicide | Technical Cyproconazole | 94361-06-5 | 1.02-1.38 |
| ingredient | Cyproconazole | (100%) | | |
| active | Fungicide | Technical Chlorothalonil | 1897-45-6 | 46.99-50.75 |
| ingredient | Chlorothalonil | (100%) | | |
| antifreeze | | propylene glycol | 57-55-6 | 3.00-10.00 |
| surfactant | | Polyethylene-polypropylene | 9038-95-3 | 2.00-7.00 |
| | | glycol monobutyl ether | | |
| defoamer | | Poly(dimethylsiloxane) | 63148-62-9 | 0.50-2.00 |
| biocide | | 1,2-benzisothiazolin-3-one | 2634-33-5 | 0.10-1.00 |
| thickener | | xanthan gum | 11138-66-2 | 0.05-0.20 |
| surfactant | | Polyoxyethylene | 163436-84-8 | 1.00-7.00 |
| | | Tristyrylphenol Phosphate | | |
| | | Potassium Salt | | |
| surfactant | | Lignosulfonic acid sodium | 8061-51-6 | 1.00-5.00 |
| | | salt | | |
| solvent | | water | 7732-18-5 | 20.00-40.00 |

* Variation considering the maximum and minimum of the other inert materials. Density = 1,330 g/mL

In the table below some of the formulations derived from the composition of the present invention are listed.

TABLE 06
Examples of developed prototypes of agricultural fungicides
containing azoxystrobin, cyproconazole and chlorothalonil.

| | Formulations | | | | | |
|---|---|---|---|---|---|---|
| | P01 | P02 | P03 | P04 | P05 | |
| Formulation components | % w/w | % w/w | % w/w | % w/w | % w/w | Function |
| Technical azoxystrobin | 3.58- | 3.58- | 3.58- | 3.58- | 3.58- | active |
| (100%) | 4.38 | 4.38 | 4.38 | 4.38 | 4.38 | ingredient |
| Technical Cyproconazole | 1.02- | 1.02- | 1.02- | 1.02- | 1.02- | active |
| (100%) | 1.38 | 1.38 | 1.38 | 1.38 | 1.38 | ingredient |
| Technical Chlorothalonil | 46.99- | 46.99- | 46.99- | 46.99- | 46.99- | active |
| (100%) | 50.75 | 50.75 | 50.75 | 50.75 | 50.75 | ingredient |
| propylene glycol | 3.00- | 3.00- | 3.00- | 3.00- | 3.00- | antifreeze |
| | 15.00 | 10.00 | 10.00 | 10.00 | 10.00 | |
| Polyethylene-polypropylene | 5.00- | 5.00- | 5.00- | 5.00- | 2.00- | surfactant |
| glycol monobutyl ether | 10.00 | 15.00 | 10.00 | 10.00 | 7.00 | |
| Poly(dimethylsiloxane) | 0.50- | 0.50- | 0.50- | 0.50- | 0.5- | defoamer |
| | 2.00 | 2.00 | 2.00 | 2.00 | 2.00 | |
| 1,2-benzisothiazolin-3-one | 0.10- | 0.10- | 0.10- | 0.10- | 0.10- | biocide |
| | 1.00 | 1.00 | 1.00 | 1.00 | 1.00 | |
| xanthan gum | 0.05- | 0.05- | 0.05- | 0.05- | 0.05- | thickener |
| | 0.20 | 0.20 | 0.20 | 0.20 | 0.20 | |
| Sodium | 1.00- | 1.00- | 1.00- | 1.00- | 1.0- | surfactant |
| alkylnaphthalenesulfonate | 5.00 | 5.00 | 5.00 | 10.00 | 7.00 | |
| condensed formaldehyde | | | | | | |
| Water | 20.00- | 20.00- | 20.00- | 20.00- | 20.00- | solvent |
| | 40.00 | 40.00 | 40.00 | 40.00 | 40.00 | |
| | Formulations | | | | | |
| | P06 | P07 | P08 | P09 | P10 | |
| Formulation components | % w/w | % w/w | % w/w | % w/w | % w/w | Function |
| Technical azoxystrobin | 3.58- | 3.58- | 3.58- | 3.58- | 3.58- | active |
| (100%) | 4.38 | 4.38 | 4.38 | 4.38 | 4.38 | ingredient |
| Technical Cyproconazole | 1.02- | 1.02- | 1.02- | 1.02- | 1.02- | active |
| (100%) | 1.38 | 1.38 | 1.38 | 1.38 | 1.38 | ingredient |
| Technical Chlorothalonil | 46.99- | 46.99- | 46.99- | 46.99- | 46.99- | active |
| (100%) | 50.75 | 50.75 | 50.75 | 50.75 | 50.75 | ingredient |
| propylene glycol | 3.00- | 3.00- | 3.00- | 5.00- | 1.00- | antifreeze |
| | 10.00 | 10.00 | 10.00 | 8.00 | 10.00 | |
| Polyethylene-polypropylene | 5.00- | 5.00- | 5.00- | 2.00- | 2.00- | surfactant |
| glycol monobutyl ether | 10.00 | 10.00 | 10.00 | 10.00 | 7.00 | |
| Poly(dimethylsiloxane) | 0.50- | 0.50- | 0.50- | 0.50- | 0.50- | defoamer |
| | 2.00 | 2.00 | 2.00 | 2.00 | 2.00 | |
| 1,2-benzisothiazolin-3-one | 0.10- | 0.10- | 0.10- | 0.10- | 0.10- | biocide |
| | 1.00 | 1.00 | 1.00 | 1.00 | 1.00 | |
| xanthan gum | 0.05- | 0.05- | 0.05- | 0.05- | 0.05- | thickener |
| | 0.20 | 0.20 | 0.20 | 0.20 | 0.20 | |
| Titanium dioxide | — | 1.00- | 1.00- | — | — | load |
| | | 4.00 | 4.00 | | | |
| polyvinylpyrrolidone | — | — | 0.50- | — | — | sticker |
| | | | 3.00 | | | |
| Sodium | 0.50- | 1.00- | 1.00- | 2.00- | 1.0- | surfactant |
| alkylnaphthalenesulfonate | 7.00 | 5.00 | 5.00 | 5.00 | 7.00 | |
| condensed formaldehyde | | | | | | |
| water | 20.00- | 20.00- | 20.00- | 20.00- | 20.00- | solvent |
| | 40.00 | 40.00 | 40.00 | 40.00 | 40.00 | |
| | Formulations | | | | | |
| | P11 | P12 | P13 | P14 | P15 | |
| Formulation components | % w/w | % w/w | % w/w | % w/w | % w/w | Function |
| Technical azoxystrobin | 3.58- | 3.58- | 3.58- | 3.58- | 3.58- | active |
| (100%) | 4.38 | 4.38 | 4.38 | 4.38 | 4.38 | ingredient |
| Technical Cyproconazole | 1.02- | 1.02- | 1.02- | 1.02- | 1.02- | active |
| (100%) | 1.38 | 1.38 | 1.38 | 1.38 | 1.38 | ingredient |
| Technical Chlorothalonil | 46.99- | 46.99- | 46.99- | 46.99- | 46.99- | active |
| (100%) | 50.75 | 50.75 | 50.75 | 50.75 | 50.75 | ingredient |
| propylene glycol | 3.00- | 3.00- | 3.00- | 3.00- | 3.00- | antifreeze |
| | 10.00 | 10.00 | 10.00 | 20.00 | 10.00 | |
| Polyethylene-polypropylene | 5.00- | 5.00- | 5.00- | 5.00- | 2.00- | surfactant |
| glycol monobutyl ether | 10.00 | 10.00 | 20.00 | 15.00 | 7.00 | |
| Poly(dimethylsiloxane) | 0.50- | 0.50- | 0.50- | 0.20- | 0.50- | defoamer |
| | 2.00 | 2.00 | 5.00 | 2.00 | 2.00 | |
| 1,2-benzisothiazolin-3-one | 0.10- | 0.10- | 0.10- | 0.10- | 0.10- | biocide |
| | 1.00 | 1.00 | 1.00 | 1.00 | 1.00 | |
| xanthan gum | 0.05- | 0.05- | 0.05- | 0.05- | 0.05- | thickener |
| | 0.20 | 0.20 | 0.20 | 0.20 | 0.20 | |
| Polyoxyethylene | — | — | — | — | 1.0- | surfactant |
| tristyrylphenol phosphate | | | | | 7.00 | |
| Sodium | 1.00- | 1.00- | 1.00- | 1.00- | — | surfactant |
| alkylnaphthalenesulfonate | 5.00 | 5.00 | 5.00 | 5.00 | | |
| condensed formaldehyde | | | | | | |
| N,N-dimethyldodecylamine | 2.00- | 5.00- | — | — | — | surfactant |
| oxide | 14.00 | 18.00 | | | | |
| Lignosulfonic acid sodium | — | — | — | — | 1.00- | surfactant |
| salt | | | | | 5.00 | |
| water | 20.00- | 20.00- | 20.00- | 20.00- | 20.00- | solvent |
| | 40.00 | 40.00 | 40.00 | 40.00 | 40.00 | |

4) increased deposition with reduced drift losses;

5) development of formulations with dynamics and persistence of each of the most suitable active ingredients to control pathogens; Drift and deposition are opposite phenomena.

The drift indicates losses during the application process and the deposition indicates how much of the applied product effectively deposited on the target (soybean plants in this case). Today, drift is identified as the main cause of environmental losses and contamination related to the application of pesticides. Reducing drift is critical to increasing deposition and efficiency, reducing environmental contamination and, by reducing the amount of droplets in suspension, reducing the exposure of workers involved in the application.

When flat targets such as the ground surface are used, performing a mass balance of the application accurately determining deposition and drift is relatively simple. However, in plants, with great variation in architecture, leaf area and morphology, performing a mass balance is not possible and the most appropriate procedure is to measure the deposition or deposit of the compounds applied per unit area or mass of the plant.

It is very relevant to conduct evaluations under conditions that are representative of practical application conditions in terms of application technology and characteristics of application solutions. In this case, the information produced in the comparative dynamics studies conducted with the objective of comparing the prototypes of formulations with each other and with the main commercial standard was used. Applications were made under controlled conditions at a speed of 1 m/s, using XR 110.02 tips, pressure of 2 Bar and application rate of 200 L/ha, temperature of 28° C. and relative humidity of 56%. The application was made with high precision experimental equipment that allows the control of the mentioned operational variables. The study was conducted using soybean plants at stage V6 as a target, with five replications for each active ingredient. In the experiment prioritized in terms of presenting information for this patent application, the treatments confronted were: 1) application of eight prototype formulations at a dose of 1.5 L/ha, conditioning doses of azoxystrobin, cyproconazole and chlorothalonil of 79.5, 24 and 975 g/ha, respectively; 2) treatment with the commercial standard azoxystrobin+mancozeb (commercial standard 1), at a dose of 1.5 L/ha, conditioning doses of the compounds azoxystrobin and mancozeb of 75 and 1,050 g/ha, respectively; commercial standard azoxystrobin+cyproconazole+mancozeb (commercial standard 2) at a dose of 1.5 L/ha, conditioning doses of azoxystrobin, cyproconazole and mancozeb of 45, 18 and 900 g/ha, respectively. All treatments received the addition of mineral oil adjuvant at a concentration of 0.50% (equivalent to 0.5 L/ha). The study was conducted with five replications and three evaluation periods: 03, 06 and 11 days after application (DAA). During the entire experimental period, the plots were kept in a greenhouse at night and outdoors during the day. This care was necessary considering that both glass and polycarbonate, covering materials for the greenhouse, do not adequately transmit ultraviolet light, making it impossible to carry out studies involving photolysis inside these structures and the like. Glass and polycarbonate practically do not transmit UVB and UVC, the most absorbed by the test fungicides.

As already described, all experimental units were subjected to rains of 20 mm at 02, 05 and 10 DAA, 24 hours before each evaluation at 03, 06 and 11 DAA. The levels of fungicides inside the leaves, in the rainwater after impact and run-off by the plants and remaining on the leaf surface after the rain were determined. The values were summed to determine the total content of the compounds.

As already exposed, the application doses of the compounds were different between the treatments, requiring that the data be corrected (divided) by the application doses expressed in g/ha. In summary, the result provided by the application of 1 g/ha of each of the compounds was determined in terms of the amount present in one gram of lyophilized soybean leaf.

The main results obtained are shown in Tables 05 to 10. All values of the F Test applied to analysis of variance for treatments were significant at 5% and 1% probability levels. The averages observed for Prototype 3, selected to be commercially produced and object of this patent application, were also represented as percentages of the averages of all other prototypes, all other treatments and commercial standards used. The values of the minimum significant difference by the T test at the 5% probability level and the percentile are also reported.

The percentile represents the percentage of the total treatments (prototypes and commercial standards) that presented averages lower than the average of Prototype 3. The average values of the Prototype 3 percentiles for all information on the levels of fungicides at 03, 06 and 11 DAA were 85.5%, 100% and 100%, respectively. The results indicate superior performance of Prototype 3 in relation to practically all other prototypes and standards in the first evaluation, superior to all other treatments at 06 and 11 DAA. Considering the objective of the new commercial product, which is to prevent the incidence of phytopathogens in the plant, to control the evolution of the disease (severity) from the already established incidence and to avoid new infections with phytopathogens, the evaluations at 06 and 11 DAA are particularly relevant and indicate that Prototype 3 stood out in relation to the other prototypes and commercial standards, always having the best performance, with the highest levels of fungicides in regions considered critical for prevention and control.

The analysis of the averages observed for Prototype 3 expressed as percentages of the averages: 1.) of the other prototypes; 2.) commercial prototypes and standards and 3.) commercial standards; they also leave no doubt about the consistency of Prototype 3's superior performance, regardless of the active ingredient considered. The advantages of this prototype increase with time and reach maximum values at 11 DAA, which is consistent with the objectives of the project and the built invention. In addition to the initial efficacy, a formulation was sought to increase persistence, extending the control of phytopathogens under field conditions. There is no doubt that the formulation developed and object of this patent application will contribute to the sustainable control of phytopathogens.

It is also relevant to compare the three fungicides in general terms so that the company can improve its formulation strategies and products in the future. The information base constituted is unique and will certainly be very useful for Ourofino Agrociência. In the first evaluation period (03 DAA) the average total levels for all commercial products and evaluated prototypes, considering a total of 40 to 50 repetitions, indicated average total levels of chlorothalonil, azoxystrobin and cyproconazole of 210, 352 and 267 (ng/g)/(g/ha) or, simply, ng.ha/g2. In the second evaluation (06 DAA) the average values were 132, 188 and 173 ng.ha/g2. In the third evaluation (11 DAA) the mean values were 66, 114 and 83 ng.ha/g2.

Considering that the three fungicides were applied in a mixture, the differences observed for each commercial product or prototype do not refer to differences in deposition, but to differences in terms of degradation speed in the first evaluation period. Literature information indicates that chlorothalonil is the fastest degraded active ingredient and this behavior also occurred in this study. However, the greater stability of azoxystrobin compared to cyproconazole was evident, contrary to the information in the literature. The information obtained in this study has a very large number of replications and considering application techniques similar to those used in the field, indicating that azoxystrobin may contribute more than expected in terms of the duration of fungicidal effects under field conditions.

The data obtained also allow comparing azoxystrobin and cyproconazole in terms of absorption, a fundamental information considering the type of action of the two compounds that demand entry into the leaves for greater effectiveness in the control of phytopathogens. It was possible to estimate the percentage of the internal content in relation to the total content of the two fungicides considering the information for all prototypes and commercial standards. The repeat numbers for azoxystrobin and cyproconazole were, respectively, 50 and 45 in each evaluation period. For azoxystrobin the mean values found at 03, 06 and 11 DAA were 29, 29 and 31% respectively. For cyproconazole the mean values were 69, 62 and 85% also respectively. If, on the one hand, cyproconazole was degraded faster than azoxystrobin, on the other hand, it was absorbed more efficiently and, possibly, stands out in the initial control of phytopathogens soon after application.

In the right part of Tables 07 to 12, the contents of the compounds observed at 06 and 11 DAA are represented in percentages of the average values observed at 03 DAA. There is no commercial standard for chlorothalonil and the comparison between the prototypes indicates that Prototypes 3, 9 and 10 were the ones with the lowest rates of degradation (higher percentages of the values observed at 3 DAA) indicating that the innovations developed by Ourofino Agrociência to increasing the persistence of chlorothalonil were effective. It is important to emphasize that the reduction of degradation is relevant, but when comparing the levels of chlorothalonil, especially at 11 DAA, Prototype 3 was superior to all the others, including Prototypes 9 and 10.

When the total and internal levels of azoxystrobin were expressed as a percentage of the values observed at 3 DAA, it was evident that the presence of chlorothalonil and other technologies incorporated by Ourofino Agrociência to the prototypes were fundamental to increase the stability of this compound allowing greater efficiencies and control periods can be obtained. The analysis of all the information presented in Tables 9 and 10, prioritizing the information obtained at 11 DAA, shows the superior performance of Prototype 3 in relation to the other prototypes and, above all, in relation to commercial standards. Considering the internal levels of azoxystrobin at 11 DAA, Prototype 3, one of the objects of this patent application, showed average gains of 54%, 76% and 255% when compared to the average of the other prototypes, of the other treatments (prototypes and commercial standards) and commercial standards, respectively.

Similarly, when the total and internal levels of cyproconazole were expressed as a percentage of the values observed at 3 DAA, it was evident that the presence of chlorothalonil and other technologies incorporated by Ourofino Agrociência to the prototypes were fundamental to increase the stability of this also fungicide allowing greater efficiencies and control periods to be obtained. The analysis of all the information presented in Tables 11 and 12, prioritizing the information obtained at 11 DAA, shows the superior performance of Prototype 3 in relation to the other prototypes and, above all, in relation to commercial standards. Considering the internal levels of cyproconazole at 11 DAA, Prototype 3, object of this patent application, showed average gains of 36%, 46% and 213% when compared to the average of the other prototypes, the other treatments (prototypes and commercial standards) and commercial standards, respectively.

TABLE 07
Total levels of chlorothalonil in
soybean leaves at 3, 6 and 11 DAA.

| | (ng of chlorothalonil/ | | | Percentage of | | |
|---|---|---|---|---|---|---|
| | g of MS)/(g/ha) | | | value at 3DAA | | |
| prototypes | 3DAA | 6DAA | 11DAA | 3DAA | 6DAA | 11DAA |
| 3 (selected) | 269.09 | 188.59 | 101.46 | 100 | 71.17 | 38.64 |
| 1 | 246.75 | 139.89 | 70.95 | 100 | 58.70 | 29.69 |
| 2 | 299.26 | 167.51 | 97.48 | 100 | 57.15 | 32.85 |
| 4 | 143.06 | 107.52 | 37.05 | 100 | 76.30 | 26.53 |
| 7 | 121.30 | 78.67 | 21.23 | 100 | 66.73 | 17.73 |
| 8 | 209.28 | 136.64 | 50.16 | 100 | 65.37 | 23.98 |
| 9 | 179.93 | 120.35 | 73.97 | 100 | 67.99 | 41.46 |
| 10 | 210.61 | 114.78 | 77.88 | 100 | 57.16 | 39.72 |
| F Treatments | 10.24 | 20.26 | 21.28 | — | 1.01 | 5.07 |
| dms t (5%) | 39.07 | 15.78 | 12.53 | — | 14.19 | 7.63 |
| CV | 20.32 | 13.08 | 20.63 | — | 23.80 | 26.61 |
| 100*M3/M of | 133.57 | 152.55 | 165.66 | — | 110.85 | 127.60 |
| the other | | | | | | |
| prototypes | | | | | | |
| percentile | 87.50 | 100 | 100 | — | 87.50 | 75.00 |

TABLE 08
Chlorothalonil contents on the surface of soybean
leaves after 20 mm rain, at 3, 6 and 11 DAA.

| | (ng of chlorothalonil/ | | | Percentage of | | |
|---|---|---|---|---|---|---|
| | g of MS)/(g/ha) | | | value at 3DAA | | |
| prototypes | 3DAA | 6DAA | 11DAA | 3DAA | 6DAA | 11DAA |
| 3 (selected) | 139.07 | 85.15 | 48.83 | 100 | 62.49 | 36.59 |
| 1 | 117.32 | 72.01 | 30.68 | 100 | 66.77 | 26.61 |
| 2 | 151.67 | 84.68 | 41.91 | 100 | 61.59 | 26.83 |
| 4 | 55.88 | 51.01 | 14.92 | 100 | 93.82 | 27.76 |
| 7 | 47.32 | 21.18 | 4.90 | 100 | 45.33 | 10.55 |
| 8 | 115.14 | 55.88 | 14.20 | 100 | 48.30 | 12.55 |
| 9 | 96.23 | 57.82 | 30.76 | 100 | 64.52 | 32.46 |
| 10 | 93.45 | 43.90 | 35.47 | 100 | 68.67 | 57.91 |
| F Treatments | 5.44 | 13.16 | 8.42 | — | 1.70 | 2.97 |
| dms t (5%) | 32.32 | 12.16 | 10.65 | — | 23.14 | 17.55 |
| CV | 34.58 | 22.51 | 41.95 | — | 39.52 | 66.29 |
| 100*M3/M of | 143.79 | 154.23 | 197.76 | — | 97.43 | 131.57 |
| the other | | | | | | |
| prototypes | | | | | | |
| percentile | 87.50 | 100 | 100 | — | 50.00 | 87.50 |

TABLE 09
Total levels of azoxystrobin in soybean leaves at 3, 6 and 11 DAA.

| | (ng of chlorothalonil/ | | | Percentage of | | |
|---|---|---|---|---|---|---|
| | g of MS)/(g/ha) | | | value at 3DAA | | |
| prototypes | 3DAA | 6DAA | 11DAA | 3DAA | 6DAA | 11DAA |
| 3 (selected) | 449.20 | 285.84 | 169.00 | 100.00 | 64.38 | 37.92 |
| 1 | 453.26 | 226.87 | 119.74 | 100.00 | 51.05 | 26.81 |
| 2 | 502.11 | 251.59 | 153.06 | 100.00 | 50.71 | 30.77 |
| 4 | 319.14 | 147.93 | 100.97 | 100.00 | 46.53 | 32.00 |
| 7 | 273.56 | 178.14 | 108.80 | 100.00 | 65.55 | 39.75 |
| 8 | 317.67 | 176.03 | 106.64 | 100.00 | 56.38 | 34.68 |
| 9 | 336.32 | 180.91 | 112.70 | 100.00 | 53.83 | 33.49 |
| 10 | 261.03 | 133.49 | 75.37 | 100.00 | 51.85 | 28.90 |
| Commercial | 357.83 | 186.49 | 121.80 | 100.00 | 52.32 | 33.81 |
| Standard 1 | | | | | | |
| Commercial | 251.24 | 118.89 | 75.40 | 100.00 | 47.12 | 30.11 |
| Standard 2 | | | | | | |
| F Treatments | 13.37 | 14.01 | 5.00 | — | 1.76 | 1.09 |
| dms t (5%) | 48.68 | 28.43 | 26.85 | — | 9.89 | 7.74 |
| CV | 15.24 | 16.62 | 25.89 | — | 20.20 | 26.01 |
| 100*M3/M of | 127.66 | 154.51 | 152.20 | — | 119.89 | 117.25 |
| the other | | | | | | |
| prototypes | | | | | | |
| 100*M3/M of | 131.59 | 160.75 | 156.08 | — | 121.90 | 117.56 |
| the other | | | | | | |
| treatments | | | | | | |
| 100*M3/M of | 147.50 | 187.20 | 171.40 | — | 129.49 | 118.65 |
| commercial | | | | | | |
| standards | | | | | | |
| percentile | 80.00 | 100.00 | 100.00 | — | 90.00 | 90.00 |

TABLE 10
Internal levels of azoxystrobin in soybean leaves
after 20 mm rain, at 3, 6 and 11 DAA.

| | (ng of chlorothalonil/ | | | Percentage of | | |
|---|---|---|---|---|---|---|
| | g of MS)/(g/ha) | | | value at 3DAA | | |
| prototypes | 3DAA | 6DAA | 11DAA | 3DAA | 6DAA | 11DAA |
| 3 (selected) | 122.68 | 82.46 | 58.10 | 100.00 | 67.31 | 48.34 |
| 1 | 149.12 | 73.50 | 41.28 | 100.00 | 51.56 | 29.59 |
| 2 | 167.47 | 78.61 | 53.40 | 100.00 | 47.62 | 32.04 |
| 4 | 94.24 | 64.23 | 38.85 | 100.00 | 67.90 | 41.16 |
| 7 | 79.63 | 42.56 | 35.64 | 100.00 | 53.84 | 44.74 |
| 8 | 99.42 | 60.27 | 39.22 | 100.00 | 61.42 | 40.65 |
| 9 | 92.33 | 51.03 | 34.80 | 100.00 | 56.37 | 37.87 |
| 10 | 81.11 | 36.91 | 21.63 | 100.00 | 45.60 | 26.78 |
| Commercial | 57.28 | 27.13 | 19.94 | 100.00 | 48.49 | 35.21 |
| Standard 1 | | | | | | |
| Commercial | 63.83 | 30.44 | 12.76 | 100.00 | 49.37 | 20.09 |
| Standard 2 | | | | | | |
| F Treatments | 15.12 | 11.13 | 11.90 | — | 2.18 | 3.81 |
| dms t (5%) | 18.62 | 12.23 | 8.41 | — | 11.14 | 8.99 |
| CV | 20.39 | 24.65 | 26.07 | — | 22.35 | 27.81 |
| 100*M3/M of | 112.50 | 141.79 | 153.58 | — | 122.60 | 133.83 |
| the other | | | | | | |
| prototypes | | | | | | |
| 100*M3/M of | 124.84 | 159.71 | 175.76 | — | 125.64 | 141.18 |
| the other | | | | | | |
| treatments | | | | | | |
| 100*M3/M of | 202.59 | 286.44 | 355.34 | — | 137.57 | 174.81 |
| commercial | | | | | | |
| standards | | | | | | |
| percentile | 80.00 | 100.00 | 100.00 | — | 90.00 | 100.00 |

TABLE 11
Total levels of cyproconazole in soybean
leaves at 3, 6 and 11 DAA.

| | (ng of chlorothalonil/ | | | Percentage of | | |
|---|---|---|---|---|---|---|
| | g of MS)/(g/ha) | | | value at 3DAA | | |
| prototypes | 3DAA | 6DAA | 11DAA | 3DAA | 6DAA | 11DAA |
| 3 (selected) | 317.26 | 220.87 | 110.46 | 100.00 | 70.36 | 35.07 |
| 1 | 308.31 | 166.30 | 74.02 | 100.00 | 55.08 | 24.42 |
| 2 | 361.26 | 179.75 | 90.36 | 100.00 | 51.16 | 24.85 |
| 4 | 271.10 | 176.36 | 96.81 | 100.00 | 64.24 | 36.01 |
| 7 | 213.12 | 159.01 | 73.71 | 100.00 | 74.90 | 34.55 |
| 8 | 237.05 | 169.24 | 84.85 | 100.00 | 72.48 | 36.50 |
| 9 | 235.41 | 162.94 | 76.57 | 100.00 | 69.62 | 32.37 |
| 10 | 247.22 | 161.67 | 79.71 | 100.00 | 67.05 | 32.58 |
| Commercial | 213.08 | 163.07 | 61.58 | 100.00 | 76.81 | 28.85 |
| Standard 2 | | | | | | |
| F Treatments | 8.62 | 1.43 | 2.06 | — | 1.60 | 1.46 |
| dms t (5%) | 35.74 | 32.56 | 20.54 | — | 14.03 | 7.77 |
| CV | 14.69 | 20.63 | 27.13 | — | 23.03 | 26.92 |
| 100*M3/M of | 118.54 | 131.55 | 134.23 | — | 108.36 | 110.96 |
| the other | | | | | | |
| prototypes | | | | | | |
| 100*M3/M of | 121.64 | 132.03 | 138.59 | — | 105.94 | 112.18 |
| the other | | | | | | |
| treatments | | | | | | |
| 100*M3/M of | 148.89 | 135.45 | 179.37 | — | 91.61 | 121.57 |
| commercial | | | | | | |
| standards | | | | | | |
| percentile | 88.89 | 100.00 | 100.00 | — | 66.67 | 77.78 |

TABLE 12
Internal levels of cyproconazole in soybean
leaves after 20 mm rain, at 3, 6 and 11 DAA.

| | (ng of chlorothalonil/ | | | Percentage of | | |
|---|---|---|---|---|---|---|
| | g of MS)/(g/ha) | | | value at 3DAA | | |
| prototypes | 3DAA | 6DAA | 11DAA | 3DAA | 6DAA | 11DAA |
| 3 (selected) | 230.17 | 133.31 | 98.61 | 100.00 | 58.78 | 43.68 |
| 1 | 216.53 | 119.73 | 64.37 | 100.00 | 57.39 | 30.93 |
| 2 | 268.86 | 129.43 | 79.30 | 100.00 | 49.85 | 29.17 |
| 4 | 193.53 | 136.83 | 87.67 | 100.00 | 70.71 | 46.09 |
| 7 | 155.30 | 88.07 | 63.76 | 100.00 | 57.10 | 41.15 |
| 8 | 164.88 | 106.93 | 74.11 | 100.00 | 65.84 | 45.59 |
| 9 | 167.20 | 102.92 | 68.54 | 100.00 | 61.85 | 40.76 |
| 10 | 184.67 | 87.94 | 70.81 | 100.00 | 48.27 | 38.75 |
| Commercial | 87.97 | 58.63 | 31.47 | 100.00 | 69.22 | 36.36 |
| Standard 2 | | | | | | |
| F Treatments | 13.46 | 6.26 | 4.36 | — | 1.54 | 1.22 |
| dms t (5%) | 28.55 | 21.00 | 18.20 | — | 12.88 | 11.16 |
| CV | 16.90 | 21.53 | 28.16 | — | 23.61 | 31.28 |
| 100*M3/M of | 119.26 | 120.90 | 135.73 | — | 100.11 | 112.23 |
| the other | | | | | | |
| prototypes | | | | | | |
| 100*M3/M of | 127.97 | 128.42 | 146.08 | — | 97.92 | 113.16 |
| the other | | | | | | |
| treatments | | | | | | |
| 100*M3/M of | 261.65 | 227.36 | 313.34 | — | 84.92 | 120.14 |
| commercial | | | | | | |
| standards | | | | | | |
| percentile | 88.89 | 100.00 | 100.00 | — | 55.56 | 77.78 |

6) high efficiency in comparative tests under practical conditions of use.

The following tests were developed with the objective of evaluating the efficiency and agronomic feasibility of the fungicide OFA-T 0125/16 (azoxystrobin 53+cyproconazole 16+chlorothalonil 650 g·L−1 SC) or Prototype 3 to control asian rust targets (Phakopsora pachyrhizi SYDOW AND SYDOW), brown spot (Septoria glycines Hemmi) on soybean and target spot (Corynespora cassicola) on soybean plants with different site-specific fungicides in the state of Mato Grosso do Sul, MS.

Six studies were carried out in the states of São Paulo, Paraná and Goiás with the objective of evaluating the product OFA-T 0125/16 (Azoxystrobin 53+Cyproconazole 16+Chlorothalonil 650 g·L−1 SC) or Prototype 3 to control the asian rust targets (Phakopsora pachyrhizi SYDOW AND SYDOW) and brown spot Septoria glycines Hemmi, in soybean [Glycine max (L.) Merrill], as shown in Table 13.

The statistical design used was randomized blocks with four blocks of six treatments, with a control as shown in Table 13.

TABLE 13
Doses of commercial product/ha, active ingredient
in grams/ha and volume of spray/ha.

| | | | volume |
|---|---|---|---|
| | Dose | Dose | of spray |
| Treatments | (L p.c./ha) | (g i.a./ha) | (L/ha) |
| 1- Control (untreated) | — | — | — |
| 2- OFA-T 0125/16* | 0.75 | 39.75 + 12 + 487.5 | 150 |
| 3- OFA-T 0125/16 | 1.0 | 53 + 16 + 650 | 150 |
| 4- OFA-T 0125/16 | 1.5 | 79.5 + 24 + 975 | 150 |
| 5- OFA-T 0125/16 | 3.0 | 159 + 48 + 1950 | 150 |
| 6- picoxystrobin + | 0.3 | 60 + 24 | 150 |
| cyproconazole ** | | | |

*For treatments with OFA-T 0125/16, 0.5% v/v mineral oil was added
** For picoxystrobin + cyproconazole, 0.75% v/v mineral oil was added

A CO2 pressurized backpack sprayer was used, equipped with six fan-type spray nozzles, TXA 8001 VK, spaced at 0.50 m between them, with constant pressure of 3.0 kgf/cm² and spray volume equivalent to 150 L/ha, aiming to obtain the best coverage in droplet diameter and density. It was recommended the use of tips that allow the production of fine drops and obtain a uniform coverage on the aerial part of the crop and consequently on the target. After applications, evaluations were performed at 7 and 14 days after the first application (DA1A) and at 7, 14, 21 and 28 days after the second application (DA2A) in order to assess severity, productivity and phytotoxicity. Disease severity data were used to calculate the area under the disease progress curve (AUDPC), according to the Shaner and Finny (1977) equation, and the sum of the AACP was used to calculate the efficiency of treatments using the proposed equation by Abbott (1925). For productivity evaluation, the values obtained were extrapolated in kilograms per hectare (kg/ha).

### EVALUATION METHODS

### Description of Reviews

Severity for Asian Rust (%): The severity assessment in plants was performed by the visual method through the attribution of notes according to the diagrammatic scale adapted by Godoy et al. (2006). The grade was assigned to 20 trefoils of the middle third of the plants and the mean severity was calculated per plot (FIG. 2).

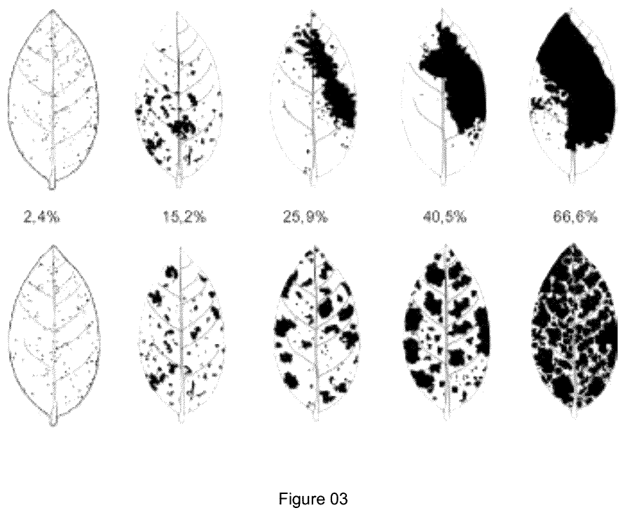

Severity for brown spot (%): The evaluation of severity in plants was performed by the visual method through the attribution of notes according to the diagrammatic scale (FIG. 3).

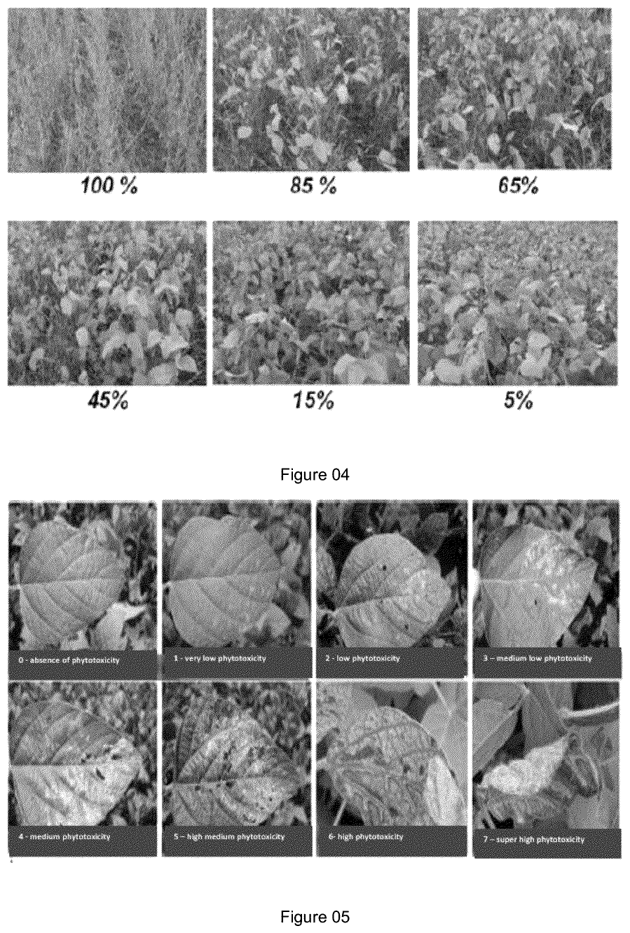

Defoliation (%): The defoliation assessment followed the scale method proposed by Mario Hirano et al. (2010) (FIG. 4).

Phytotoxicity (%): For the evaluation of phytotoxicity, the scale of Campos et al. (2012) (FIG. 5).

### Results and Discussion on Asian Rust

### Incidence and Severity

The average latency period of soybean rust (Phakopsora pachyrrizi) (time between establishment of infection and inoculum production) varies between 7 and 9 days (Alves et al., 2006). Historically, considering the arrival of the initial inoculum and the latency period of the fungus, the disease often becomes visible in the flowering phase, stage R1 (Fehr & Caviness, 1977), about 35 to 45 days after emergence (Godoy, 1977). 2011).

However, it should be considered that the detection of symptoms occurs after one or two cycles of the pathogen. In this case, it is possible that in the vast majority of cases, Phakopsora pachyrrizi infection has already occurred 20 days after emergence.

The first fungicide application has always been positioned and timed at flowering, or even later, but never before the first symptoms are seen (Godoy, 2011).

This fact suggests that, for several years, full conditions were given for the generation of several cycles of infection of the pathogen and abundant production of spores, until the application of fungicides occurred, characterizing a predominantly eradicative position, being allowed the increase in the number of spores that, selectively exposed to fungicides, are being selected over several seasons (Godoy, 2011).

The identification of the first symptoms was used as an indicator for the beginning of fungicide applications. However, from the identification of the first symptoms, a very short period for the effective entry of fungicides has been observed.

Thus, if the issues of machinery, area size, and environmental condition are considered, there may be obstacles that make it difficult to quickly enter the crop so that fungicides are applied effectively.

In this sense, in many situations, yield losses can occur even after application of fungicides, largely due to control failures due to the timing of application not being ideal considering the stage of pathogenesis (Calvo et al., 2008).

The assessment of incidence, prior to the first application, was performed on the leaves of the plants and no symptoms of infection of the fungus Phakopsora pachyrhizi were observed, four points were observed in each plot and no symptoms of infection were found.

In this way the application occurred preventively to the incidence of the disease. Symptoms were detected from the first application in the evaluation at 7 DA2A, with 10% severity in the control.

Table 14 describes the mean severity data of the treatments observed during the evaluations, it can be seen that in the first evaluation performed after the incidence of the disease at 7 DA1A was verified, all treatments showed significant differences in relation to the control, the treatments 1.0 stand out; 1.5 and 3.0 L/ha of OFA-T 0125/16.

At 14 DA1A it was found by statistical analysis that the treatment with 0.75 L/ha of OFA-T 0125/16 showed less control when compared to treatments with higher doses.

After the second application, at 7 DA2A, it was observed that the severity of the disease was maintained at the lowest levels only in treatments with OFA-T 0125/16 at doses 1.5 and 3.0 L/ha, performing statistically better than the default.

At 14, 21 and 28 DA2A, treatments with 1.5 and 3.0 L/ha of OFA-T 0125/16 maintained satisfactory levels of disease control and presented lower than standard disease severity levels.

TABLE 14
Severity caused by Asian rust (Phakopsora pachyrhizi), in soybean.

| | Dose | Severity of Asian Rust | | | | | | |
|---|---|---|---|---|---|---|---|---|
| Treateaments | L/ha | Preview | 7DA1A¹ | 14DA1A | 7DA2A | 14DA2A | 21DA2A | 28DA2A |
| 1- Control | — | 0.0 | 10.0a² | 12.8a | 19.5a | 30.0a | 36.3a | 40.0a |
| (untreated) | | | | | | | | |
| 2- OFA-T | 0.75 | 0.0 | 6.8b | 9.5ab | 15.0b | 18.3b | 21.8b | 29.5b |
| 0125/16 | | | | | | | | |
| 3- OFA-T | 1.0 | 0.0 | 3.3c | 4.5c | 11.5b | 13.8c | 18.8bc | 20.8c |
| 0125/16 | | | | | | | | |
| 4- OFA-T | 1.5 | 0.0 | 3.3c | 5.3c | 6.5c | 8.5d | 14.5cd | 17.3cd |
| 0125/16 | | | | | | | | |
| 5- OFA-T | 3.0 | 0.0 | 1.8c | 3.5c | 5.0c | 6.0e | 9.0e | 10.5e |
| 0125/16 | | | | | | | | |
| 6-picoxystrobin + | 0.3 | 0.0 | 3.8c | 5.1c | 13.5b | 14.2c | 17.4bc | 21.6c |
| cyproconazole | | | | | | | | |
| C.V.³ (%) | — | 0.0 | 30.8 | 24.7 | 17.5 | 4.5 | 12.6 | 8.6 |

¹DAA (days after application).
²In the columns, means followed by the same letter do not differ from each other by Tukey (P ≤ 0.05).
³Data variation coefficient.

### Disease Progress Curve and Efficiency

Looking at Table 15, it was found that all treatments provided a significant decrease in the area under the disease curve (AUDPC), when compared to the control.

OFA-T 0125/16 or Prototype 3 showed significant differences as a function of dose variation, with an increasing percentage of efficiency being noted with increasing doses.

The treatments of OFA-T 0125/16 at doses of 1.0, 1.5 and 3.0 L/ha showed efficiency of 60%, 70% and 80% respectively in the control of Asian rust.

The OFA at a dose of 1.0 L/ha obtained statistical equivalence to Picoxistrobin+cyproconazole, while the other doses showed statistical superiority to the same. COSTA et al (2017) found that azoxystrobin combined with other active ingredients resulted in more than 80% control for Asian soybean rust. OLIVEIRA et al (2017) observed that the combination of chlorothalonil, among other protective fungicides, potentiated the application effect for Asian soybean rust.

Multisite fungicides have been a unique and irreplaceable tool in the fight against fungal resistance to fungicides. (A successful example is the control of mildew fungi at high risk of developing resistance in horticulture and fruit growing, where the use of site-specific fungicides (mildiocides) has always been formulated (prefabricated double mixtures) with the addition of of multisites (chlorothalonil/mancozeb mainly), paralyzing the threat of control failure for several years.

In this sense, time has been lost, as a result, the control of rust by site-specific fungicides in double or triple mixtures has been rapidly reduced season after season.

The fungus Phakopsora pachyrhizi, through directional selection, has been faster and more successful in the development of resistance than the market launch of efficient fungicidal mixtures (site-specific+multisite) for its control.

There is sufficient volume of research confirming that the addition of multisite fungicides to dual monosite mixtures can improve control efficiency.

In view of the cited facts of the reduction in the control of Asian soybean rust, the clear guidance that in order to recover its control (>80%) and maintain the effective life for a longer time of the monosite fungicides is necessary, in the shortest possible time, commercialize ready-made mixtures (doubles/triples) containing an efficient multisite formulation.

If not done in the shortest possible time, it appears that double or triple mixes will not have lasting success in controlling rust.

The fungicide OFA-T 0125/16 is the association of azoxystrobin, belonging to the chemical group of strobilurins, which is linked to the ability to inhibit mitochondrial respiration acting on the fungus' energy synthesis.

In this way, it is highly effective in the phases of greatest energy demand in development. It also has protective/healing properties in addition to the effect on spore germination. As for cyproconazole, the second active belonging to the OFA formulation, it belongs to the group of triazoles or demethylation inhibitors (DMIs) and is characterized by interfering with sterol biosynthesis in the cell membrane, acting in the demethylation of lanosterol, at the C-14 position, in the of ergosterol biosynthesis. The last component of the triple formulation is chlorothalonil, a broad-spectrum fungicide used to control plant diseases since the mid-1960s.

Currently plays an important role in disease control in cereal fields, this asset is also part of the anti-resistance strategy in disease control programs. The fungicide is used in several crops, preventing important diseases, being the most used fungicide in the United States.

In Brazil, the fungicide has its use in several cultures, with increasing use in the soybean crop, as a strategy of control and resistance management aiming at the control of Asian rust and other diseases important to the culture.

To reduce the risk of damage from rust to the crop, the following strategies are recommended: use of early cycle cultivars, sowing at the beginning of the recommended season, elimination of voluntary soybean plants and the absence of soybean cultivation in the off-season through the sanitary void (60 to 90 days), monitoring from the beginning of the development of the culture, the use of fungicides preventively and the use of resistant cultivars.

Therefore, the solution to control Asian soybean rust lies in the integration of methods. Despite the high risk of emergence of resistant mutants in the population of the fungus P. pachyrhizi, in the field with the use of fungicides with a specific mode of action, chemical control is still the best solution to reduce the damage caused by the disease.

It is known that in the short and medium term there will be no new molecules available on the market for fungicides with chemical groups with a specific mode of action. Then there is the need to seek action of fungicides with generalized interference, such as protectors (multisites).

The OFA-T 0125/16 or Prototype 3 is available, which contributes to the maintenance of chemical groups with a specific mode of action, significantly increases the effectiveness in controlling the pathogen and reduces productivity losses. The way, therefore, lies in the introduction of protective fungicides in systemic (specific) fungicide formulations.

TABLE 15
Area Below the Disease Progress Curve (AUDPC) during the
evaluation period, in soybean, treatment efficiency.

| | | AUDPC asian rust | | | | | | |
|---|---|---|---|---|---|---|---|---|
| | Dose | Interval | Interval | Interval | Interval | Interval | Σ | |
| Treatments | L/ha | 1 | 2 | 3 | 4 | 5 | AUDPC | E %¹ |
| 1- Control | — | 79.6 | 112.9 | 208.3 | 310.6 | 345.6 | 1057a2 | — |
| (untreated) | | | | | | | | |
| 2- OFA-T | 0.75 | 56.9 | 85.8 | 116.4 | 140.0 | 179.4 | 578.4b | 45 |
| 0125/16 | | | | | | | | |
| 3- OFA-T | 1.0 | 27.1 | 56.0 | 88.4 | 113.8 | 138.3 | 423.5c | 60 |
| 0125/16 | | | | | | | | |
| 4- OFA-T | 1.5 | 29.8 | 41.1 | 52.5 | 80.5 | 111.1 | 315.0d | 70 |
| 0125/16 | | | | | | | | |
| 5- OFA-T | 3.0 | 18.4 | 29.8 | 38.5 | 52.5 | 68.3 | 207.4e | 80 |
| 0125/16 | | | | | | | | |
| 6-picoxystrobin + | 0.3 | 28.4 | 55.2 | 90.2 | 125.1 | 154.9 | 453.8c | 57 |
| cyproconazole | | | | | | | | |
| C.V.³ (%) | — | | | | | | 5.7 | |

¹Percentage of efficiency, by Abbott (1925).
2In the columns, means followed by the same letter do not differ by Tukey (P ≤ 0.05).
³Data variation coeficiente

### Phytotoxicity

In the same period in which the severity of Asian rust in soybean was evaluated, the symptoms of phytotoxicity were also evaluated. It was found that the different applications and doses tested did not result in phytotoxic symptoms in soybean plants during the evaluations. These values can be seen in Table 16.

TABLE 16
Percentage of injury caused by the application of fungicides.

| | Dose | Severity of Asian Rust | | | | | |
|---|---|---|---|---|---|---|---|
| Treatments | L/ha | 7DA1A¹ | 14DA1A | 7DA2A | 14DA2A | 21DA2A | 28DA2A |
| 1- Control | — | 0 | 0 | 0 | 0 | 0 | 0 |
| (untreated) | | | | | | | |
| 2- OFA-T | 0.75 | 0 | 0 | 0 | 0 | 0 | 0 |
| 0125/16 | | | | | | | |
| 3- OFA-T | 1.0 | 0 | 0 | 0 | 0 | 0 | 0 |
| 0125/16 | | | | | | | |
| 4- OFA-T | 1.5 | 0 | 0 | 0 | 0 | 0 | 0 |
| 0125/16 | | | | | | | |
| 5- OFA-T | 3.0 | 0 | 0 | 0 | 0 | 0 | 0 |
| 0125/16 | | | | | | | |
| 6-picoxystrobin + | 0.3 | 0 | 0 | 0 | 0 | 0 | 0 |
| cyproconazole | | | | | | | |
| C.V.³ (%) | — | 0 | 0 | 0 | 0 | 0 | 0 |

¹DAA (days after application).
²Data variation coefficient

### Culture Productivity

According to table 17, it can be seen that all treatments showed numerical superiority of productivity in relation to the control. The OFA fungicide at its lowest dose of 1.0 L/ha showed statistical similarity to the standard picoxystrobin+cyproconazole, that is, the addition of the multisite in the formulation absorbed the reduction in the concentration of azoxystrobin and cyproconazole to obtain the same production values in kg/there is. The fungicide OFA-T 0125/16 at doses of 1.5 L/ha and 3.0 L/ha were statistically superior in relation to the control and the standard picoxystrobin+cyproconazole.

TABLE 17
Productivity in Kg per hectare, in the soybean crop.

| | | |
|---|---|---|
| | Dose | Productivity |
| Treataments | L/ha | Kg/ha |

| | | | |
|---|---|---|---|
| 1- Control (untreated) | — | 2630.5 | b¹ |
| 2- OFA-T 0125/16 | 0.75 | 2872.5 | b |
| 3- OFA-T 0125/16 | 1.0 | 3221.8 | ab |
| 4- OFA-T 0125/16 | 1.5 | 3555.1 | a |
| 5- OFA-T 0125/16 | 3.0 | 3705.3 | a |
| 6- picoxystrobin + | 0.3 | 2842.3 | b |
| cyproconazole | | | |
| C.V.³ (%) | — | 8.51 | |

¹In the columns, means followed by the same letter do not differ by Tukey (P ≤ 0.05).
²Data variation coefficient.

### Integrated Management to be Applied in the Culture

Soybean rust can be effectively controlled through the application of appropriate fungicides. More than 120 commercial fungicides are currently registered in Brazil for use in rust control. Many of them are being evaluated annually since 2003/04 in standardized tests conducted in a network in different producing regions of the country, coordinated by Embrapa Soja.

In general, the effectiveness of control programs is related to the performance of fungicides, by the sequence of products used and due to the sequence of actives.

In this particular, the moment in which the fungicides are positioned, both in relation to the arrival of the pathogen in the area and in relation to the plant, are fundamental and imply a series of difficulties.

In addition, the performance of the product will depend on the application technology and the physical and chemical properties of the molecule that influence the arrival of the active at the target site of the pathogen.

Based on the characteristics of fungicides, the timing of the first application of foliar fungicides is often the main factor that determines the success or failure of Phakopsora pachyrrizi control programs in soybean (Mueller et al., 2009).

The performance of systemic fungicides is gradually reduced as the application is delayed in relation to the beginning of the infection. The vast majority of fungicides have a residual effect that varies from 14 to 20 days, which may change depending on the inoculum pressure (Silva et al, 2005).

Preventive applications aim to delay the onset of the disease and the secondary cycles of the pathogen (Balardin et al., 2010).

The significant reduction in the production of spores of the pathogen that serves as a secondary inoculum is the key point of the greater residual delivered from the products by preventive applications.

Applications performed after the observation of the first symptoms allow the pathogen to establish itself in the host and enter into active reproduction, increasing the inoculum pressure that can reach healthy tissues (Balardin et al., 2010).

In addition, early applications can provide better conditions to reach the lower canopy of plants and protect the lower leaves. This is extremely important because this is where the disease finds its best conditions and the first infections appear (Yang et al., 1991).

Lower canopy protection may reflect significant disease delay and provide greater residual fungicide control. Currently, the number of applications is very dependent on the sowing time and environmental conditions.

The number of applications will be dictated depending on the greater or lesser interval between one application and another. In later sown soybean fields, farmers need to reduce the interval between fungicide applications due to the greater amount of inoculum produced in the earlier sown areas (Godoy et al., 2016). Therefore, the average number of fungicide applications during a soybean crop increase.

The control residual will also depend on metabolism and dissipation half-life or constant rates of fungicides in plants, which are necessary data for the evaluation of products in plant protection (Humbert et al., 2007).

Another important factor that interferes in the persistence and consequently in the effectiveness of fungicide applications is the occurrence of rain after the treatment. Precipitation can reduce the effectiveness of pesticides, washing the AI applied to the leaf out of the plant and by increasing the availability of compounds for runoff, consequently to the environment (Reddy et al., 1994). Since loss(s) of active ingredient(s) can cause a loss in efficacy (Reddy et al., 1994) it is important to know the persistence of these compounds in response to leaf washing, especially when this occurs shortly after treatment.

The chemical control of the disease stands out among the forms of control, however to be more efficient, it must be sought through the integrated use of several strategies aimed at reducing the level of inoculum. Furthermore, fungal resistance to fungicides is a natural evolutionary response of these organisms to an external threat to their survival (FARIAS, 2016).

To combat resistance management, one of the alternatives that has been studied is the use of multisite fungicides (LANDGRAF, 2017). The mixture of two or more active ingredients with different mechanisms of action provides a more efficient control of soybean rust.

Added to this is the fact that the combination of these actives in the field allows an increase in the product's action spectrum, guaranteeing a greater residual, in addition to reducing the risk of the emergence of fungicide-resistant populations of the pathogen (MENEGHETTI, et al 2010).

The test product of the present OFA-T 0125/16 or Prototype 3 trial has three different active principles in its composition: azoxystrobin+cyproconazole+chlorothalonil.

There are studies in the literature with the active principles mentioned in the control of rust. However, their combination can become a more effective alternative in controlling this disease and providing combat resistance.

The results obtained in the present tests show that OFA-T 0125/16 at the doses tested was efficient in the control of Asian soybean rust, highlighting the doses of 1.5 and 3.0 L/ha, as they resulted in superior performance to picoxystrobin+cyproconazole already registered for the control of this disease.

In addition to showing an increase in the productivity of soybean plants. In this way it is evidenced that the test product can become another new alternative for the management of Asian rust.

### Results and Brown-Spot Discussion

### Incidence and Severity

The severity assessment, prior to the first application, was performed on the leaves of the plants and no symptoms of infection by the fungus Septoria glycines were observed.

In this way the application occurred preventively to the incidence of the disease. The symptoms were detected from the evaluation of 7 DA1A, with 2.8% of severity in the control.

Table 18 describes the mean severity data of the treatments observed during the evaluations, it can be seen that in the first evaluation carried out at 7 DA1A all treatments applied showed significant differences in relation to the control, at 14 DA1A also the same behavior was observed.

It was observed, at a visual level, a superiority of all treatments in relation to the control, a result also verified by Igarashi et al (1997) and Utiamada et al (1997).

These last authors also observed an increase in the culture cycle of the order of three to four days, in relation to the control.

After the second application, it is noted that at 14 DA2A and in the subsequent evaluations, treatment 4 (OFA-T 0125/16 at a dose of 1.5 L/ha) showed less severity.

This suggests that from 1.5 L/ha of OFA-T 0125/16 there was better disease control and greater residual, it also showed statistically lower infection levels than the standard picoxystrobin+cyproconazole.

TABLE 18
Severity caused by brown spot (Setoria glycines), in soybean.

| | Dose | Severity of brown spot | | | | | |
|---|---|---|---|---|---|---|---|
| Treatments | L/ha | 7DA1A¹ | 14DA1A | 7DA2A | 14DA2A | 21DA2A | 28DA2A |
| 1- Control | — | 2.8a² | 5.8a | 15.5a | 25.0a | 36.0a | 54.8a |
| (untreated) | | | | | | | |
| 2- OFA-T | 0.75 | 1.5b | 2.5b | 5.3b | 12.3b | 21.3b | 35.0b |
| 0125/16 | | | | | | | |
| 3- OFA-T | 1.0 | 1.8ab | 2.0b | 4.5bc | 12.8b | 17.0c | 20.0c |
| 0125/16 | | | | | | | |
| 4- OFA-T | 1.5 | 1.3b | 1.5b | 2.5c | 5.8c | 11.0d | 15.3d |
| 0125/16 | | | | | | | |
| 5- OFA-T | 3.0 | 1.3b | 1.5b | 3.0bc | 5.3c | 10.5d | 14.3d |
| 0125/16 | | | | | | | |
| 6-picoxystrobin + | 0.3 | 1.8ab | 2.3b | 4.0bc | 10.8b | 18.0c | 21.0c |
| cyproconazole | | | | | | | |
| C.V.³ (%) | — | 31.3 | 24.5 | 18.4 | 13.6 | 9.6 | 6.5 |

¹DAA (days after application).
²In the columns, means followed by the same letter do not differ by Tukey (P ≤ 0.05).
³Data variation coefficient.

Given the relevance and protagonism of the soybean crop for Brazilian agribusiness, it is necessary to carry out constant exercises of analysis of challenges and essential care for the production of the grain and the maintenance of good levels of productivity.

One of the main disorders is on account of septoria, also known as brown spot, a disease caused by the action of the fungus Septoria glycines on plant leaves.

The first symptoms of the presence of the disease appear around two weeks after the activity of the fungus, with the appearance of small spots or spots, in angular shapes and reddish-brown in color, on the unifoliate leaves of the plants.

When their development conditions gain greater dimension, they can reach the trifoliate leaves and cause a polycyclic process, causing leaf fall and early grain maturation.

Due to the survival of the fungus in soybean crop residues and for belonging to the group of end-of-cycle diseases (DFC), the farmer must prioritize the adoption of a crop rotation system, integrated with cover plants to deposit straw on cultural remains, reducing dissemination.

The search to find soybean cultivars resistant to S. glycines comes from three to four decades ago, but to date, cultivars with satisfactory resistance to the disease have not yet been found.

Therefore, the control of this disease is based on the application of fungicides. Fungicide application should also be incorporated into an integrated disease management context.

Therefore, observing Table 19, it was found that all fungicide treatments provided a significant decrease in the area under the disease progress curve (AUDPC), when compared to the control.

Treatments with OFA-T 0125/16 showed significant differences as a function of dose variation, with an increasing percentage of efficiency being noted with increasing doses.

It can be highlighted with better performance in the control of brown spot OFA-T 0125/16 at a dose of 1.5 and 3.0 L/ha which resulted in efficiency of 74% and 75%, respectively, and the standard picoxystrobin+cyproconazole showed 57% control (Table 19), therefore statistically superior to the standard.

TABLE 19
Area Below the Disease Progress Curve (AUDPC) during the
evaluation period, in soybean, treatment efficiency.

| | | AUDPC brown spot | | | | | | |
|---|---|---|---|---|---|---|---|---|
| | Dose | Interval | Interval | Interval | Interval | Interval | Σ | |
| Treatments | L/ha | 1 | 2 | 3 | 4 | 5 | AUDPC | E %¹ |
| 1- Control | — | 29.8 | 74.4 | 141.8 | 213.5 | 317.6 | 777a2 | — |
| (untreated) | | | | | | | | |
| 2- OFA-T | 0.75 | 14 | 27.1 | 61.3 | 117.3 | 196.9 | 416.5b | 46 |
| 0125/16 | | | | | | | | |
| 3- OFA-T | 1.0 | 13.1 | 22.8 | 60.4 | 104.1 | 129.5 | 329.9b | 58 |
| 0125/16 | | | | | | | | |
| 4- OFA-T | 1.5 | 9.6 | 14 | 28.9 | 58.6 | 91.9 | 203c | 74 |
| 0125/16 | | | | | | | | |
| 5- OFA-T | 3.0 | 9.6 | 15.8 | 28.9 | 55.1 | 86.6 | 196c | 75 |
| 0125/16 | | | | | | | | |
| 6-picoxystrobin + | 0.3 | 14 | 21.9 | 63.8 | 98.3 | 134.5 | 332.5b | 57 |
| cyproconazole | | | | | | | | |
| C.V.³ (%) | — | | | | | | 7.1 | |

¹Percentage of efficiency, by Abbott (1925).
2In the columns, means followed by the same letter do not differ by Tukey (P ≤ 0.05).
³Data variation coefficient.

### Phytotoxicity

In the same period in which the severity of brown spot was evaluated, the symptoms of phytotoxicity were also evaluated. It was found that the different applications and dosages tested did not result in phytotoxic symptoms in soybean plants during the evaluations. These values can be seen in table 20.

TABLE 20
Percentage of injuries caused by the application of fungicides.

| | Dose | Phytotoxicity Percentage | | | | | |
|---|---|---|---|---|---|---|---|
| Treatments | L/ha | 7DA1A¹ | 14DA1A | 7DA2A | 14DA2A | 21DA2A | 28DA2A |
| 1- Control | — | 0 | 0 | 0 | 0 | 0 | 0 |
| (untreated) | | | | | | | |
| 2- OFA-T | 0.75 | 0 | 0 | 0 | 0 | 0 | 0 |
| 0125/16 | | | | | | | |
| 3- OFA-T | 1.0 | 0 | 0 | 0 | 0 | 0 | 0 |
| 0125/16 | | | | | | | |
| 4- OFA-T | 1.5 | 0 | 0 | 0 | 0 | 0 | 0 |
| 0125/16 | | | | | | | |
| 5- OFA-T | 3.0 | 0 | 0 | 0 | 0 | 0 | 0 |
| 0125/16 | | | | | | | |
| 6-picoxystrobin + | 0.3 | 0 | 0 | 0 | 0 | 0 | 0 |
| cyproconazole | | | | | | | |
| C.V.³ (%) | — | 0 | 0 | 0 | 0 | 0 | 0 |

¹DAA (days after application).
²Data variation coefficient.

### Culture Productivity

Brown spot registers low frequency in seeds, prevailing through remains of previous soybean crops. Due to its fungal condition, the infection in crops is facilitated and favored by climatic conditions of heat and humidity, which can be facilitated by the action of the wind and carried by drops of water from one plant to another.

If the problem is not identified throughout its stages of evolution and controlled in a timely manner by the farmer, productivity losses in crops can be significant.

Of the products tested, all proved to be options for controlling the pathogen, both by reducing the incidence at the foliar level, as well as at the level of infection and grain yield, phenomena also observed by Lopes & KleinGunnewik (1997) and Jaccoud Filho et al. al (1997).

Studies carried out prove that azoxystrobin, at dosages of 50 g.i.a and 100 g.i.a with two applications, the first in the R5.4 phase and the second 12 days after the first, was the best option among those tested in the conditions in which the test was performed.

Regarding grain yield, strobilurin in relation to the other actives is superior in the sense that it reduces infection levels, which may be very influential as a source of inoculum for the secondary cycle or for the primary cycle, by transmission through the seeds, for new crops in areas free from these diseases.

For the productivity results, the hypothesis test (Student's T test) was used, capable of evaluating whether there is a significant difference between the means of the productions.

When comparing the average yields of the OFA fungicide, assuming different variances, of picoxystrobin+cyproconazole, it was noted that the averages are 3373.66 kg·ha versus 3169 kg·ha.

So, we can say that there is a significant difference between the treatments, because calculated t=21.09 is greater than the two-tailed critical t=4.30 and the p-value=0.02 (20%) is less than alpha adopted=0.05 or 5% so the productivity in kg/ha is different.

This is on average the production of the OFA treatments was statistically superior to the standard picoxystrobin+cyproconazole. FIG. 5 shows the productivity data of the treatments in kg/ha.

### Integrated Management to be Applied in the Culture

The chemical control of the disease stands out among the forms of control, however, due to the survival of the fungus in the cultural remains, for greater efficiency in controlling this disease, crop rotation is also recommended, accompanied by the improvement of physical conditions.—soil chemicals, with emphasis on potassium fertilization (GODOY, ET AL 2014).

In chemical control, despite the great contribution that site-specific fungicides provide, their intensive use can result in the selection of less sensitive or resistant fungi isolates (MAIS SOJA, 2016).

All soybean diseases of fungal nature are affected by protective fungicides, the best management is always obtained with the application of these products preventively and in mixtures with specific fungicides (AZEVEDO, 2018).

The test product of the present OFA-T 0125/16 assay has three different active principles in its composition: azoxystrobin+cyproconazole+chlorothalonil. There are studies in the literature with the active principles mentioned in the control of brown spot.

However, their combination can become a more effective alternative in controlling this disease and combating resistance.

The results obtained in the present trial demonstrate that OFA-T 0125/16 at the doses tested was efficient in controlling brown spot, as they resulted in statistically superior performance to the standard picoxystrobin+cyproconazole already registered for the control of this disease.

In addition to showing an increase in the productivity of soybean plants. In this way, it is evidenced that the test product can become another new alternative for the management of brown spot in soybean.

### CONCLUSION

The product OFA-T 0125/16 (azoxystrobin+cyproconazole+chlorothalonil) showed efficiency and agronomic feasibility from the dose of 1.5 L/ha for the control of Asian rust (Phakopsora pachyrhizi), with superior performance to the standard picoxystrobin+cyproconazole. The product OFA-T 0125/16 was totally selective for the soybean crop, showing no symptoms of phytotoxicity during applications. Therefore, it should be recommended as another tool in the management of the disease in soybean.

The product OFA-T 0125/16 (azoxystrobin+cyproconazole+chlorothalonil) showed efficiency and agronomic feasibility from the dose of 1.5 L/ha to control brown spot (Septoria glycines), with performance superior to the standard picoxystrobin+cyproconazole. The product OFA-T 0125/16 was totally selective for the soybean crop, showing no symptoms of phytotoxicity during applications. Therefore, it is concluded that OFA-T 0125/16 was superior to picoxystrobin+cyproconazole and can be recommended for the management of this important disease in soybean.

Target Spot Control in Soybean Plants with Different Site-Specific Fungicides in Anaurilândia, MS.

Two studies were carried out in the state of Mato Grosso do Sul in the municipalities of Anaurilandia and Itaquiraí with the objective of evaluating the control of OFA-T 0125/16 (azoxystrobin 53+cyproconazole 16+chlorothalonil 650 g/L SC) for target spot (Corynespora cassicola) in four sequential applications with researchers Grigolli and Grigolli from the MS Foundation.

TABLE 21
Treatments and doses

| | | Dose (mL |
|---|---|---|
| No | Treatment | ou g p.c./ha) |
| 1 | Control (untreated) | 0 |
| 2 | tebuconazole + picoxystrobin + mancozeb + oil | 2250 + 250 |
| | vegetal | |
| 3 | tebuconazole + picoxystrobin + vegetable oil | 500 + 250 |
| 4 | epoxiconazole + fluxaripixad + pyraclostrobin + | 800 + 500 |
| | mineral oil | |
| 5 | pyraclostrobin + fluxaripixad + mineral oil | 300 + 500 |
| 6 | epoxiconazole + pyraclostrobin + mineral oil | 250 + 500 |
| 7 | fenpropimorph | 300 |
| 8 | prothioconazole + trifloxystrobin + | 400 + 200 |
| | vegetable oil | |
| 9 | prothioconazole + trifloxystobin + bixafen + | 500 + 200 |
| | vegetable oil | |
| 10 | trifloxystrobin + cyproconazole + vegetable oil | 200 + 200 |
| 11 | picoxistobin + cyproconazole + mineral oil | 300 + 600 |
| 12 | benzovindyflupyr + picoxystrobin | 600 |
| 13 | flutriafol + carbendazim + mineral oil | 500 + 600 |
| 14 | cresoxin + tebuconazole + carbendazim + | 1000 + 600 |
| | mineral oil | |
| 15 | metominostrobin + tebuconazole + mineral oil | 580 + 600 |
| 16 | difenoconazole + cyproconazole + mineral oil | 400 + 600 |
| 17 | benzovindyflupyr + azoxystrobin + mineral oil | 200 + 600 |
| 18 | azoxystrobin + cyproconazole + mineral oil | 300 + 600 |
| 19 | prothioconazole + difenoconazole + mineral oil | 150 + 600 |
| 20 | azoxystrobin + cyproconazole + mancozeb + | 2000+ |
| | vegetable oil | |
| 21 | azoxystrobin + tebuconazole + mancozeb + | 1750 + 0.25% |
| | vegetable oil | |
| 22 | tebuconazole + chlorothalonil + adjuvant | 2500 + 50 |
| 23 | OFA 0125/16 (azoxystrobin + cyproconazole + | 1500 + 0.25% |
| | chlorothalonil) + Ligga OF (vegetable oil) | |

P.C.—commercial product; DAE—days after plant emergence.
Time of application of treatments: 30/45/60/75 days after plant emergence.

### Culture Data:

Place: Anaurilândia, MS
Field: Fazenda Estrela do Quiterói
Geographic coordinate: −22,1358; −52,7481
Year: Safra 2019/20
Previous culture: Cotton
Plant: Brasmax Garra IPRO
planting system: no-tillage system
Data de semeadura: 21/11/2019
Espaçamento entre linhas: 50 cm
Fertilizing: 300 kg/ha Apr. 30, 2010 (N-P-K) in the sowing furrow
Harvest date: Aug. 3, 2020

2) EXPERIMENTAL DESIGN, I, SAMPLING UNIT AND STATISTICAL ANALYSIS: The experiment was carried out in a randomized block design, with 23 treatments and four replications. Each plot consisted of seven lines of 10 meters in length (35 m2). The data obtained were submitted to analysis of variance and the mean of the treatments compared by the Scott-Knott test at 5% probability.

3) APPLICATION TECHNOLOGY: The treatments were applied using a constant pressure CO2-based sprayer, with a bar with six nozzles spaced 0.5 m between each nozzle. Double fan nozzle TJ 06 11002 and spray volume of 160 L/ha were used. Weather conditions at the time of each application can be seen below.

TABLE 22
Weather conditions

| | | | Temperature | Relative | Wind speed |
|---|---|---|---|---|---|
| Date | Estage | Time | (° C.) | humidity (%) | (m/s) |
| 22 Dec. 2019 | V6 | 19 h 14 min | 27.2 | 64 | 1.1 |
| 9 Jan. 2020 | R2 | 08 h 23 min | 25.3 | 83.6 | 1.9 |
| 26 Jan. 2020 | R5.1 | 08 h 44 min | 26.9 | 65.5 | 1.8 |
| 13 Feb. 2020 | R5.4 | 08 h 09 min | 27.5 | 72.5 | 1.9 |

4) EVALUATIONS, Target Spot Severity in soybean plants: Six disease severity assessments were performed before each application and at 14 and 21 days after the last application of treatments, at 30, 46, 65, 79, 95 and 102 days after plant emergence. Assessments were based on diagrammatic scales proposed by Soares et al. (2009) for target spot (Corynespora cassiicola) (FIG. 6). Ten plants per plot were evaluated. In each plant, two leaflets were removed and the average of the plot was considered the average of the 20 leaflets evaluated.

Disease severity results from the size and number of lesions, and these two components may act independently during disease progression (Kranz 1988; Boff et al. 1991). Furthermore, the best representation of an epidemic is the disease progress curve, usually expressed by plotting the proportion of disease as a function of time (Paula and Oliveira 2003). Thus, severity data were used to calculate the area under the disease progress curve (AUDPC) based on the model proposed by Campbell and Madden (1990), in which

$$AACPD = {\sum }_{1}^{n - 1} \frac{{y}_{i} + {y}_{i + 1}}{2} \times ( {t}_{i + 1} - {t}_{i} )$$

where n is the number of assessments, y is the severity of the disease, and t is the time in days of each assessment.

### Control Efficiency

Based on the data obtained from the severity of the disease in the experimental area, the control efficiency of each treatment was calculated according to the method proposed by Abbott (1925), in which:

$$E ( \% ) = \frac{( T - t ) \times 100}{T}$$

where E (%) is the control efficiency of the treatment expressed as a percentage, T is the AUDPC value in the control, and t is the AUDPC value in the evaluated treatment.

### Grain Yield

Yield evaluations were performed with the harvest of the three central lines of each seven-meter-long plot with the aid of a plot harvester and the grain moisture was corrected to 13%. For the correction of grain moisture, the formula below was used:

$$Yield = \frac{10 \times ( 100 - U S ) \times P}{( 100 - 13 ) \times A C}$$

where Yield is expressed in tons per hectare, US is seed moisture in %, PP is the weight harvested from the plot in kg, and AC is the harvested area from the plot in m2. In addition, the mass of 1000 grains of each

### Results and Discussion

The results of target spot severity on soybean plants indicated signs of the pathogen from the second evaluation. In the second, third and fourth evaluations, no significant differences were observed between treatments.

In the fifth evaluation, great evolution of the pathogen was noted, and from there the treatments were differentiated forming four groups. The treatments with the lowest values were composed of azoxystrobin+tebuconazole+mancozeb, epoxiconazole+pyraclostrobin+fluxapyroxad, pyraclostrobin+fluxapyroxad, proticonazole+trifloxystrobin+bixafen and azoxystrobin+cyproconazole+mancozeb, while the Control and fenpropimorph had the highest severity values.

The other treatments showed intermediate values, with some differences between them (Table 23).

In the sixth evaluation, there was also a separation into four groups of means, so that azoxystrobin+tebuconazole+mancozeb, epoxiconazole+pyraclostrobin+fluxapyroxad, pyraclostrobin+fluxapyroxad, prothioconazole+trifloxystrobin, proticonazole+trifloxystrobin+bixafen and azoxystrobin+cyproconazole+mancozeb, azoxystrobin+tebuconazole+mancozeb, tebuconazole+chlorothalonil and OFA 0125/16 (azoxystrobin+cyproconazole+chlorothalonil) presented the lowest values, while the Control presented the highest value.

The other treatments showed intermediate values, forming two statistical groups. (Table 23).

As for the values of AUDPC, which represents the epidemic of the pathogen throughout the crop cycle, the formation of five groups was verified, so that the most efficient fungicides were azoxystrobin+tebuconazole+mancozeb, epoxiconazole+pyraclostrobin+fluxapyroxad, proticonazole+trifloxystrobin+bixafen, whose AUDPC values were the lowest.

The treatments pyraclostrobin+fluxapyroxad, prothioconazole+trifloxystrobin, azoxystrobin+cyproconazole+mancozeb, azoxystrobin+tebuconazole+mancozeb, tebuconazole+chlorothalonil, OFA 0125/16 (azoxystrobin+cyproconazole+chlorothalonil) formed the second group, the treatments epoxiconazole+pyraclostrobin, trifloxystrobin+cyproconazole, picoxystrobin+cyproconazole, benzovindiflupyr+picoxystrobin, flutriafol+carbendazim, kresoxim+tebuconazole+carbendazim, metaminostrobin+tebuconazole, difenoconazole+cyproconazole and propiconazole+difenocholazol formed the third group.

The fourth group was formed by the treatments fenpromimorph, benzovindiflupir+azoxystrobin and azoxystrobin+cyproconazole, and the fifth group, with the highest AUDPC value, was composed by the Control (Table 23).

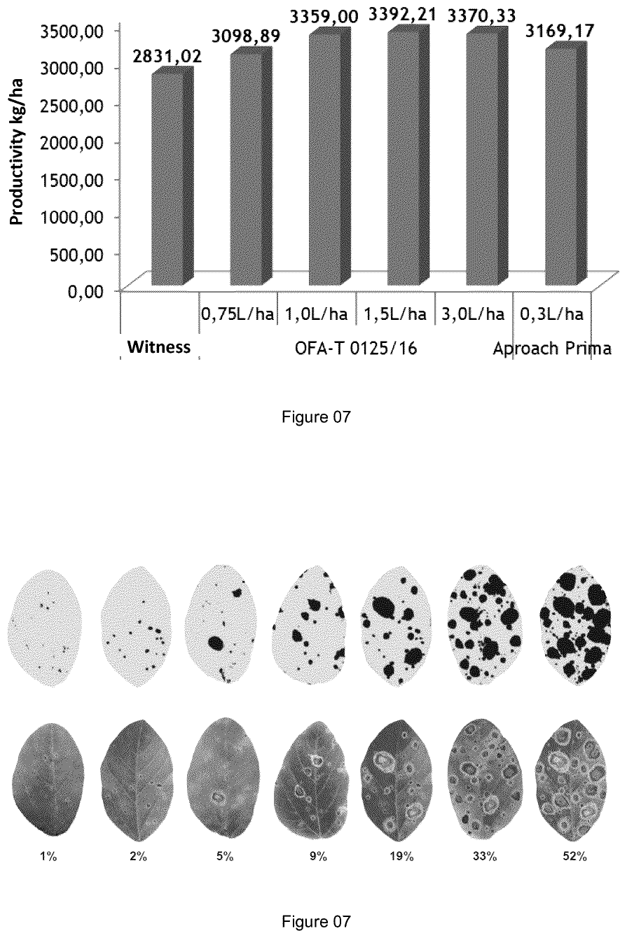

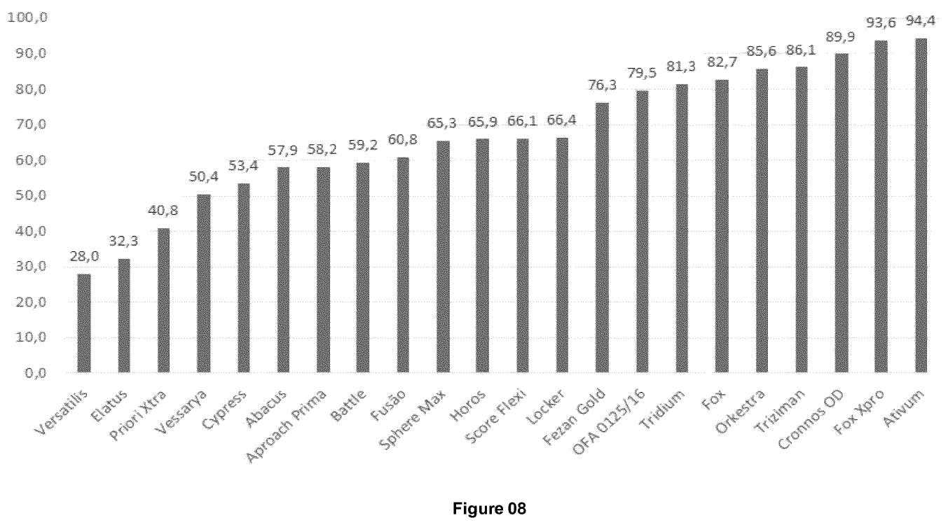

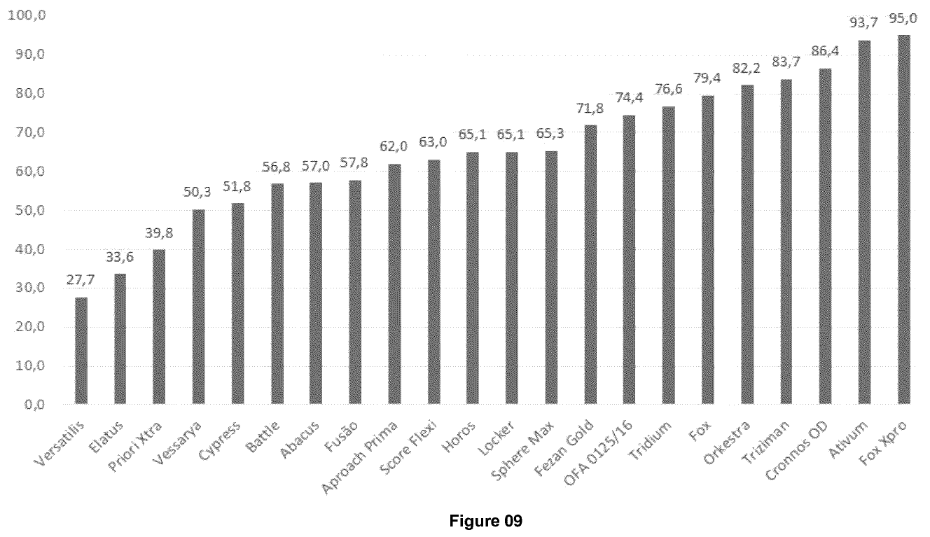

The control efficiency values, prepared based on the AUDPC, can be seen in FIG. 7. These results are important to help producers and consultants in decision making about the management program to be used. It is essential that we alternate active ingredients, rotate products and follow the recommendations in the package insert for each product and the FRAC-BR.

TABLE 23
Severity (%) of target spot on soybean plants in six assessments and area under the disease
progress curve (AUDPC) in the trial conducted in Anaurilândia, MS, 2020.

| No | Treatment | Av1 | Av2 | Av3 | Av4 | Av5 | Av6 | AUDPC |
|---|---|---|---|---|---|---|---|---|
| 1 | Control | 0 | 2.6 A | 7.2 A | 12.1 A | 37.5 D | 51.6 D | 957.2 E |
| | (untreated) | | | | | | | |
| 2 | tebuconazole + | 0 | 0.2 A | 0.6 A | 1.1 A | 4.1 A | 5.2 A | 97.0 A |
| | picoxystrobin + | | | | | | | |
| | mancozeb + | | | | | | | |
| | vegetable oil | | | | | | | |
| 3 | tebuconazole + | 0 | 0.7 A | 2.2 A | 3.8 A | 13.9 B | 17.6 B | 326.6 C |
| | picoxystrobin + | | | | | | | |
| | vegetable oil | | | | | | | |
| 4 | epoxiconazole + | 0 | 0.1 A | 0.4 A | 0.6 A | 2.3 A | 2.9 A | 53.6 A |
| | fluxaripixad + | | | | | | | |
| | pyraclostrobin + | | | | | | | |
| | mineral oil | | | | | | | |
| 5 | pyraclostrobin + | 0 | 0.3 A | 0.9 A | 1.6 A | 5.9 A | 7.4 A | 137.8 B |
| | fluxaripixad + | | | | | | | |
| | mineral oil | | | | | | | |
| 6 | epoxiconazole + | 0 | 0.8 A | 2.7 A | 4.7 A | 17.2 C | 21.8 B | 403.1 C |
| | pyraclostrobin + | | | | | | | |
| | mineral oil | | | | | | | |
| 7 | phenpropimorph | 0 | 1.4 A | 4.6 A | 8.0 A | 29.4 D | 37.2 C | 688.9 D |
| 8 | prothioconazole + | 0 | 0.3 A | 1.1 A | 1.9 A | 7.1 B | 9.0 A | 165.8 B |
| | trifloxystrobin + | | | | | | | |
| | vegetable oil | | | | | | | |
| 9 | prothioconazole + | 0 | 0.1 A | 0.4 A | 0.7 A | 2.6 A | 3.3 A | 61.2 A |
| | trifloxystobin + | | | | | | | |
| | bixafen + | | | | | | | |
| | vegetable oil | | | | | | | |
| 10 | trifloxystrobin + | 0 | 0.7 A | 2.2 A | 3.9 A | 14.1 B | 17.9 B | 331.7 C |
| | cyproconazole + | | | | | | | |
| | vegetable oil | | | | | | | |
| 11 | picoxistobin + | 0 | 0.8 A | 2.7 A | 4.7 A | 17.1 C | 21.6 B | 400.6 C |
| | cyproconazole + | | | | | | | |
| | mineral oil | | | | | | | |
| 12 | benzovindyflupyr + | 0 | 1.0 A | 3.2 A | 5.5 A | 20.2 C | 25.6 B | 474.6 C |
| | picoxystrobin | | | | | | | |
| 13 | flutriafol + | 0 | 0.8 A | 2.6 A | 4.6 A | 16.6 C | 21.1 B | 390.4 C |
| | carbendazim + | | | | | | | |
| | mineral oil | | | | | | | |
| 14 | cresoxin + | 0 | 0.7 A | 2.1 A | 3.7 A | 13.7 B | 17.4 B | 321.5 C |
| | tebuconazole + | | | | | | | |
| | carbendazim + | | | | | | | |
| | mineral oil | | | | | | | |
| 15 | metominostrobin + | 0 | 0.8 A | 2.5 A | 4.4 A | 16.0 C | 20.2 B | 375.1 C |
| | tebuconazole + | | | | | | | |
| | mineral oil | | | | | | | |
| 16 | difenoconazole + | 0 | 0.9 A | 3.0 A | 5.2 A | 19.0 C | 24.1 B | 446.5 C |
| | cyproconazole + | | | | | | | |
| | mineral oil | | | | | | | |
| 17 | benzovindyflupyr + | 0 | 1.3 A | 4.3 A | 7.6 A | 27.6 D | 35.0 C | 648.0 D |
| | azoxystrobin + | | | | | | | |
| | mineral oil | | | | | | | |
| 18 | azoxystrobin + | 0 | 1.2 A | 3.8 A | 6.6 A | 24.1 C | 30.6 C | 566.4 D |
| | cyproconazole + | | | | | | | |
| | mineral oil | | | | | | | |
| 19 | prothioconazole + | 0 | 0.7 A | 2.2 A | 3.8 A | 13.8 B | 17.5 B | 324.0 C |
| | difenoconazole + | | | | | | | |
| | mineral oil | | | | | | | |
| 20 | azoxystrobin + | 0 | 0.3 A | 0.9 A | 1.5 A | 5.7 A | 7.2 A | 132.7 B |
| | cyproconazole + | | | | | | | |
| | mancozeb + | | | | | | | |
| | vegetable oil | | | | | | | |
| 21 | azoxystrobin + | 0 | 0.4 A | 1.2 A | 2.1 A | 7.6 B | 9.6 A | 178.6 B |
| | tebuconazole + | | | | | | | |
| | mancozeb + | | | | | | | |
| | vegetable oil | | | | | | | |
| 22 | tebuconazole + | 0 | 0.5 A | 1.5 A | 2.6 A | 9.7 B | 12.3 A | 227.1 B |
| | chlorothalonil + | | | | | | | |
| | adjuvant | | | | | | | |
| 23 | OFA 0125/16 | 0 | 0.4 A | 1.3 A | 2.3 A | 8.4 B | 10.6 A | 196.5 B |
| | (azoxystrobin + | | | | | | | |
| | cyproconazole + | | | | | | | |
| | chlorothalonil) + | | | | | | | |
| | Ligga OF | | | | | | | |
| | (vegetable oil) | | | | | | | |
| — | Test F | — | 2.3^{ns} | 3.4^{ns} | 3.8^{ns} | 30.5** | 36.4** | 39.5** |
| — | CV (%) | — | 33.2 | 22 | 19.4 | 22.6 | 21.4 | 16.4 |

Means followed by the same capital letter in the column do not differ statistically from each other by the Scott-Knott test at 5% probability.
ns not significant;
* and ** significant at 5% and 1% respectively.

As for the grain yield, there was the formation of two groups, so that the fungicides tebuconazole+picoxystrobin+mancozeb, epoxiconazole+fluxapyroxad+pyraclostrobin, fluxapyroxad+pyraclostrobin, prothioconazole+trifloxystrobin, prothioconazole+trifloxystrobin+bixafen, azoxystrobin+cyproconazole+mancozeb, tebuconazole+azoxystrobin+mancozeb and OFA 0125/16 showed the highest values, with yield increments varying between 13 and 22% in relation to the control

The other treatments formed the second group with the lowest values. The mass of 1000 grains also showed significant differences, so that tebuconazole+picoxystrobin+mancozeb, prothioconazole+trifloxystrobin, picoxystrobin+cyproconazole, metominostrobin+tebuconazole, azoxystrobin+cyproconazole, propiconazole+difenoconazole, tebuconazole+chlorothalonil and OFA 0125/16 had the highest values and the other treatments had the lowest values (Table 24).

TABLE 24
Grain yield (sc ha−1), relative increase in productivity
(%) and mass of 1000 grains (g) of soybean plants treated
with different fungicides applied for the control of target
spot in the trial conducted in Anaurilândia-MS, 2020.

| | | Grain | | |
|---|---|---|---|---|
| | | Yield | Increment | Mass 1000 |
| No | Treatment | (sc/ha) | (%) | Grains (g) |
| 1 | Control (untreated) | 60.7 B | — | 203.8 B |
| 2 | tebuconazole + picoxystrobin + | 73.2 A | 20.5 | 210.7 A |
| | mancozeb + vegetable oil | | | |
| 3 | tebuconazole + picoxystrobin + | 67.1 B | 10.4 | 206.5 B |
| | vegetable oil | | | |
| 4 | epoxiconazole + fluxaripixad + | 73.9 A | 21.7 | 205.7 B |
| | pyraclostrobin + mineral oil | | | |
| 5 | pyraclostrobin + fluxaripixad + | 71.2 A | 17.3 | 203.8 B |
| | mineral oil | | | |
| 6 | epoxiconazole + | 65.3 B | 7.6 | 208.7 B |
| | pyraclostrobin Mineral oil | | | |
| 7 | fenpropimorph | 61.3 B | 0.9 | 200.6 B |
| 8 | prothioconazole + | 70.7 A | 16.5 | 212.6 A |
| | trifloxystrobin + vegetable oil | | | |
| 9 | prothioconazole + | 71.7 A | 18.1 | 204.4 B |
| | trifloxystobin + bixafen + | | | |
| | vegetable oil | | | |
| 10 | trifloxystrobin + | 66.6 B | 9.7 | 203.1 B |
| | cyproconazole + vegetable oil | | | |
| 11 | picoxistobin + cyproconazole + | 65.4 B | 7.7 | 219.7 A |
| | mineral oil | | | |
| 12 | benzovindyflupyr + | 64.1 B | 5.6 | 202.2 B |
| | picoxystrobin | | | |
| 13 | flutriafol + carbendazim + | 65.4 B | 7.7 | 202.4 B |
| | mineral oil | | | |
| 14 | cresoxin + tebuconazole + | 67.3 B | 10.9 | 198.6 B |
| | carbendazim + mineral oil | | | |
| 15 | metominostrobin + | 65.4 B | 7.7 | 214.9 A |
| | tebuconazole + mineral oil | | | |
| 16 | difenoconazole + | 64.6 B | 6.3 | 205.6 B |
| | cyproconazole + mineral oil | | | |
| 17 | Benzovindiflupir + | 63.3 B | 4.2 | 208.9 B |
| | azoxystrobin + mineral oil | | | |
| 18 | azoxystrobin + cyproconazole + | 64.1 B | 5.6 | 213.0 A |
| | mineral oil | | | |
| 19 | prothioconazole + | 67.7 B | 11.6 | 216.5 A |
| | difenoconazole + mineral oil | | | |
| 20 | azoxystrobin + cyproconazole + | 71.4 A | 17.5 | 204.7 B |
| | mancozeb + vegetable oil | | | |
| 21 | Azoxystrobin + tebuconazole + | 69.3 A | 14.1 | 207.2 B |
| | mancozeb + vegetable oil | | | |
| 22 | tebuconazole + chlorothalonil + | 67.8 B | 11.7 | 212.8 A |
| | adjuvant | | | |
| 23 | OFA 0125/16 (azoxystrobin + | 69.0 A | 13.6 | 217.9 A |
| | cyproconazole + | | | |
| | chlorothalonil) + Ligga OF | | | |
| | (vegetable oil) | | | |
| — | Teste F | 1.8* | — | 2.0* |
| — | CV (%) | 8.1 | — | 4 |

Means followed by the same capital letter in the column do not differ statistically from each other by the Scott-Knott test at 5% probability.
ns not significant; * and ** significant at 5% and 1% respectively.

### Conclusions

Under the conditions in which the test was conducted, it can be concluded that the fungicides tebuconazole+picoxystrobin+mancozeb, epoxiconazole+fluxapyroxad+pyraclostrobin and prothioconazole+trifloxystrobin; prothioconazole+tirfloxystrobin+bixafen were the most efficient in controlling target spot in soybean plants.

### Final Considerations

With the convenience of being able to be used at any time of the cycle, the versatility of OFA-T 0125/16 proves to be an excellent tool in the control of the target spot (Corynespora cassicola) with 79.5% effectiveness in controlling the pathogen, thanks to the combination of strobilurin+triazole+multisite which also acts in the control of the soybean disease complex.

Target Loot Control in Soybean Plants with Different Site-Specific Fungicides in the Municipality of Itaquiraí-MS Material and Methods

TABLE 25
Treatments and doses

| | | Dose (mL |
|---|---|---|
| No | Treatment | ou g p.c./ha) |
| 1 | Control (untreated) | — |
| 2 | tebuconazole + picoxystrobin + mancozeb + | 2250 + 250 |
| | vegetable oil | |
| 3 | tebuconazole + picoxystrobin + vegetable oil | 500 + 250 |
| 4 | epoxiconazole + fluxaripixad + pyraclostrobin + | 800 + 500 |
| | mineral oil | |
| 5 | pyraclostrobin + fluxaripixad + mineral oil | 300 + 500 |
| 6 | epoxiconazole + pyraclostrobin + mineral oil | 250 + 500 |
| 7 | fenpropimorph | 300 |
| 8 | prothioconazole + trifloxystrobin + vegetable oil | 400 + 200 |
| 9 | prothioconazole + trifloxystobin + bixafen + | 500 + 200 |
| | vegetable oil | |
| 10 | trifloxystrobin + cyproconazole + vegetable oil | 200 + 200 |
| 11 | picoxistobin + cyproconazole + mineral oil | 300 + 600 |
| 12 | benzovindyflupyr + picoxystrobin | 600 |
| 13 | flutriafol + carbendazim + mineral oil | 500 + 600 |
| 14 | cresoxin + tebuconazole + carbendazim + | 1000 + 600 |
| | mineral oil | |
| 15 | metominostrobin + tebuconazole + mineral oil | 580 + 600 |
| 16 | difenoconazole + cyproconazole + mineral oil | 400 + 600 |
| 17 | benzovindyflupyr + azoxystrobin + mineral oil | 200 + 600 |
| 18 | azoxystrobin + cyproconazole + mineral oil | 300 + 600 |
| 19 | prothioconazole + difenoconazole + mineral oil | 150 + 600 |
| 20 | azoxystrobin + cyproconazole + mancozeb + | 2000 + 0.25% |
| | vegetable oil | |
| 21 | azoxystrobin + tebuconazole + mancozeb + | 1750 + 0.25% |
| | Aureo vegetable oil | |
| 22 | tebuconazole + chlorothalonil + adjuvant | 2500 + 50 |
| 23 | OFA 0125/16 (azoxystrobin + cyproconazole + | 1500 + 0.25% |
| | chlorothalonil) + Ligga OF (vegetable oil) | |

p.c.—commercial product; DAE—days after plant emergence.
Time of application of treatments: 30/45/60/75 days after plant emergence.

### Culture Data:

Place: Itaquiraí, MS
Field: UDT-I Copasul
Geographic coordinate: 21° 37′10.40″S; 55° 08′13.27″O
Year: Safra 2019/20
Previous crop: Corn
Plant: Brasmax Garra IPRO
Planting system: Conventional planting system
Sowing date: 13/11/2019
Line spacing: 50 cm
Fertilization: 250 kg ha-1 Apr. 30, 2010 (N-P-K) in the sowing furrow harvest date: 15/03/2020

1) EXPERIMENTAL DESIGN, SAMPLING UNIT AND STATISTICAL ANALYSIS: The experiment was carried out in a randomized block design, with 23 treatments and four replications. Each plot consisted of seven lines of 10 meters in length (35 m2). The data obtained were submitted to analysis of variance and the mean of the treatments compared by the Scott-Knott test at 5% probability.

2) APPLICATION TECHNOLOGY: The treatments were applied using a constant pressure CO2-based sprayer, with a bar with six nozzles spaced 0.5 m between each nozzle. Double fan nozzle TJ 06 11002 and spray volume of 160 l/ha were used.

TABLE 26
Weather conditions at the time of each application.

| | | | | Relative | Wind |
|---|---|---|---|---|---|
| | | | Temperature | humidity | speed |
| Date | Stadium | Hour | (° C.) | (%) | (m/s) |
| 17 Dec. 2019 | V6 | 09 h 33 min | 29.6 | 62.7 | 1.1 |
| 2 Jan. 2020 | R2 | 09 h 28 min | 28.4 | 74.5 | 1.4 |
| 19 Jan. 2020 | R4 | 08 h 17 min | 27.5 | 73.2 | 2.6 |
| 3 Feb. 2020 | R5.3 | 09 h 49 min | 29.2 | 70.4 | 1.2 |

EVALUATIONS, Target Spot Severity in soybean plants: Six disease severity assessments were performed before each application and at 14 and 21 days after the last application of treatments, at 32, 48, 62, 77, 91 and 98 days after plant emergence. Assessments were based on diagrammatic scales proposed by Soares et al. (2009) for target spot (Corynespora cassiicola) (FIG. 6). Ten plants per plot were evaluated. In each plant, two leaflets were removed and the average of the plot was considered the average of the 20 leaflets evaluated.

Disease severity results from the size and number of lesions, and these two components may act independently during disease progression (Kranz 1988; Boff et al. 1991). Furthermore, the best representation of an epidemic is the disease progress curve, usually expressed by plotting the proportion of disease as a function of time (Paula and Oliveira 2003). Thus, severity data were used to calculate the area under the disease progress curve (AUDPC) based on the model proposed by Campbell and Madden (1990), in which

$$AACPD = {\sum }_{1}^{n - 1} \frac{{y}_{i} + {y}_{i + 1}}{2} \times ( {t}_{i + 1} - {t}_{i} )$$

where n is the number of assessments, y is the severity of the disease, and t is the time in days of each assessment.

### Control Efficiency

Based on the data obtained from the severity of the disease in the experimental area, the control efficiency of each treatment was calculated according to the method proposed by Abbott (1925), in which:

$$E ( \% ) = \frac{( T - t ) \times 100}{T}$$

where E (%) is the control efficiency of the treatment expressed as a percentage, T is the AUDPC value in the control, and t is the AUDPC value in the evaluated treatment.

### Grain Yield

Yield evaluations were performed with the harvest of the three central lines of each seven-meter-long plot with the aid of a plot harvester and the grain moisture was corrected to 13%. For the correction of grain moisture, the formula below was used:

$$Yield = \frac{10 \times ( 100 - U S ) \times P}{( 100 - 13 ) \times A C}$$

where Yield is expressed in tons per hectare, US is seed moisture in %, PP is the weight harvested from the plot in kg, and AC is the harvested area from the plot in m2. In addition, the mass of 1000 grains of each plot were recorded.

### Results and Discussion

The results of the target spot severity assessments indicated signs of the pathogen from the second assessment, but at this time, no significant differences between treatments. This same pattern was observed in the third evaluation.

In the fourth evaluation, two groups were formed, so that the fungicides tebuconazole+picoxystrobin+mancozeb, tebuconazole+picoxystrobin, epoxiconazole+fluxapyroxad+pyraclostrobin, fluxapyroxad+pyraclostrobin, epoxiconazole+pyraclostrobin, prothioconazole+trifloxystrobin, prothioconazole+trifloxystrobin+bixafen, trifloxystrobin+cyproconazole, picoxystrobin+cyproconazole, benzovindiflupyr+picoxystrobin, flutriafol+carbendazim, kresoxim+tebuconazole+carbendazim, metominostrobin+tebuconazole, difenoconazole+cyproconazole, propiconazole+difenoconazole, azoxystrobin+cyproconazole+mancozeb, tebuconazole+azoxystrobin+mancozeb, tebuconazole+chlorothalonil and OFA 0125/16 (azoxystrobin+cyproconazole+chlorothalonil) presented the lowest values and the other fungicides together with the Control presented the highest values (Table 27).

In the fifth evaluation, two groups were formed, so that the fungicides tebuconazole+picoxystrobin+mancozeb, tebuconazole+picoxystrobin, epoxiconazole+fluxapyroxad+pyraclostrobin, fluxapyroxad+pyraclostrobin, epoxiconazole+pyraclostrobin, prothioconazole+tirfloxystrobin, prothioconazole+trifloxystrobin, prothioconazole+tirfloxystrobin+bixafen, trifloxystrobin+cyproconazole, picoxystrobin+cyproconazole, flutriafol+carbendazin, resoxim+tebuconazole+carbendazim, metominostrobin+tebuconazole, difenoconazole+cyproconazole, propiconazole+difenoconazole, azoxystrobin+cyproconazole+mancozeb, tebuconazole+azoxystrobin+mancozeb, tebuconazole+chlorothalonil and OFA 0125/16 (azoxystrobin+cyproconazole+chlorothalonil) presented the lowest values and the other fungicides together with the Control presented the highest values (Table 27).

In the sixth severity assessment, four groups were formed, so that the fungicides tebuconazole+picoxystrobin+mancozeb, epoxiconazole+fluxapyroxad+pyraclostrobin, fluxapyroxad+pyraclostrobin, prothioconazole+trifloxystrobin, prothioconazole+tirfloxystrobin+bixafen and azoxystrobin+cyproconazole+mancozeb showed the lowest values.

The group with the highest severity of target spot was composed by the Control, and the other fungicides formed two groups with intermediate severities (Table 27). As for the AUDPC values, which best represent the epidemic of the disease throughout the crop cycle, it was verified the formation of five groups, so that the group with the lowest values and, therefore, the most effective in reducing the progress of the pathogen were formed by the fungicides tebuconazole+picoxystrobin+mancozeb, epoxiconazole+fluxapyroxad+pyraclostrobin and prothioconazole+trifloxystrobin+bixafen.

The fifth group was formed by the Control (untreated), indicating that all fungicides were able to significantly reduce the progress of the disease. Control efficiency results can be seen in Table 27.

These results were generated using AUDPC values as a basis. Regarding grain yield, the fungicides that showed the highest values were tebuconazole+picoxystrobin+mancozeb, epoxiconazole+fluxapyroxad+pyraclostrobin, fluxapyroxad+pyraclostrobin, prothioconazole+trifloxystrobin+bixafen and azoxystrobin+cyproconazole+mancozeb, with increments of approximately 30%. more productivity in relation to the Control (untreated) (Table 27).

These results are important to assist producers and consultants in making a decision about the management program to be used. It is essential that we alternate active ingredients, rotate products and follow the recommendations in the package insert for each product and the FRAC-BR.

TABLE 27
Severity (%) of target spot on soybean plants in six assessments and area under the disease
progress curve (AUDPC) in the trial conducted in Itaquiraí, MS, 2020.

| No | Treatment | Av. 1 | Av. 2 | Av. 3 | Av. 4 | Av. 5 | Av. 6 | AUDPC |
|---|---|---|---|---|---|---|---|---|
| 1 | Witness | 0 | 1.7A | 3.8A | 7.3B | 14.5B | 25.4D | 426.7E |
| 2 | tebuconazole + picoxystrobin + | 0 | 0.2A | 0.5A | 1.0A | 2.0A | 3.4A | 58.2A |
| | mancozeb + vegetable oil | | | | | | | |
| 3 | tebuconazole + picoxystrobin + | 0 | 0.5A | 1.3A | 2.6A | 5.1A | 8.8B | 149.0C |
| | vegetable oil | | | | | | | |
| 4 | Epoxiconaloze + fluxaripixad + | 0 | 0.1A | 0.2A | 0.5A | 0.9A | 1.6A | 26.8A |
| | pyraclostrobin + mineral oil | | | | | | | |
| 5 | pyraclostrobin + fluxaripixad + | 0 | 0.2A | 0.7A | 1.3A | 2.6A | 4.5A | 76.1B |
| | mineral oil | | | | | | | |
| 6 | epoxiconaloze + pyraclostrobin + | 0 | 0.6A | 1.6A | 3.2A | 6.3A | 10.8B | 183.3C |
| | mineral oil | | | | | | | |
| 7 | fenpropimorph | 0 | 1.0A | 2.7A | 5.4B | 10.6B | 18.2C | 308.4D |
| 8 | prothioconazole + trifloxystrobin + | 0 | 0.3A | 0.8A | 1.5A | 3.0A | 5.2B | 87.9B |
| | vegetable oil | | | | | | | |
| 9 | prothioconazole + trifloxysrtobin + | 0 | 0.1A | 0.2A | 0.4A | 0.7A | 1.3A | 21.4A |
| | bixafen + vegetable oil | | | | | | | |
| 10 | trifloxystrobin + cyproconazole + | 0 | 0.5A | 1.3A | 2.6A | 5.1A | 8.7B | 148.3C |
| | vegetable oil | | | | | | | |
| 11 | picoxistobin + cyproconazole + | 0 | 0.5A | 1.4A | 2.8A | 5.6A | 9.6B | 162.3C |
| | mineral oil | | | | | | | |
| 12 | Benzovindiflupir + picoxystrobin | 0 | 0.7A | 1.9A | 3.7A | 7.3B | 12.5C | 212.3C |
| 13 | flutriafol + carbendazim + mineral oil | 0 | 0.6A | 1.6A | 3.2A | 6.4A | 10.9B | 184.4C |
| 14 | cresoxin + tebuconazole + carbendazim + | 0 | 0.5A | 1.3A | 2.6A | 5.1A | 8.8B | 149.0C |
| | mineral oil | | | | | | | |
| 15 | metominostrobin + tebuconazole + | 0 | 0.6A | 1.6A | 3.2A | 6.2A | 10.6B | 180.1C |
| | mineral oil | | | | | | | |
| 16 | difenoconazole + cyproconazole + | 0 | 0.7A | 1.8A | 3.6A | 7.1A | 12.1C | 205.8C |
| | mineral oil | | | | | | | |
| 17 | benzovindyflupyr + azoxystrobin + | 0 | 0.9A | 2.5A | 5.0B | 9.8B | 16.7C | 283.2D |
| | mineral oil | | | | | | | |
| 18 | azoxystrobin + cyproconazole + mineral | 0 | 0.8A | 2.3A | 4.5B | 8.9B | 15.2C | 257.0D |
| | oil | | | | | | | |
| 19 | prothioconazole + difenoconazole + | 0 | 0.5A | 1.4A | 2.8A | 5.4A | 9.3B | 157.8C |
| | mineral oil | | | | | | | |
| 20 | azoxystrobin + cyproconazole + | 0 | 0.2A | 0.6A | 1.2A | 2.4A | 4.1A | 69.4B |
| | mancozeb + vegetable oil | | | | | | | |
| 21 | azoxystrobin + tebuconazole + | | 0.3A | 0.9A | 1.7A | 3.4A | 5.9B | 99.7B |
| | mancozeb + vegetable oilAureo | | | | | | | |
| 22 | tebuconazole + chlorothalonil + adjuvant | 0 | 0.4A | 1.1A | 2.1A | 4.1A | 7.1B | 120.2B |
| 23 | OFA 0125/16 (azoxystrobin + | 0 | 0.4A | 1.0A | 1.9A | 3.8A | 6.4B | 109.1B |
| | cyproconazole + chlorothalonil) + Ligga | | | | | | | |
| | OF (vegetable oil) | | | | | | | |
| — | Test F | — | 4.1^{ns} | 3.4^{ns} | 24.7** | 21.8** | 25.5** | 22.2** |
| — | CV (%) | — | 46.8 | 30 | 23.6 | 25.4 | 23.7 | 25.3A |

Means followed by the same capital letter in the column do not differ statistically from each other by the Scott-Knott test at 5% probability.
ns not significant;
* and ** significant at 5% and 1% respectively.

TABLE 28
Grain yield (sc ha − 1), relative increase in productivity (%) and weight
of 1000 grains (g) of soybean plants treated with different fungicides applied
to control target spot in the trial conducted in Itaquiraí-MS, 2020.

| | | Grains Yield | Increment | Mass 1000 |
|---|---|---|---|---|
| No | Treatment | (sc ha⁻¹) | (%) | Grains (g) |
| 1 | Witness | 49.3 C | — | 151.3 B |
| 2 | tebuconazole + picoxystrobin + | 65.9 A | 33.5 | 155.5 B |
| | mancozeb + vegetable oil | | | |
| 3 | tebuconazole + picoxystrobin + | 59.5 B | 20.6 | 155.7 B |
| | vegetable oil | | | |
| 4 | epoxiconaloze + fluxaripixad + | 66.6 A | 35 | 165.1 A |
| | pyraclostrobin + mineral oil | | | |
| 5 | pyraclostrobin + fluxaripixad + | 63.0 A | 27.7 | 163.0 A |
| | mineral oil | | | |
| 6 | epoxiconaloze + pyraclostrobin + | 58.0 B | 17.5 | 154.4 B |
| | mineral oil | | | |
| 7 | fenpropimorph | 55.3 B | 12.1 | 144.5 B |
| 8 | prothioconazole + trifloxystrobin + | 61.1 B | 23.8 | 159.2 A |
| | vegetable oil | | | |
| 9 | prothioconazole + trifloxystobin + | 68.0 A | 37.8 | 160.3 A |
| | bixafen + vegetable oil | | | |
| 10 | trifloxystrobin + cyproconazole + | 60.4 B | 22.5 | 151.4 B |
| | vegetable oil | | | |
| 11 | picoxistobin + cyproconazole + | 58.2 B | 18 | 156.0 B |
| | mineral oil | | | |
| 12 | benzovindyflupyr + picoxystrobin | 57.9 B | 17.4 | 156.5 B |
| 13 | flutriafol + carbendazim + | 57.1 B | 15.8 | 152.1 B |
| | mineral oil | | | |
| 14 | cresoxin + tebuconazole + | 59.9 B | 21.5 | 148.6 B |
| | carbendazim + mineral oil | | | |
| 15 | metominostrobin + tebuconazole + | 58.1 B | 17.8 | 152.6 B |
| | mineral oil | | | |
| 16 | difenoconazole + cyproconazole + | 57.3 B | 16.1 | 160.7 A |
| | mineral oil | | | |
| 17 | benzovindyflupyr + azoxystrobin + | 55.9 B | 13.4 | 151.4 B |
| | mineral oil | | | |
| 18 | azoxystrobin + cyproconazole + | 56.9 B | 15.3 | 159.5 A |
| | mineral oil | | | |
| 19 | prothioconazole + difenoconazole + | 59.3 B | 20.2 | 162.1 A |
| | mineral oil | | | |
| 20 | azoxystrobin + cyproconazole + | 63.6 A | 28.9 | 151.3 B |
| | mancozeb + vegetable oil | | | |
| 21 | azoxystrobin + tebuconazole + | 61.0 B | 23.6 | 154.1 B |
| | mancozeb + vegetable oil | | | |
| 22 | tebuconazole + chlorothalonil + | 60.7 B | 23 | 154.9 B |
| | adjuvant | | | |
| 23 | OFA 0125/16 (azoxystrobin + | 60.7 B | 23.1 | 154.4 B |
| | cyproconazole + chlorothalonil) + | | | |
| | Ligga OF (vegetable oil) | | | |
| — | Teste F | 3.7* | — | 2.1* |
| — | CV (%) | 11.7 | — | 4.4 |

Means followed by the same capital letter in the column do not differ statistically from each other by the Scott-Knott test at 5% probability.
ns not significant; * and ** significant at 5% and 1% respectively.

### Conclusions

Under the conditions in which the test was conducted, it can be concluded that the fungicides tebuconazole+picoxystrobin+mancozeb, prothioconazole+trifloxystrobin+bixafen and epoxiconazole+fluxapyroxad+pyraclostrobin were the most efficient fungicides in controlling target spot in soybean plants.

### Final Considerations

The correct management of soybean diseases will depend on the knowledge of the history of the area, the choice of cultivars, crop rotation, the use of efficient fungicides, applied at the right time, rotation of mechanisms of action and the use of multisites.

Current effective chemical control options for target spot are limited to a few fungicides. Protective multisites have provided an important contribution to control, but it is necessary that site-specific fungicides continue to present good performance so that multisite fungicides can complement the control.

The fungicide OFA 0125/16 has a triple formulation, with preventive action in relation to the appearance of diseases, contributing with other site-specific modes of action. Therefore, OFA-T 0125/16 (Azoxystrobin 53+Cyproconazole 16+Chlorothalonil 650 g/L SC) can be considered an excellent ally in the control of fungi, such as Corynespora cassiicola, which causes target spot in soybeans.

FINAL CONSIDERATIONS The sustainability of Brazilian soybeans could be threatened if fungicides continue to have reduced efficiency because of the resistance and lower sensitivity of the fungus to these products.

The greatest risk of losing currently available fungicides lies in the fact that there is no new mode of action to enter the market in the next few years. Because it is a natural process, resistance to most new fungicides is almost certain to occur.

However, the shelf life can be extended using the groups of systemic fungicides, with a specific mode of action, with the association of protectors such as the fungicide OFA-T 0125/16 (azoxystrobin+cyproconazole+chlorothalonil) developed in a unique formulation considering the fact that chlorothalonil has a photoprotective action, reducing the degradation of strobilurins such as azoxystrobin and triazoles such as cyproconazole, with specific surfactants such as adhering agents and others that promote excellent performance in the management of the main diseases in soybean and other crops.

The use of fungicides with prolonged residual effect such as protectors are fundamental in preserving the useful life of systemic fungicides in the field. Therefore, it is concluded that OFA-T 0125/16 (azoxystrobin+cyproconazole+chlorothalonil) used in the management of Asian rust (Phakopsora pachyrhizi), brown leaf spot (Septoria glycines) and target leaf spot (Corynespora cassiicola) in different scenarios that were presented guarantees an effective control of these diseases.

Within this context, Ourofino Agrociência invested in the present invention, that is, the development of an innovative formulation OFA-T 0125/16 (azoxystrobin+cyproconazole+chlorothalonil) which involved the construction of an arrangement of information and technologies that needed be selected, combined, evaluated and continuously improved until obtaining a viable product in economic, social and environmental terms. The process is complex, requires time and large investments, and patent protection is essential so that the company can exclusively commercially exploit the innovation developed, allowing the recovery of invested resources.

The company also has ethics as one of its pillars of support. In this context, it understands that obtaining patents must serve the effective scientific and technological development seeking the sustainable production of food, fiber and bioenergy. It is contrary to the company's ethical principles to apply for patents that aim to create legal uncertainty for competitors and unfair commercial advantages.

It is worth mentioning the complexity of the studies conducted so that the new formulation could be developed and evaluated. In addition to innovative concepts in terms of the selection of components and manufacturing processes, it was a great challenge to develop experimental and analytical methods that would allow the precise quantification of the levels of the three fungicides on the surface or inside the leaves. It was also necessary to develop procedures to measure the concentrations of fungicides in rainwater to compare experimental formulations and commercial products in terms of their ability to remain on leaves after rainfall. In total, 3,258 quantifications of fungicides (active ingredients) were carried out in different types of matrices.

Chlorothalonil stands out in terms of analytical difficulty requiring the use of specific ionization and analysis procedures in LC-MSMS systems that were developed exclusively for this project.

In summary, in the present innovation, the main points to be considered were:
1. The combination of active ingredients and the choice of chlorothalonil as a protective fungicide.
2. Choice of triazole cyproconazole.
3. Choice of strobilurin azoxystrobin.
4. The formulation development process.

The following items present information on the technologies developed to achieve the six objectives that guide the formulation development process at Ourofino Agrociência:
1. Increase in the concentration of actives in the formulation, reducing the consumption of raw materials and transport costs;
2. Use of safer raw materials in toxicological and environmental terms;
3. Development of stable formulations during storage and transport;
4. Increased deposition with reduced drift losses;
5. Development of formulations with dynamics and persistence of each of the active ingredients best suited to the control of pathogens;
6. High efficiency in comparative studies under practical conditions of use.

### CONSULTED BIBLIOGRAPHY

ABBOTT, W. S. A method of computing the effectiveness of an insecticide. Journal of Economic Entomology, v. 18, p. 265-266, 1925.
ALMEIDA, A. M. R.; FERREIRA, L. P.; YORINORI, J. T.; SILVA, J. F. V.; HENNING,
A. A.; GODOY, C. V.; COSTAMILAN, L. M.; MEYER, M. C. 2005. Doenças da Soja. In: KIMATI, H.; AMORIM, L.; REZENDE, J. A. M.; BERGAMIM FILHO, A.; CAMARGO, L. E. A. 2005. Manual de Fitopatologia. Volume 2. p. 576-577.
AZEVEDO, L. 2018. Impacto dos fungicidas protetores na cultura. Disponível e: <http://maissoja.com.br/impacto-dos-fungicidas-protetores-na-cultura-da-soja/>. Acesso: 02 de abril de 2020.
BALARDIN, R. 2016. Manutenção da tecnologia existente para controle de Phakopsora pachyrhizi agente causal da Ferrugem Asiática na cultura da soja. Parecer Técnico. Ministério da Educação Universidade Federal de Santa Maria Departamento de Defesa Fitossanitária.
BANZATTO, D. A., KRONKA, S. N. Experimentação Agrícola. 4. ed.-Jaboticabal: Funep, 2006. 237p
BARBOSA, g. f.; CENTURION, m. a. p da c.; FERRAUDO, a. s. 2014. POTENCIAL DO MANEJO INTEGRADO DA FERRUGEM ASIÁTICA DA SOJA: SEVERIDADE DA DOENçA, DESENVOLVIMENTO VEGETATIVO E COMPONENTES DA PRODUçÃO, CULTIVAR MG/BR-46 (CONQUISTA). Disponível em: <file:///C:/Users/jesse/Downloads/15037-104640-1-PB.pdf>. Acesso: 13 de junho de 2018.
BARTLETT, D. W.; CLOUGH, J. M.; GODWIN, J. R.; HALL, A. A.; HAMER, M.; PARR-BROMFIELD, K. R. Soybean rust. 1984. 63f. American Phytopathological Society. St. Paul, Minnesota. (Monograph n. 11).
CAMPBELL, C. L.; MADDEN, L. V. Introduction to plant disease epidemiology. 1990. 532 p.
BUCHENAUER, H. Mechanism of action of triazolyl fungicides and related compounds. In: Lyr, H. Modern selective fungicides properties, applications, mechanisms of action. Longman Scientific & Technical, p. 205-32, 1987.
CAMPOS, H. D.; SILVA, L. HC. P. ESCALAS DESCRITIVA E DIAGRAMÁTICA PARA AVALIAçÃO DE FITOTOXIDEZ EM FUNçÃO DA INTENSIDADE DE CLOROSES E/OU BRONZEAMENTOS E NECROSES FOLIARES CAUSADAS POR FUNGICIDAS. Rio Verde, Goiás, 2p.
CANTERI, M. G., ALTHAUS, R. A., VIRGENS FILHO, J. S., GIGLIOTI, E. A.,
GODOY, C. V. SASM-Agri: Sistema para análise e separação de médias em experimentos agrícolas pelos métodos Scott-Knott, Tukey e Duncan. Revista Brasileira de Agrocomputação, V. 1, N. 2, p. 18-24. 2001.
COSTA, J. L. B.; Campos, H. D.; Silva, R. S.; Ribeiro, L. M.; Pilar, M. N.; Magalhães,
W. B. 2017. FUNGICIDAS SISTEMICOS NO CONTROLE DA FERRUGEM ASIÁTICA NA CULTURA DA SOJA EM GOIÁS. 50° congresso brasileiro de fitopatologia. Disponível em: <http://www.cbfito.com.br/cd/Resumos/Resumo50CBFito_0347.pdf>. Acesso: 06 de junho de 2018.
DOBRZANSKI, B. The strobilurin fungicides. Pest Management Science, v. 58, pp. 649-662, 2002.
EMBRAPA. 2014. Ferrugem asiática da soja. Disponível em: <https://www.embrapa.br/busca-de-publicacoes/-/publicacao/1001340/ferrugem-asiatica-da-soja>. Acesso: 05 de junho de 2018.
EMBRAPA. 2016. Soluções tecnológicas. Ferrugem: manejo e prevenção. Disponível em: <https://www.embrapa.br/busca-de-solucoes-tecnologicas/-/produto-servico/3031/ferrugem-manejo-e-prevencao>. Acesso: 05 de junho de 2018.
EMBRAPA. 2017. Como agem os fungicidas multissítios no controle da ferrugem asiática. Disponível em: <https://www.noticiasagricolas.com.br/noticias/soja/199770-como-agem-os-fungicidas-multissitios-no-controle-da-ferrugem-asiatica.html #.WxbxnOgvzIU>. Acesso: 05 de junho de 2018.
FARIAS, J. R. B. 2016. RESISTÊNCIA DA FERRUGEM ASIÁTICA DA SOJA A FUNGICIDAS É PROBLEMA. Informativo Meridional-Edição No 56. Disponível em: <http://fundacaomeridional.com.br/artigos/2016/01/05/resistencia-da-ferrugem-asiatica-da-soja-a-fungicidas-e-problema->. Acesso: 06 de junho de 2018.
FIALLOS, F. R. G. 2011. A FERRUGEM ASIÁTICA DA SOJA CAUSADA POR Phakopsora pachyrhizi Sydow e Sydow. ARTÍCULO DE REVISIÓN en Ciencia y Tecnología 4 (2): 45-60. 2011. Disponível em: <http://www.uteq.edu.ec/revistacyt/publico/archivos/C2_A%20ferrugen%20asi%C3%A1tica.pdf>. Acesso: 06 de junho de 2018.
FRANCO, L. 2017. Tudo o que você precisa saber sobre a ferrugem asiática. Disponível em: <http://www.canalrural.com.br/noticias/soja/tudo-que-voce-precisa-saber-sobre-ferrugem-asiatica-70401>. Acesso: 05 de junho de 2018.
GODOY, C. V.; ALMEIDA, A. M. R.; SOARES, R. M.; SEIXAS, C. D. S.;
DIAS, W. P.; MEYER, M. C.; COSTAMILAN, L. M.; HENNING, A. A. 2014.
DOENçAS DA SOJA (Glycine max (L.) Merrill). Disponível em: <https://ainfo.cnptia.embrapa.br/digital/bitstream/item/125697/1/D oencasdaSoja.pdf>. Acesso: 03 de abril de 2020.
GODOY, C. V.; MEYER, M. C.; SIQUERI, F. NAVARINI, L.; MARTINS, M. C.;
FERREIRA, A. H. Sustentabilidade Pressionada. Revista Cultivar, 2016. p. 26-29.
GODOY, C. V.; UTIAMADA, C. M.; MEYER, M. C.; CAMPOS, H. D.; FORCELINI, C.
A.; PIMENTA, C. B. 2015. Eficiência de fungicidas multissítios e fertilizantes no controle da ferrugemasiática da soja, Phakopsora pachyrhizi, na safra 2014/15: resultados sumarizados dos ensaios cooperativos. Circular Técnica 113. Disponível em: <https://www.infoteca.cnptia.embrapa.br/infoteca/bitstream/doc/1027879/1/CT113.pdf>. Acesso: 06 de junho de 2018.
GODOY, C. V.; UTIAMADA, C. M.; MEYER, M. C.; CAMPOS, H. D.; LOPES, I. DE O. N.; FORCELINI, C. A. 2017. Eficiência de fungicidas para o controle da ferrugem-asiática da soja, Phakopsora pachyrhizi, na safra 2016/17: resultados sumarizados dos ensaios cooperativos. Circular Técnica 129. Disponível em: <https://ainfo.cnptia.embrapa.br/digital/bitstream/item/162648/1/C T-129-ferrugem-OL.pdf>. Acesso: 05 de junho de 2018.
GUIMARÃES, L. S. 2008. Mancha parda (Septoria glycines Hemmi) da soja (Glycine max L.): Aspectos etiológicos e de controle. Disponível em: <http://repositorio.unb.br/bitstream/10482/3796/1/2008_LeticiaSimoneGuimaraes.pdf>. Acesso: 05 de abril de 2020.
HARTMAN, G. L., WANG, T. C., TCHANZ, A. T. Soybean rust development and tbe quantitative relationship between rust severity and soybean yield. Plant Disease, v. 75, p. 596-600, 1991.
HANSSLER, G.; KUCK, K. H. Microscopic studies on the effect of Folicur on pathogenesis of brown rust of wheat (Puccinia recondite sp tritici). Pflanzenschutz-Nachrichten Bayer, v. 40, pp. 153-180, 1987.
HENNING, A. A.; ALMEIDA, A. M. R.; GODOY, C. V.; SEIXAS, C. D. S.; YORINORI, J. T.; COSTAMILAN, L. M.; FERREIRA, L. P.; MEYER, M. C.; SOARES, R. M.; DIAS, W. P. 2005. Manual de identificação de doenças da soja. p. 16. Disponível em: <https://www.agrolink.com.br/downloads/doen%C3%A7as%20da%20soja.pdf>. Acesso: 05 de junho de 2018.
HEWITT, H. G. Fungicides in Plant Protection. CAB International, Wallingford, U K. 1998. 221p.
LANDGRAF, L. 2017. Produção de soja no Brasil cresce mais de 13% ao ano. Disponível em: <https://www.embrapa.br/busca-de-noticias/-/noticia/25242861/producao-de-soja-no-brasil-cresce-mais-de-13-ao-ano>. Acesso: 05 de junho de 2018.
LEINHOS, G. M. E.; GOLD, R. E.; DÜGGELIN, M.; GUGGENHEIM, R. Development and morphology of Uncinula necator following treatment with the fungicides Kresoxim-methyl and penconazole. Mycology Research, v. 101, pp. 1033-1046, 1997.
ITO, M. F. 2013. PRINCIPAIS DOENçAS DA CULTURA DA SOJA E MANEJO INTEGRADO. 1° ENCONTRO TECNICO SOBRE AS CULTURAS DA SOJA E DO MILHO NO NOROESTE PAULISTA. Nucleus, Edição Especial, 2013. Disponível em: <http://www.nucleus.feituverava.com.br/index.php/nucleus/article/view/908/1041>. Acesso: 05 de junho de 2018.
JUNIOR, I. P. A.; SIQUERI, F. V.; TOMEN, A.; GASPERINI, A. 2017. EFEITO DE ESTROBILURINAS NO CONTROLE DA FERRUGEM ASIÁTICA DA SOJA. Il Workshop brasileiro de ferrugem da soja. Disponível em:
<http://www.cbfito.com.br/ferrugemsoja/cd/Resumos/ResumoFerrugemSoja_0021.pdf>. Acesso: 13 de junho de 2018.
Kim Y M, Park K, Joo G J, Jeong E M, Kim J E, Rhee I K. Glutathione-dependent biotransformatioprn of the fungicide clorotalonil. J Agric Food Chem. 2004 Jun. 30; 52 (13): 4192-6. doi: 10.1021/jf040047u. PMID: 15212468.
LANDGRAF, L. 2017. Produção de soja no Brasil cresce mais de 13% ao ano. Disponível em: <https://www.embrapa.br/busca-de-noticias/-/noticia/25242861/producao-de-soja-no-brasil-cresce-mais-de-13-ao-ano>. Acesso: 05 de junho de 2018.
MAIS SOJA. 2016. Eficiência de fungicidas multissítios no controle da ferrugem-asiática da soja, Phakopsora pachyrhizi, na safra 2015/16: resultados sumarizados dos ensaios cooperativos. Disponível em: <http://maissoja.com.br/eficiencia-de-fungicidas-multissitios-no-controle-da-ferrugem-asiatica-da-soja-phakopsora-pachyrhizi-na-safra-201516-resultados-sumarizados-dos-ensaios-cooperativos-2/>. Acesso: 08 de março de 2020.
MANTECÓN, J. DE. 2008. Efficacy of chemical and biological strategies for controlling the soybean brown spot (Septoria glycines). Cienc. Inv. Agr. v. 35 n. 2 Santiago ago. 2008. Disponível em: <https://scielo.conicyt.cl/scielo.php?script=sci_arttext&pid=S0718-16202008000200011>. Acesso: 18 de abril de 2020.
MARTINS, M. C., GUERZONI, R. A., CÂMARA, G. M. S., MATTIAZZI, P., LOURENçO, S. A. & AMORIM, L. Escala diagramática para a quantificação do complexo de doenças foliares de final de ciclo em soja. Fitopatologia Brasileira 29:179-184. 2004.
MENEGHETTI, R. C.; BALARDIN, R. S.; CORTE, G. D.; FAVERA, D. D.; DEBONA, D. 2010. AVALIAçÃO DA ATIVAvaliação da ativação de defesa em soja. AçÃO DE DEFESA EM SOJA CONTRA Phakopsora 823 pachyrhizi EM CONDIçÕES CONTROLADAS. Disponível em: <http://www.scielo.br/pdf/cagro/v34n4/v34n4a05. Acesso: 10 de abril de 2020.
NUNES, J. L. DA S. 2016. Ferrugem asiática. Disponível em: <https://www.agrolink.com.br/culturas/soja/informacoes/ferrugem-asiatica_361544.html>. Acesso: 05 de junho de 2018.
OGLE, H. J., BYTH, D. E., MCLEAN, R. Effect of rust (Phakopsora pachyrhizi) on soybean yield and quality in South-eastern Queensland. Australian Journal Agriculture Research, v. 30, p. 883-893, 1979.
OLIVEIRA, W. F. DE; CAETANO, F. V.; DIAS, E. M.; BATISTA, R. G.; NONATO, A. R. 2000. EFICIÊNCIA DE PRODUTOS FITOSSANITÁRIOS
PULVERIZADOS NA CULTURA DA SOJA (Glycine max L.), NO CONTROLE DA MANCHA PARDA (Septoria glycines) E CRESTAMENTO FOLIAR-MANCHA PÚRPURA DOS GRÃOS (Cercospora kikuchii). Disponível em: <https://revistas.ufg.br/pat/article/viewFile/2792/2775>. Acesso: 05 de abril de 2020.
OLIVEIRA, S. H. F. Época de aplicação de fungicidas no controle da ferrugem asiática (Phakopsora pachyrhizi) da soja. Fitopatologia Brasileira, Brasília, v. 29 Supl. p. 295, 2004. (Resumo)
PPDB: Pesticide Properties DataBase (University of Hertfordshire, 2021, http://sitem.herts.ac.uk/aeru/ppdb/en/atoz.htm).
Richard H. Bromilow, Chamberlain, K., & Avis A. Evans. (1990). Physicochemical Aspects of Phloem Translocation of Herbicides. Weed Science, 38 (3), 305-314.
ROSS. 2017. Cultivar DM6563 RSF IPRO. Disponível em: <http://sementesroos.com.br/cultivar/dm6563-rsf-ipro/>. Acesso: 12 de junho de 2018.
SHANER, G.; FINNEY, R. E. The effect of nitrogen fertilization on the expression of slow-mildewing resistance in Knox wheat. Phytopathology, v. 67, p. 1051-1056, 1977.
SILVA, C. S.; JULIATTI, B. C. M.; BORGES, B. A.; JULIATTI, F. Ca.; HOYLER, h.;
NETO, J. N.; PALHARES, M. L.; BORGES, M. G.; ARANTES, O. M.; JULIATTI, F. C. 2017. AVALIAçÃO DE FUNGICIDAS QUANTO A EFICÁCIA NO CONTROLE DE
DOENçAS Phakopsora pachyrhizi, Microsphaera diffusa E Septoria glycines NA CULTURA DA SOJA (Glycine max. L.). 50° Congresso Brasileiro de Fitopatologia. 2017. Disponível em: <http://www.cbfito.com.br/cd/Resumos/Resumo50CBFito_0465.pdf>. Acesso: 20 de abril de 2020.
SOARES, R. M.; GODOY, C. V.; OLIVEIRA, M. C. N. Escala diagramática para avaliação da severidade da mancha alvo da soja. Tropical Plant Pathology, v. 34, n. 5, p. 333-338, 2009.
SOJA BRASIL. 2017. Pesquisador lista principais doenças para a soja e como combatê-las. Disponível em: <http://www.projetosojabrasil.com.br/pesquisador-lista-principais-doencas-para-a-soja-e-como-combate-las/>. Acesso: 15 de abril de 2020.
YORINORI, J. T. 2000. Ameaças para a soja. Disponível em: <https://www.grupocultivar.com.br/artigos/ameacas-para-a-soja>. Acesso: 05 de abril de 2020.
Zambolim, L., 2006. Manejo integrado da ferrugem asiática da soja. In: Zambolim, L. (Ed.). Ferrugem asiática da soja. Universidade Federal de Viçosa, Viçosa, Minas Gerais. pp. 73-98.
WALTER, H. Modern Fungicides and Antifungal Compounds VI (eds H. W. Dehne
H. B. Deising, U. Gisi, K. H. Kuck, P. E. Russell, and H. Lyr). DPG-Verlag, Braunschweig, pp. 47-54, 2011.

1. A fungicidal composition comprising:
as active ingredients, Chlorothalonil at a concentration of 46.99% to 50.75% w/w of the composition, with photoprotective effect of the other active ingredients, Azoxystrobin at a concentration of 3.58% to 4.38% w/w of the composition and Cyproconazole at a concentration of 1.02% to 1.38% w/w of the composition;
Propylene glycol at a concentration of 1.00% to 20.00% w/w of the composition;
1,2-benzisothiazolin-3-one at a concentration of 0.10% to 1.00% w/w of the composition;
Poly(dimethylsiloxane) at a concentration of 0.50% to 2.00% w/w of the composition;
Xanthan gum at a concentration of 0.05% to 0.20% w/w of the composition; and
Water at a concentration of 20.00% to 40.00% w/w of the composition.

2. The fungicidal composition of claim 1 further comprising at least one surfactant in a concentration of 0.50% to 20.00% w/w of the composition selected from Polyethylene-polypropylene glycol monobutyl ether, Polyoxyethylene tristyrylphenol phosphate salt of potassium, Lignosulfonic acid sodium salt, Sodium alkylnaphthalenesulfonate condensed formaldehyde, N,N-oxide of dimethyldodecylamine, and/or Lignosulfonic acid sodium salt.

3. The fungicidal composition of claim 1 that further comprises Titanium Dioxide in a concentration of 1.00% to 4.00% m/m of the composition.

4. The fungicidal composition of claim 1 that further comprises Polyvinylpyrrolidone in a concentration of 0.50% to 3.00% w/w of the composition.

5. The fungicidal composition of claim 1 that comprises:
(i)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 15.00% w/w of the composition;
Polyethylene-polypropylene glycol monobutyl ether at a concentration of 5.00% to 10.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 5.00% w/w of the composition; and
Water at a concentration of 20.00% to 40.00% w/w of the composition; or
(ii)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 5.00% to 15.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 5.00% w/w of the composition; and
Water at a concentration of 20.00% to 40.00% w/w of the composition; or
(iii)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 5.00% to 10.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 5.00% w/w of the composition; and
Water at a concentration of 20.00% to 40.00% w/w of the composition; or
(iv)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 5.00% to 10.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 10.00% w/w of the composition; and
Water at a concentration of 20.00% to 40.00% w/w of the composition; or
(v)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 2.00% to 7.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 7.00% w/w of the composition; and
Water at a concentration of 20.00% to 40.00% w/w of the composition; or
(vi)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 5.00% to 10.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 0.50% to 7.00% w/w of the composition; and
Water at a concentration of 20.00% to 40.00% w/w of the composition; or
(vii)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 5.00% to 10.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Titanium Dioxide at a concentration of 1.00% to 4.00% w/w of the composition;
Sodium alkylnaphthalenesulfonate condensed from formaldehyde at a concentration of 1.00% to 5.00% w/w of the composition; and
Water at a concentration of 20.00% to 40.00% w/w of the composition; or
(viii)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 5.00% to 10.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Titanium Dioxide at a concentration of 1.00% to 4.00% w/w of the composition;
Polyvinylpyrrolidone at a concentration of 0.50% to 3.00% w/w of the composition;
Sodium alkylnaphthalenesulfonate condensed from formaldehyde at a concentration of 1.00% to 5.00% w/w of the composition; and
Water at a concentration of 20.00% to 40.00% w/w of the composition; or
(ix)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 5.00% to 8.00% w/w of the composition;
Polyethylene-polypropylene glycol monobutyl ether at a concentration of 2.00% to 10.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 2.00% to 5.00% w/w of the composition; and
Water at a concentration of 20.00% to 40.00% w/w of the composition; or
(x)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 1.00% to 10.00% w/w of the composition;
Polyethylene-polypropylene glycol monobutyl ether at a concentration of 2.00% to 7.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 7.00% w/w of the composition; and
Water at a concentration of 20.00% to 40.00% w/w of the composition; or
(xi)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 5.00% to 10.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 5.00% w/w of the composition;
N,N-oxide of dimethyldodecylamine at a concentration of 2.00% to 14.00% w/w of the composition; and
Water at a concentration of 20.00% to 40.00% w/w of the composition; or
(xii)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 5.00% to 10.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 5.00% w/w of the composition;
N,N-oxide of dimethyldodecylamine at a concentration of 5.00% to 18.00% w/w of the composition; and
Water at a concentration of 20.00% to 40.00% w/w of the composition; or
(xiii)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 5.00% to 20.00% w/w of the composition;
Poly(dimethylsiloxane) at a concentration of 0.50% to 5.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 5.00% w/w of the composition; and
Water at a concentration of 20.00% to 40.00% w/w of the composition; or
(xiv)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 20.00% w/w of the composition;
Polyethylene-polypropylene glycol monobutyl ether at a concentration of 5.00% to 15.00% w/w of the composition;
Poly(dimethylsiloxane) at a concentration of 0.20% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Sodium alkylnaphthalenesulfonate condensed from formaldehyde at a concentration of 1.00% to 5.00% w/w of the composition; and
Water at a concentration of 20.00% to 40.00% w/w of the composition; or
(xv)
Azoxystrobin at a concentration of 3.58% to 4.38% w/w of the composition;
Cyproconazole at a concentration of 1.02% to 1.38% w/w of the composition;
Chlorothalonil at a concentration of 46.99% to 50.75% w/w of the composition;
Propylene glycol at a concentration of 3.00% to 10.00% w/w of the composition;
Polyethylene-polypropylene glycol monobutyl ether at a concentration of 2.00% to 7.00% w/w of the composition;
Poly(dimethylsiloxane) at a concentration of 0.50% to 2.00% w/w of the composition;
1,2-benzisothiazolin-3-one at a concentration of 0.10% to 1.00% w/w of the composition;
Xanthan gum at a concentration of 0.05% to 0.20% w/w of the composition;
Polyoxyethylene phosphate tristyrylphenol potassium salt at a concentration of 1.00% to 7.00% w/w of the composition;
Lignosulfonic acid sodium salt at a concentration of 1.00% to 5.00% w/w of the composition; and
Water at a concentration of 20.00% to 40.00% w/w of the composition.

6.-18. (canceled)

19. A method for preventing and/or treating plants infected by fungi, comprising applying the composition of claim 1 to the plants.

20. A method for preventing and/or treating plants infected by fungi, comprising applying a formulation comprising the composition of claim 1 to the plants.

21. A method for preventing and/or treating plants infected by fungi, comprising applying the composition of claim 2 to the plants.

22. A method for preventing and/or treating plants infected by fungi, comprising applying a formulation comprising the composition of claim 2 to the plants.

23. A method for preventing and/or treating plants infected by fungi, comprising applying the composition of claim 3 to the plants.

24. A method for preventing and/or treating plants infected by fungi, comprising applying a formulation comprising the composition of claim 3 to the plants.

25. A method for preventing and/or treating plants infected by fungi, comprising applying the composition of claim 4 to the plants.

26. A method for preventing and/or treating plants infected by fungi, comprising applying a formulation comprising the composition of claim 5 to the plants.
